(19) United States
(12) Patent Application Publication
(10) Pub. No.: US 2007/0025444 A1
(43) Pub. Date: Feb. 1, 2007

(54) Coding Method

(76) Inventors: Shigeyuki Okada, Ogaki-shi (JP); Hideki Yamauchi, Ogaki-shi (JP); Yuh Matsuda, Gifu-shi (JP); Mitsuru Suzuki, Anpachi-gun (JP); Haruhiko Murata, Osaka (JP)

Correspondence Address: MCDERMOTT WILL & EMERY LLP, 600 13TH STREET, N.W., WASHINGTON, DC, 20005-3096, US

(21) Appl. No.: 11/494,767

(22) Filed: Jul. 28, 2006

(30) Foreign Application Priority Data
Jul. 28, 2005 (JP) JP 2005-219590
Jul. 28, 2005 (JP) JP 2005-219591
Aug. 31, 2005 (JP) JP 2005-250846
Jun. 30, 2006 (JP) JP 2006-182514

(51) Int. Cl. H04N 11/02; H04N 11/04

(52) U.S. Cl. 375/240.16; 375/240.24

(57) ABSTRACT

A local motion vector detection unit 66 obtains a local motion vector LMV for each macro block in a coding target frame image. A region setting unit 64 sets multiple global regions in the frame image. A global motion vector calculation unit 68 calculates a global motion vector GMV which indicates the global motion within each global region. A local motion vector difference coding unit 72 performs coding of the difference ΔLMV which has been obtained by making the difference between each of the local motion vectors LMV within the global region and the global motion vector GMV obtained for each global region. A global motion vector difference coding unit 74 performs coding of the difference ΔGMV which has been obtained by making the difference between each of the global motion vectors GMV obtained for corresponding global region and the reference global motion vector GMV_{B} serving as a reference.

### BACKGROUND OF THE INVENTION

1. Field of the Invention

The present invention relates to a coding method for coding moving images.

2. Description of the Related Art

The rapid development of broadband networks has increased consumer expectations for services that provide high-quality moving images. On the other hand, large capacity storage media such as DVD and so forth are used for storing high-quality moving images. This increases the segment of users who enjoy high-quality images. A compression coding method is an indispensable technique for transmission of moving images via a communication line, and storing the moving images in a storage medium. Examples of international standards of moving image compression coding techniques include the MPEG-4 standard, and the H.264/AVC standard. Furthermore, the SVC technique is known, which is a next-generation image compression technique that includes both high quality image streaming and low quality image streaming.

Streaming distribution of high-resolution moving images without taking up most of the communication bandwidth, and storage of such high-resolution moving images in a recording medium having a limited storage capacity, require an increased compression ratio of a moving image stream. In order to improve the effects of the compression of moving images, motion compensated interframe prediction coding is performed. With motion compensated interframe prediction coding, a coding target frame is divided into blocks, and the motion between the target coding frame and a reference frame, which has already been coded, is predicted so as to detect a motion vector for each block, and the motion vector information is coded together with the subtraction image.

Japanese Patent Application Laid-open Publication No. 2003-299101 discloses a moving image coding technique having a function of selecting a motion compensation method which exhibits the highest coding efficiency from among the interframe coding, ordinary motion compensation, and various kinds of motion vector compensation using global motion vectors.

The H.264/AVC standard provides a function of adjusting the motion compensation block size, and a function of selecting the improved motion compensation pixel precision of up to around ¼ pixel precision, thereby enabling finer prediction to be made for the motion compensation. On the other hand, in the development of SVC (Scalable Video Coding), which is a next-generation image compression technique, MCTF (Motion Compensated Temporal Filtering) technique is being studied in order to improve temporal scalability. The MCTF technique is a technique in which the time-base sub-band division technique and the motion compensation technique are combined. With the MCTF technique, motion compensation is performed in a hierarchical manner, leading to significantly increased information with respect to the motion vectors. As described above, according to the recent trends, such a latest moving image coding technique requires the increased overall amount of data for the moving image stream due to the increased amount of information with respect to the motion vectors. This leads to a strong demand for a technique of reducing the coding amount for the motion vector information.

### SUMMARY OF THE INVENTION

The present invention has been made in view of the aforementioned problems. Accordingly, it is an object thereof to provide a coding technique and a decoding technique for a moving image which offer high coding efficiency and high-precision motion prediction.

In order to solve the aforementioned problems, with a coding method according to an aspect of the present invention, coded moving image data includes the information with respect to the global motion vector which represents the global motion within the target region for at least one region of multiple regions defined in a picture which is a component of a moving image, and which is to be subjected to inter-picture prediction coding.

The term “global motion vector” as used here represents a vector which represents the motion of the entire region.

The term “picture” as used herein represents a coding unit. The concept thereof includes the frame, field, and VOP (Video Object Plane).

According to such an aspect of the present invention, at the time of coding a moving image, the global motion can be captured within at least one region among multiple regions defined in the moving image.

An arrangement may be made in which, in a case that the global motion vector is defined for each of two or more regions, the coded moving image data includes the information with respect to the difference between the global motion vectors of different regions. With such an arrangement, the difference is obtained between the global motion vectors each of which has been obtained for the corresponding region, thereby reducing the coding amount of the global motion vector.

An arrangement may be made in which, in a case that the local motion vectors are defined in units of predetermined blocks in the picture which is subjected to inter-picture prediction coding, the coded moving image data includes the information with respect to the difference between the global motion vector and the local motion vector for each of the regions. With such an arrangement, before the coding of the local motion vector, the difference is calculated between the global motion vector and the local motion vector for each region defined in the coding target picture. This reduces the coding amount of the local motion vectors, thereby improving the compression efficiency of the moving image.

An arrangement may be made in which, in a case that the global motion vector is defined for each of two or more regions, at least one global motion vector is selected as a reference, and the coded moving image data includes the information with respect to the difference between the reference global motion vector serving as a reference and each of the other global motion vectors. With such an arrangement, before the coding of the global motion vectors for multiple regions, the difference is calculated between each of the other global motion vectors and the reference global motion vector. This reduces the coding amount of the global motion vectors, thereby improving the compression efficiency of the moving image.

Another aspect of the present invention provides a coding device. The coding device includes a global motion vector calculation unit for calculating the global motion vector which represents the global motion within the region for at least one region among multiple regions defined in a picture which is to be subjected to inter-picture prediction coding for a moving image.

Yet another aspect of the present invention provides a data structure of a moving image stream. With regard to this data structure of a moving image stream, pictures of the moving image are coded. Furthermore, a global motion vector, which represents global motion within the region, is also coded for at least one region among multiple regions defined in a picture which is to be subjected to inter-picture prediction coding, in the form of motion vector information, in addition to coding of the picture which is to be subjected to inter-picture prediction coding as described above.

With such an aspect, each global motion vector, which represents the global motion within the corresponding region defined in a coding target picture, is coded. This provides a moving image stream which allows the global motion to be captured for each region defined in a moving image.

With regard to the data structure of a moving image stream, coding may be performed for the difference between the global motion vectors of different regions in a form of the motion vector information, in addition to the coding of the coding target picture. Such an arrangement provides a moving image stream having a reduced coding amount of the global motion vectors.

Also, with regard to the data structure of a moving image stream, coding may be performed for the difference between the global motion vector which represents the overall motion of the local motion vectors obtained in units of predetermined blocks defined in each region and each of the local motion vector in a form of the motion vector information, in addition to the coding of the coding target picture. With such an arrangement, coding is performed for the local motion vectors obtained for each region defined in a coding target picture by coding the difference between each of the local motion vectors and the global motion vector. This provides a moving image stream having a reduced coding amount of the local motion vectors.

Yet another aspect of the present invention provides a decoding device. This decoding device is a device for decoding a moving image stream which has been obtained by coding pictures of a moving image. The decoding device includes a global motion vector calculation unit for acquiring a global motion vector, which represents global motion within a target region, from the moving image stream for at least one region among multiple regions defined in a picture which has been subjected to inter-picture prediction coding. An arrangement may be made in which the global motion vector calculation unit acquires difference between the global motion vectors of different regions from the moving image stream, and the global motion vector is calculated for each region using the difference thus acquired.

According to such an aspect, the global motion vector is acquired from a moving image stream, which has been obtained by coding the global motion vector, for each region defined in an image picture. This allows the global motion to be captured for each region defined in the moving image.

The decoding device may further include: a local motion vector calculation unit for calculating the local motion vector for each region by acquiring the local motion vector difference which represents the local motion within each region, and making the sum of the local motion vector difference thus acquired and the global motion vector; and an image reconstruction unit for reconstructing a decoding target picture by making the sum of the subtraction image acquired from the moving image stream and the local motion vector thus calculated. With such an arrangement, the difference between the local motion vector and the global motion vector is acquired from a moving image stream obtained by coding the difference between the local motion vector and the global motion vector for each region defined in the image picture. Then, the local motion vector is obtained for each region by making the sum of the local motion vector difference and the global motion vector, and motion compensation is performed using the local motion vector thus obtained. This provides high-precision reproduction of a moving image.

Yet another aspect of the present invention provides a decoding method. With such a decoding method, a global motion vector which represents global motion within a target region is acquired from a moving image stream, which has been obtained by coding pictures of a moving image, for at least one region among multiple regions defined in the picture which has been subjected to inter-picture prediction coding for a moving image. Then, information with respect to the global motion vector thus obtained is used for motion compensation of the picture which has been subjected to inter-picture prediction coding. Specifically, the global motion vector which indicates the global motion for each region, and local motion vector difference which represents the local motion within each region are acquired. Then, a local motion vector is calculated for each region by making the sum of the local motion vector difference and the global motion vector of the corresponding region. Then, motion compensation is performed for a coding target picture using the local motion vectors thus calculated for each region.

Note that any combination of the aforementioned components or any manifestation of the present invention realized by modification of a method, device, system, recording medium, computer program, and so forth, is effective as an embodiment of the present invention.

### BRIEF DESCRIPTION OF THE DRAWINGS

FIG. 1 is a configuration diagram which shows a coding device according to an Embodiment 1;

FIG. 2 is a diagram for describing the configuration of a motion compensation unit shown in FIG. 1;

FIG. 3 is a flowchart for describing the procedure of motion vector difference coding performed by the motion compensation unit shown in FIG. 2:

FIGS. 4A through 4C are diagrams for describing examples in which the regions are set in an image by a region setting unit shown in FIG. 2;

FIGS. 5A through 5C are diagrams for describing examples in which a global motion vector difference is calculated by a global motion vector difference coding unit shown in FIG. 2;

FIG. 6 is a configuration diagram which shows a decoding device according to the Embodiment 1;

FIG. 7 is a diagram for describing the configuration of a motion compensation unit shown in FIG. 6;

FIG. 8 is a configuration diagram which shows a coding device according to an Embodiment 2;

FIG. 9 is a diagram for describing the configuration of a motion compensation unit shown in FIG. 8;

FIG. 10 is a flowchart for describing the procedure of differential coding of a motion vector performed by the motion compensation unit shown in FIG. 9;

FIGS. 11A through 11C are diagrams for describing examples of ROIs set in an image by a ROI setting unit shown in FIG. 8;

FIGS. 12A through 12C are diagrams for describing examples of calculation of the global motion vector difference performed by a global motion vector difference coding unit shown in FIG. 9;

FIGS. 13A and 13B are diagrams for describing the data structure of a coded stream created by a multiplexing unit shown in FIG. 8;

FIG. 14 is a configuration diagram which shows a decoding device according to an Embodiment 2;

FIG. 15 is a diagram for describing the configuration of a motion compensation unit shown in FIG. 14;

FIG. 16 is a configuration diagram which shows a coding device according to an Example 1 of an Embodiment 3;

FIG. 17 is a diagram for describing the configuration of the motion compensation unit shown in FIG. 16;

FIG. 18 is a flowchart for describing the procedure of differential coding of a motion vector performed by the motion compensation unit shown in FIG. 17;

FIGS. 19A and 19B are diagrams for describing examples of common global motion vectors defined in units of groups each of which is formed of multiple frames of a moving image;

FIG. 20 is a diagram for describing an example of the common global motion vector obtained for each region of multiple spatial regions, into which a moving image has been divided;

FIG. 21 is a diagram for describing an example of coding of the difference in the common global motion vector between multiple groups;

FIG. 22 is a configuration diagram which shows a decoding device according to an Example 1 of the Embodiment 3;

FIG. 23 is a diagram for describing the configuration of a motion compensation unit shown in FIG. 22;

FIG. 24 is a configuration diagram which shows the motion compensation unit of a coding device according to an Example 2 of the Embodiment 3;

FIG. 25 is a diagram for describing the correction processing performed, in units of frames, for the common global motion vector which is common to a group formed of multiple frames of a moving image;

FIG. 26 is a configuration diagram which shows a coding device according to an Embodiment 4;

FIG. 27 is a diagram for describing the configuration of a motion compensation unit shown in FIG. 26;

FIG. 28 is a diagram which shows an example of a reference table of the global motion vector;

FIG. 29 is a flowchart for describing the procedure of differential coding of a motion vector according to an Example 1 of the Embodiment 4;

FIG. 30A is a diagram for describing examples of global regions;

FIG. 30B is a diagram which shows an example of a reference table;

FIG. 31 is a diagram for describing the data structure of a coded stream according to the Example 1 of the Embodiment 4;

FIGS. 32A and 32B are diagrams for describing an example of a method for assigning an index to each global motion vector;

FIG. 33 is a flowchart for describing the procedure of differential coding of a motion vector according to an Example 2 of the Embodiment 4;

FIG. 34A is a diagram for describing examples of global regions;

FIGS. 34B and 34C are diagrams each of which shows an example of a reference table;

FIG. 35 is a diagram for describing the data structure of a coded stream according to the Example 2 of the Embodiment 4;

FIG. 36 is a flowchart for describing the procedure of differential coding of a motion vector according to an Example 3 of the Embodiment 4;

FIG. 37 is a diagram for describing the data structure of a coded stream according to the Example 3 of the Embodiment 4;

FIG. 38 is a configuration diagram which shows a decoding device according to the Embodiment 4; and

FIG. 39 is a diagram which shows the configuration of a motion compensation unit shown in FIG. 38.

### DETAILED DESCRIPTION OF THE INVENTION

The invention will now be described by reference to the preferred embodiments. This does not intend to limit the scope of the present invention, but to exemplify the invention.

### Embodiment 1

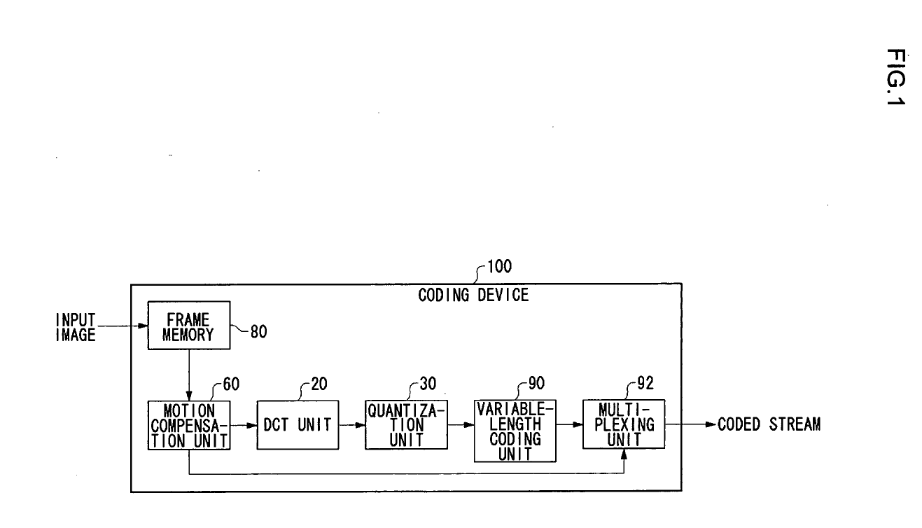

FIG. 1 is a configuration diagram which shows a coding device 100 according to an Embodiment 1. This configuration can be realized by hardware means, e.g., by actions of a CPU, memory, and other LSIs, of a computer, or by software means, e.g., by actions of a program having a function of image coding or the like, loaded into the memory. Here, the drawing shows a functional block configuration which is realized by cooperation between the hardware components and software components. It is needless to say that such a functional block configuration can be realized by hardware components alone, software components alone, or various combinations thereof, which can be readily conceived by those skilled in this art.

The coding device 100 according to the present embodiment performs coding of moving images according to the MPEG (Moving Picture Experts Group) series standards (MPEG-1, MPEG-2, and MPEG-4) standardized by the international standardization organization ISO (International Organization for Standardization)/IEC (International Electrotechnical Commission), the H.26x series standards (H.261, H.262, and H.263) standardized by the international standardization organization with respect to electric communication ITU-T (International Telecommunication Union-Telecommunication Standardization Sector), or the H.264/AVC standard which is the newest moving image compression coding standard jointly standardized by both the standardization organizations (these organizations have advised that this H.264/AVC standard should be referred to as the “MPEG-4 Part 10: Advanced Video Coding” and “H.264”, respectively).

With the MPEG series standards, in a case of coding an image frame in the intra-frame coding mode, the image frame to be coded is referred to as the “I (Intra) frame”. In a case of coding an image frame with a prior frame as a reference image, i.e., in the forward interframe prediction coding mode, the image frame to be coded is referred to as the “P (Predictive) frame”. In a case of coding an image frame with a prior frame and an upcoming frame as reference images, i.e., in the bi-directional interframe prediction coding mode, the image frame to be coded is referred to as the “B frame”.

On the other hand, with the H.264/AVC standard, image coding is performed using reference images regardless of the time at which the reference images have been acquired. For example, image coding may be made with two prior image frames as reference images. Also, image coding may be made with two upcoming image frames as reference images. Furthermore, the number of the image frames used as the reference images is not restricted in particular. For example, image coding may be made with three or more image frames as the reference images. Note that, with the MPEG-1, MPEG-2, and MPEG-4 standards, the term “B frame” represents the bi-directional prediction frame. On the other hand, with the H.264/AVC standard, the time at which the reference image is acquired is not restricted in particular. Accordingly, the term “B frame” represents the bi-predictive prediction frame.

While description will be made in the Embodiment 1 regarding an arrangement in which coding is performed in units of frames, coding may be performed in units of fields. Also, coding may also be performed in VOP increments as stipulated in the MPEG-4.

The coding device 100 receives the input moving images in units of frames, performs coding of the moving images, and outputs a coded stream. The moving image frames thus input are stored in frame memory 80.

A motion compensation unit 60 performs motion compensation for each macro block of a P frame or B frame using a prior or upcoming image frame stored in the frame memory 80 as a reference image, thereby creating the motion vector and the predicted image. The motion compensation unit 60 performs subtraction between the image of the P frame or B frame to be coded and the predicted image, and supplies the subtraction image to a DCT unit 20. Furthermore, the motion compensation unit 60 supplies the coded motion vector information to a multiplexing unit 92.

The DCT unit 20 performs discrete cosine transform (DCT) processing for the image supplied from the motion compensation unit 60, and supplies the DCT coefficients thus obtained, to a quantization unit 30.

The quantization unit 30 performs quantization of the DCT coefficients and supplies the quantized DCT coefficients to the variable-length coding unit 90. The variable-length coding unit 90 performs variable-length coding processing for the quantized DCT coefficients of the subtraction image, and transmits the DCT coefficients subjected to the variable-length coding processing to the multiplexing unit 92. The multiplexing unit 92 multiplexes the coded DCT coefficients received from the variable-length coding unit 90 and the coded motion vector information received from the motion compensation unit 60, thereby creating a coded stream. The multiplexing unit 92 creates a coded stream with the coded frames being sorted in order of time.

Description has been made regarding coding processing for a P frame or B frame, in which the motion compensation unit 60 operates as described above. On the other hand, in a case of coding processing for an I frame, the I frame subjected to intra-frame prediction is supplied to the DCT unit 20 without involving the motion compensation unit 60. Note that this coding processing is not shown in the drawings.

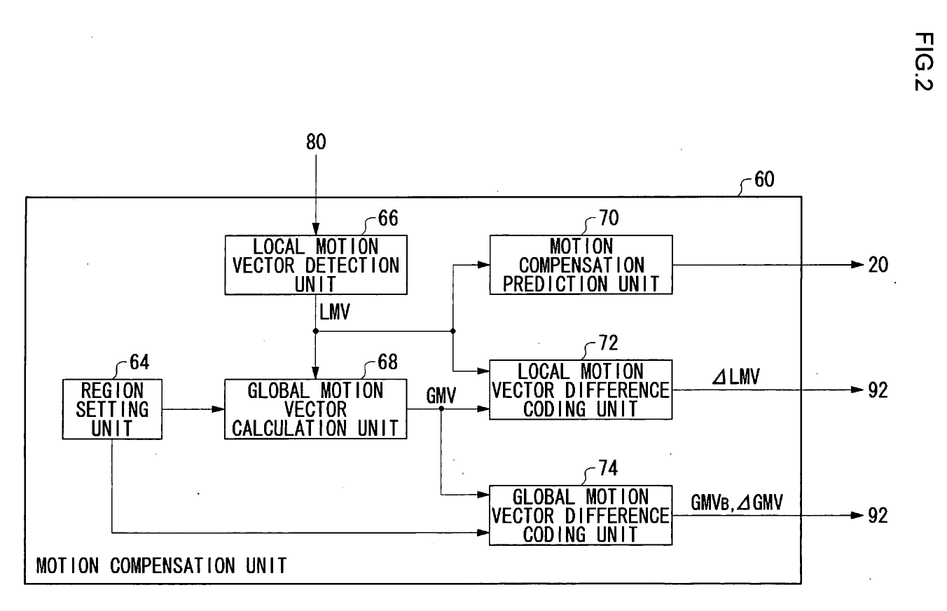

FIG. 2 is a diagram for describing the configuration of the motion compensation unit 60. The motion compensation unit 60 detects a motion vector for each macro block in a coding target image (which will be referred to as the “local motion vector” hereafter). At the same time, the motion compensation unit 60 obtains a motion vector which indicates the global motion within the region for each of the predetermined regions set in the image (which will be referred to as the “global motion vector” hereafter). The global motion vector is a vector which represents the overall motion of the entire region. For example, the global motion vector for each region may represents the overall mouton of the individual local motion vectors obtained in units of macro blocks defined in the corresponding region.

The motion compensation unit 60 performs motion prediction based upon the local motion vector, and outputs a subtraction image. At the same time, the motion compensation unit 60 performs coding of the difference between each of the local motion vectors and the global motion vector, and outputs the calculation results in the form of motion vector information.

A local motion vector detection unit 66 detects the predicted macro block, which exhibits the least difference from the target macro block in the coding target image, from the reference image, with reference to the reference image held by the frame memory 80. Then, the local motion vector detection unit 66 obtains the local motion vector LMV which represents the movement from the target macro block to the predicted macro block. Motion detection is performed by searching the reference image for the reference macro block, which matches the target macro block, in units of pixels, or in units of fractions of a pixel. In general, searching is repeatedly performed multiple times within a pixel region, and the reference macro block which best suits the target macro block is selected as the predicted macro block.

The local motion vector detection unit 66 supplies the local motion vector LMV thus obtained to a global motion vector calculation unit 68, a motion compensation prediction unit 70, and a local motion vector difference coding unit 72.

The motion compensation prediction unit 70 performs motion compensation of the target macro block using the local motion vector LMV, thereby creating a predicted image. The motion compensation prediction unit 70 outputs the subtraction image, which has been obtained by making a subtraction between the coding target image and the predicted image, to the DCT unit 20.

A region setting unit 64 sets a region for calculating the global motion vector GMV in a frame image (which will be referred to as the “global region” hereafter). Note that the region setting unit 64 sets multiple global regions in the image. For example, the region setting unit 64 may set fixed global regions in the image beforehand. Specific examples include: an arrangement in which the region setting unit 64 sets one global region around the center of the frame image, and sets the perimeter region other than the center region to be another global region; etc. Alternatively, the global regions may be set by the user.

Also, an arrangement may be made in which, in a case that the image includes a particular object such as a human figure or the like, the region setting unit 64 automatically extracts the region occupied by the object, and the region thus extracted is set to be a global region.

Also, an arrangement may be made in which the region setting unit 64 automatically extracts a region occupied by the macro blocks having roughly the same motion with reference to the local motion vectors LMV in the image detected by a local motion vector detection unit 66, and sets the region thus extracted to be a global region.

The region setting unit 64 transmits the information with respect to the global regions thus set to a global motion vector calculation unit 68 and a global motion vector difference coding unit 74.

The global motion vector calculation unit 68 calculates the global motion vector GMV which indicates the global motion in each global region set by the region setting unit 64. For example, the global motion vector calculation unit 68 calculates the average of the local motion vectors LMV within a region, and employs the average as the global motion vector GMV.

Furthermore, an arrangement may be made in which the global motion vector calculation unit 68 acquires the information with respect to the global motion in each global region, and calculates the global motion vector GMV for each global region based upon the information thus acquired. For example, an arrangement may be made in which, in a case of the camera zooming or panning, or in a case of scrolling the screen, the global motion vector calculation unit 68 determines the global motion for each global region based upon the information with respect to the overall region of the screen, thereby calculating the global motion vector GMV. Also, an arrangement may be made in which the global motion vector calculation unit 68 automatically extracts the motion of a particular object such as a human figure or the like in the image, and determines the global motion for each global region based upon the motion of that object, thereby calculating the global motion vector GMV.

The global motion vector calculation unit 68 transmits the global motion vector GMV thus obtained to the local motion vector difference coding unit 72 and the global motion vector difference coding unit 74.

The local motion vector difference coding unit 72 receives the local motion vector LMV from the local motion vector detection unit 66, and receives the global motion vector GMV from the global motion vector calculation unit 68, respectively. Then, the local motion vector difference coding unit 72 calculates the difference between the local motion vector LMV and the global motion vector GMV for each global region, i.e., the local motion vector difference ΔLMV=LMV−GMV, and performs variable length coding of the local motion vector difference ΔLMV. The local motion vector difference coding unit 72 transmits the coded local motion vector difference ΔLMV to the multiplexing unit 92.

The global motion vector difference coding unit 74 receives the global motion vector GMV for each region as an input from the global motion vector calculation region 68, and selects at least one global motion vector GMV as a reference from among the set of global motion vectors GMV, each of which is obtained for the corresponding region. The global motion vector GMV which is selected as a reference will be referred to as the “reference global motion vector GMV_{B}”. The global motion vector difference coding unit 74 calculates the difference ΔGMV=GMV−GMV_{B}, and performs variable length coding of the difference between the reference motion vector GMV_{B} and the global motion vector difference ΔGMV in the form of the motion vector information.

The global motion vector difference coding unit 74 transmits the coded reference global motion vector GMV_{B} and the coded global motion vector difference ΔGMV for each global region to the multiplexing unit 92 in the form of motion vector information. In this stage, the global motion vector difference coding unit 74 appends the region information with respect to the global region set by the region setting unit 64 as a part of the motion vector information.

The multiplexing unit 92 receives the reference global motion vector GMV_{B}, the global motion vector difference ΔGMV, and the local motion vector difference ΔLMV, in the form of motion vector information.

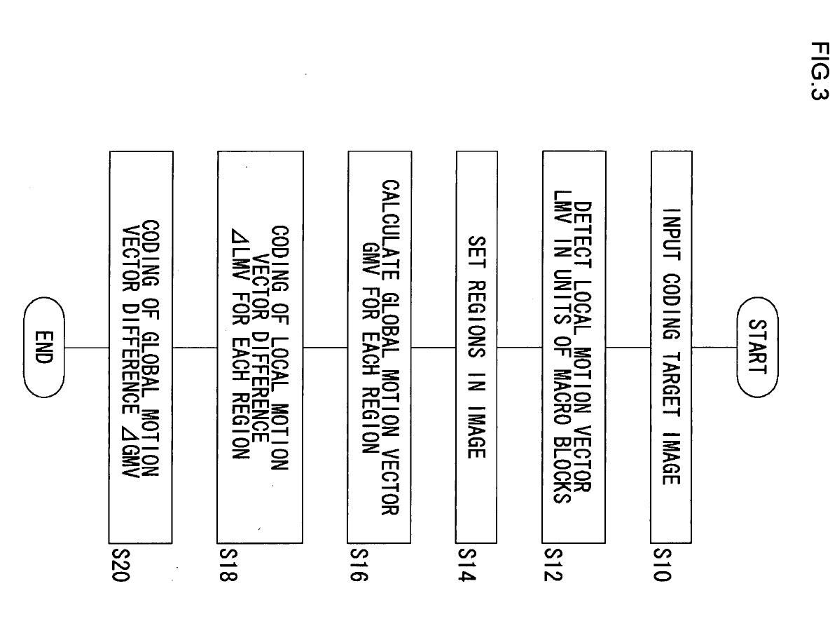

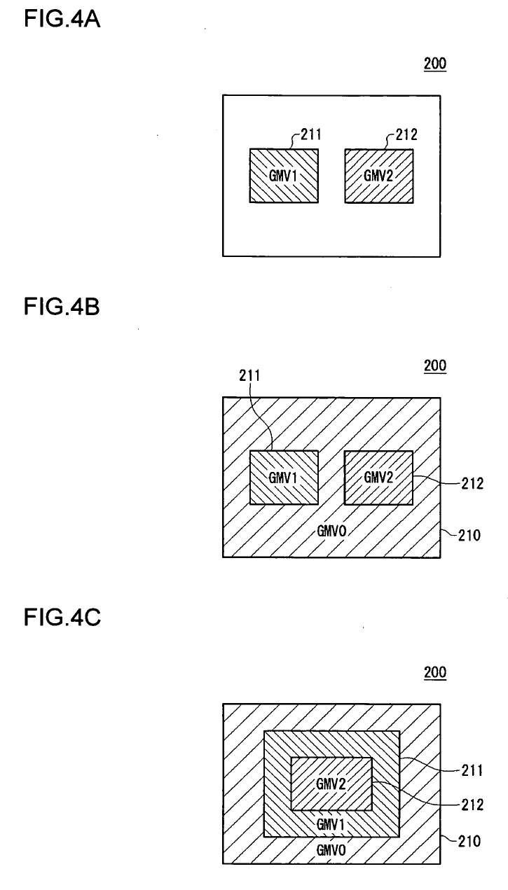

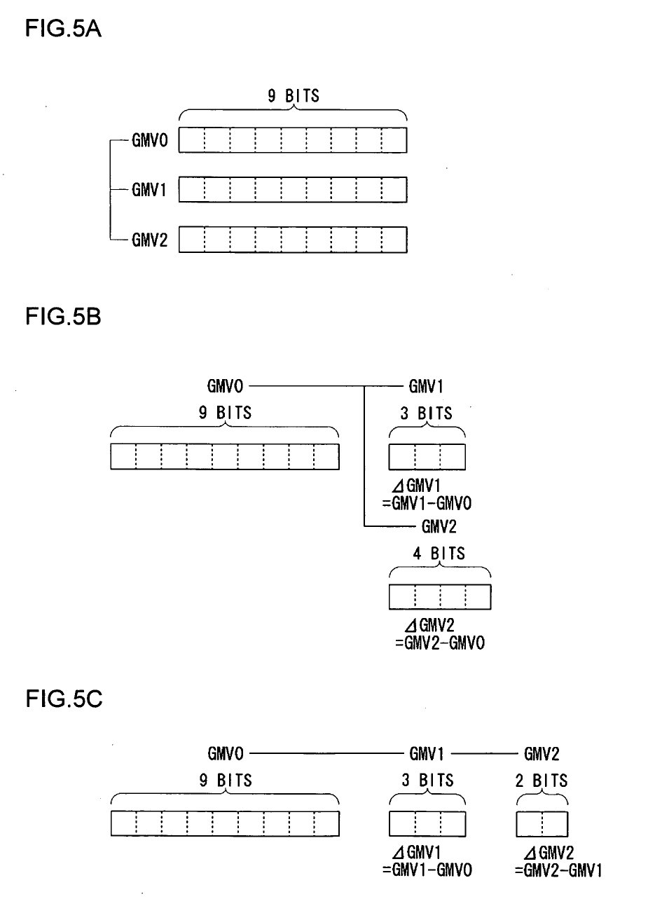

FIG. 3 is a flowchart for describing the coding procedure for the motion vector difference performed by the motion compensation unit 60. Description will be made regarding the coding procedure with reference to examples shown in FIGS. 4A through 4C, and FIGS. 5A through 5C, as appropriate.

A coding target image is input to the frame memory 80 of the coding device 100 (S10). The local motion vector detection unit 66 of the motion compensation unit 60 detects the local motion vector LMV for each macro block defined in a coding target image (S12).

Next, the region setting unit 64 sets the global regions in the image (S14), and the global motion vector calculation unit 68 calculates the global motion vector GMV for each global region (S16).

The local motion vector difference coding unit 72 calculates the local motion vector differences ΔLMV for each global region, and performs coding thereof (S18). The global motion vector difference coding unit 74 calculates the global motion vector difference ΔGMV for each global region, and performs coding thereof (S20).

FIGS. 4A through 4C are diagrams for describing an example of the global region. In the example shown in FIG. 4A, the region setting unit 64 sets a first global region 211 and a second global region 212 in a coding target image 200. The global motion vector calculation unit 68 obtains a first global motion vector GMV1 for the first global region 211, and a second global motion vector GMV2 for the second global region 212. In this example, there is no region in the back ground region other than the first global region 211 and the second global region 212 for which the global motion vector is to be obtained.

In the example shown in FIG. 4A, in a case of coding the local motion vectors LMV within the first global region 211, the local motion vector difference coding unit 72 obtains ΔLMV=LMV−GMV1, which is the difference between the local motion vector LMV and the first global motion vector GMV1, for each macro block, and performs coding thereof. In the same way, in a case of coding the local motion vectors LMV within the second global region 212, the local motion vector difference coding unit 72 obtains ΔLMV=LMV−GMV2, which is the difference between the local motion vector LMV and the second global motion vector GMV2, for each macro block, and performs coding thereof.

In the example shown in FIG. 4A, the global motion vector GMV is not obtained for any region in the background region other than the first global region 211 and the second global region 212. Accordingly, in a case of coding the local motion vectors in the background region, the local motion vector difference coding unit 72 performs coding of each local motion vector LMV without calculating the difference between the local motion vector LMV and the global motion vector GMV, i.e., without performing computation before the coding.

In the example shown in FIG. 4B, the region setting unit 64 sets the background region other than the first global region 211 and the second global region 212 to be a third global region 210, unlike the example shown in FIG. 4A. The global region vector calculation unit 68 obtains a third global motion vector GMV0 for the third global region 210. In a case of coding the local motion vectors LMV within the third global region 210, the local motion vector difference coding unit 72 calculates ΔLMV=LMV−GMV0, which is the difference between the local motion vector LMV and the third global motion vector GMV0, for each macro block, and performs coding thereof.

FIG. 4C shows an example in which there is an inclusion relation among multiple global regions in the coding target image 200. In this example, the second global region 212 is included in the first global region 211. Furthermore, the entire areas of the first global region 211 and the second global region 212 are included in the third global region 210.

In a case of coding the local motion vectors LMV within the second global region 212, the local motion vector difference coding unit 72 performs coding of the difference between the second global motion vector GMV2 and the local motion vector LMV for each macro block. In a case of coding the local motion vectors LMV in a region which is inside the first global region 211 and is outside the second global region 212, the local motion vector difference coding unit 72 performs coding of the difference between the first global motion vector GMV1 and the local motion vector LMV for each macro block. In a case of coding the local motion vectors LMV in a region which is inside the third global region 210 and is outside the first global region 211, the local motion vector difference coding unit 72 performs coding of the difference between the third global motion vector GMV0 and the local motion vector LMV for each macro block.

FIGS. 5A through 5C are diagrams for describing examples of the calculation of the global motion vector difference performed by the global motion vector difference coding unit 74. Here, description will be made regarding examples in which three global regions are set as shown in FIG. 4B or 4C, the three global motion vectors GMV0, GMV1, and GMV2 are obtained for the three respective global regions, and the three global motion vectors GMV0, GMV1, and GMV2 are coded.

FIG. 5A shows an arrangement in which the three global motion vectors GMV0, GMV1, and GMV2 are handled without involving any hierarchical structure. With such an arrangement, the global motion vector difference coding unit 74 handles all the three global motion vectors GMV0, GMV1, and GMV2 as a set of reference global motion vectors. Specifically, the global motion vector difference coding unit 74 performs coding of the 9-bit global motion vectors GMV0, GMV1, and GMV2 without calculating the global motion vector difference, i.e., without performing any calculation before the coding, and outputs the coded global motion vectors.

FIG. 5B shows an arrangement in which the three global motion vectors GMV0, GMV1, and GMV2 are handled in a hierarchical structure. With such an arrangement, GMV0 serves as a global motion vector at a higher hierarchical level. On the other hand, each of GMV1 and GMV2 serves as a global motion vector at a hierarchical level immediately lower than that of GMV0. With such an arrangement, the global motion vector difference coding unit 74 performs coding of each of the global motion vectors GMV1 and GMV2 at the lower hierarchical level with the global motion vector GMV0 at the higher hierarchical level as a reference global motion vector. Specifically, the global motion vector difference coding unit 74 performs coding of ΔGMV1=GMV1−GMV0, which is the difference between the global motion vector GMV1 and the reference global motion vector GMV0, and ΔGMV2=GMV2−GMV0, which is the difference between the global motion vector GMV2 and the reference global motion vector GMV0. Here, each of the global motion vectors GMV1 and GMV2 at the lower hierarchical level has a 9-bit original coding amount. With such an arrangement, the global motion vectors GMV1 and GMV2 are represented by reduced coding amounts, i.e., a 3-bit coding amount and the 4-bit coding amount, respectively, by calculating the difference between the global motion vector GMV1 and the higher hierarchical level global motion vector GMV0, and calculating the difference between the global motion vector GMV2 and the higher hierarchical level global motion vector GMV0.

FIG. 5C shows an arrangement in which the three global motion vectors GMV0, GMV1, and GMV2 are handled using another hierarchical structure. With such an arrangement, GMV0 serves as the global motion vector at the highest hierarchical level. GMV1 serves as the global motion vector at the next lower hierarchical level than that of GMV0, and GMV2 serves as the global motion vector at next lower hierarchical level than that of GMV1. With such an arrangement, the global motion vector difference coding unit 74 performs coding of the global motion vectors GMV1 at the second hierarchical level with the global motion vector GMV0 at the first hierarchical level as a reference global motion vector. Specifically, the global motion vector difference coding unit 74 performs coding of ΔGMV1=GMV1−GMV0, which is the difference between the global motion vector GMV1 and the reference global motion vector GMV0. Here, the second hierarchical level global motion vector GMV1 has a 9-bit original coding amount. With such an arrangement, the global motion vector GMV1 is represented by a reduced coding amount, i.e., a 3-bit coding amount, by calculating the difference between the global motion vector GMV1 and the first hierarchical level global motion vector GMV0.

Then, the global motion vector difference coding unit 74 performs coding of ΔGMV2=GMV2−GMV0, which is the difference between the third hierarchical level global motion vector GMV2 and the second hierarchical level global motion vector GMV1. Here, the third hierarchical level global motion vector GMV2 has a 9-bit original coding amount. With such an arrangement, the global motion vector GMV2 is represented by the reduced coding amount, i.e., a 2-bit coding amount, by calculating the difference between the global motion vector GMV2 and the second hierarchical level global motion vector GMV1.

With either of the arrangements shown in FIG. 5B or FIG. 5C, the global motion vector difference coding unit 74 outputs the reference global motion vector GMV0 and the two global motion vector differences ΔGMV1 and ΔGMV2, as the motion vector information. In this stage, the information that indicates the hierarchical structure used for handling the three global motion vectors GMV0, GMV1, and GMV3 is appended as a part of the motion vector information.

As described above with reference to the examples shown in FIGS. 5B and 5C, an arrangement may be made in which the global motion vectors are handled in a hierarchical structure as appropriate. With such an arrangement, each of the global motion vectors is represented by a reduced coding amount by calculating the difference between the global motion vector and another global motion vector at an adjacent hierarchical level. Description has been made in the above examples regarding an arrangement in which coding is performed for the difference between the global motion vector at a lower hierarchical level and the global motion vector at a higher hierarchical level with the global motion vector at the higher hierarchical level as a reference. Also, an arrangement may be made in which coding is performed for the difference between the global motion vector at a lower hierarchical level and the global motion vector at a higher hierarchical level with the global motion vector at the lower hierarchical level as a reference.

The hierarchical structure for the global motion vectors may be determined regardless of the inclusion relation among the global regions. Also, the hierarchical structure may be determined based upon the inclusion relation among the global regions.

For example, let us consider a case in which the first global region 211 and the second global region 212 are included within the third global region 210 as shown in FIG. 4B. In this case, the global motion vector difference coding unit 74 creates a hierarchical structure in which the global motion vector GMV0 of the third global region 210 is set to a higher hierarchical level, and the global motion vectors GMV1 and GMV2 of the first and second global regions 211 and 212 are set to the immediately lower hierarchical level, based upon the inclusion relation among these global regions, as shown in FIG. 5B. The global motion vector difference coding unit 74 performs coding of the global motion vector difference using the hierarchical structure thus created.

Next, let us say that there is an inclusion relation in which the second global region 212 is included within the first global region 211, and the entire areas of the first global region 211 and the second global region 212 are included within the third global region 210, as shown in FIG. 4C. In this case, the global motion vector difference coding unit 74 creates a hierarchical structure in which the global motion vector GMV0 of the third global region 210 is set to the highest hierarchical level, the global motion vector GMV1 of the first global region 211 is set to a second hierarchical level, and the global motion vector GMV2 of the second global region 212 is set to a third hierarchical level. The global motion vector difference coding unit 74 performs coding of the global motion vector difference using the hierarchical structure thus created.

With such an arrangement in which the hierarchical structure for the global motion vectors is created just in accordance with the inclusion relation among the global regions set by the region setting unit 64, and the information with respect to the inclusion relation among the global regions is included as a part of the motion vector information, there is no need to provide the information with respect to the hierarchical structure for the global motion vectors in the form of additional information. Such an arrangement reduces the amount of data in the header information.

Also, let us consider a case in which the inclusion relation among the global regions reflects the relative difference in the motion amount in the image such as the difference in the motion amount between the region around the center and the back ground region in the image, the difference in the motion amount between the region of a particular object and the background region other than the region of the particular object, and so forth. In this case, with such an arrangement in which the hierarchical structure for the global motion vectors is created such that it just reflects the inclusion relation among the global regions, and the global motion vector difference is obtained according to the hierarchical structure thus created, it will be anticipated that the global motion vector difference can be represented with a fewer number of bits.

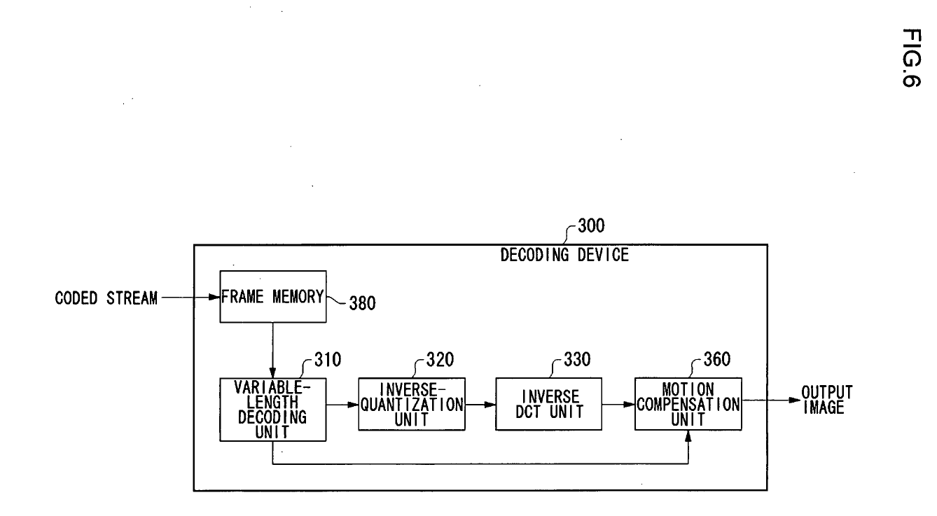

FIG. 6 is a configuration diagram which shows the decoding device 300 according to the present embodiment. The functional block configuration can also be realized by hardware components alone, software components alone, or combinations thereof.

The decoding device 300 receives a coded stream in the form of input data, and decodes the coded stream, thereby creating an output image. The coded stream thus input is stored in frame memory 380.

A variable-length decoding unit 310 performs variable-length decoding of the coded stream stored in the frame memory 380, and transmits the decoded image data to an inverse-quantization unit 320. The variable-length decoding unit 310 transmits the decoded motion vector information to a motion compensation unit 360.

The inverse-quantization unit 320 performs inverse-quantization of the image data decoded by the variable-length decoding unit 310, and transmits the image data thus inverse-quantized to an inverse DCT unit 330. The image data inverse-quantized by the inverse quantized unit 320 is a DCT coefficient set. The inverse DCT unit 330 performs inverse discrete cosine transform (IDCT) for the DCT coefficient set inverse-quantized by the inverse quantization unit 320, thereby reconstructing the original image data. The image data reconstructed by the inverse DCT unit 330 is transmitted to the motion compensation unit 360.

The motion compensation unit 360 creates a predicted image based upon the motion vector information supplied from the variable-length decoding unit 310 using the prior or upcoming image frame as a reference image. Then, the motion compensation unit 360 reconstructs the original image data by making the sum of the predicted image and the subtraction image supplied from the inverse DCT unit 330, and outputs the original image data thus reconstructed.

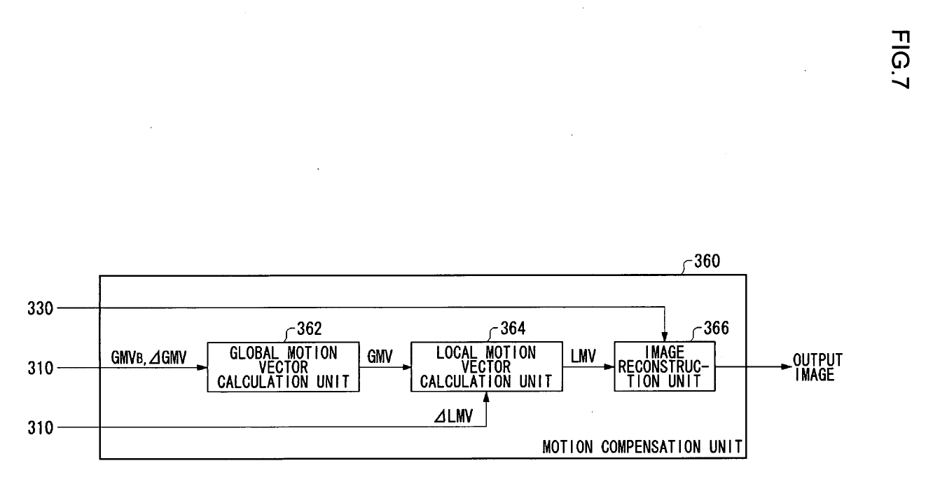

FIG. 7 is a diagram for describing the configuration of the motion compensation unit 360. The coded stream, which has been coded by the coding device 100 shown in FIG. 1, is input to the decoding device 300. The motion vector information, which is supplied to the motion compensation unit 360, includes: the reference global motion vector GMV_{B}; the global motion vector difference ΔGMV; and the local motion vector difference ΔLMV. The motion compensation unit 360 obtains the local motion vector LMV with reference to this motion vector information, and performs motion compensation.

A global motion vector calculation unit 362 receives the reference global motion vector GMV_{B} and the global motion vector difference ΔGMV for each global region in the form of input from the variable-length decoding unit 310, calculates the global motion vector GMV=ΔGMV+GMV_{B}, and transmits the global motion vector GMV to a local motion vector calculation unit 364.

The local motion vector calculation unit 364 receives the local motion vector difference ΔLMV in the form of input from the variable-length decoding unit 310, and the global motion vector GMV for each global region in the form of input from the global motion vector calculation unit 362. Then, the local motion vector calculation unit 364 calculates the local motion vector LMV=ΔLMV+GMV. The local motion vector calculation unit 364 transmits the local motion vectors LMV thus calculated for each global region, to an image reconstruction unit 366.

The image reconstruction unit 366 creates a predicted image using the reference image and the local motion vectors LMV each of which has been calculated for the corresponding macro block within each global region. Then, the image reconstruction unit 366 reconstructs the original image by calculating the sum of the subtraction image received from the inverse DCT unit 330 and the predicted image thus created, and outputs the original image thus reconstructed.

As described above, with the coding device according to the present embodiment, before the coding of the motion vectors, the information with respect to the motion vector within a spatial region is represented by the difference between the motion vector and the global motion vector of this region. Such an arrangement enables the amount of data of the information with respect to the individual motion vectors to be reduced. This reduces the overall coding amount of the moving image stream, thereby improving the compression efficiency. Furthermore, with the present embodiment, the global motion vectors of the spatial regions are handled in a hierarchical structure, and coding is performed for the difference between the global motion vectors at different hierarchical levels. Such an arrangement enables the coding amount of the motion vector information to be further reduced.

With the decoding device 300 according to the present embodiment, the local motion vector difference is acquired from a moving image stream coded by the coding device 100 with high compression efficiency. Then, the local motion vector is obtained for each spatial region by making the sum of the local motion vector difference and the global motion vector. Then, motion compensation is performed using the local motion vector thus obtained, thereby reconstructing a high-quality moving image.

Description has been made regarding the present invention with reference to the aforementioned embodiment. The aforementioned embodiment has been described for exemplary purposes only, and is by no means intended to be interpreted restrictively. Rather, it can be readily conceived by those skilled in this art that various modifications may be made by making various combinations of the components or of the processing, which are also encompassed in the technical scope of the present invention.

Description has been made in the present embodiment regarding an arrangement in which the coding device 100 and the decoding device 300 perform coding and decoding of the moving images in accordance with the MPEG series standards (MPEG-1, MPEG-2, and MPEG-4), the H.26x series standards (H.261, H.262, and H.263), or the H.264/AVC standard. Also, the present invention may be applied to an arrangement in which coding and decoding are performed for moving images managed in a hierarchical manner having a temporal scalability. In particular, the present invention is effectively applied to an arrangement in which motion vectors are coded with the reduced coding amount using the MCTF technique.

### Embodiment 2

Summary of this Embodiment

It is an object of Embodiment 2 to provide a coding technique and a decoding technique for a moving image which offer high coding efficiency and high-precision motion prediction.

With a coding method according to an aspect of the Embodiment 2, coded moving image data includes: information for specifying regions which are defined in a picture which is a component of a moving image, and in which coding is performed with different image quality; and information for specifying a global motion vector that represents the global motion within each of the regions thus defined in the picture where inter-picture prediction coding is to be performed.

The “information that indicates the global motion vector” is the information which represents the overall motion of the entire region, e.g., a vector which represents the overall motion of the entire region. Note that, in some cases, the global motion vector is included in the coded data in the form of difference information. Also, in some cases, the motion vector is represented in the form of a certain combination of multiple parameters. The form of the “information that indicates the global motion vector” is not restricted in particular. That is to say, the “information that indicates the global motion vector” may include the information that indicates the global motion vector in any form.

The term “picture” as used herein represents a coding unit. The concept thereof includes the frame, field, and VOP (Video Object Plane).

With such an aspect, the global motion vectors are connected to the respective regions which are to be coded with different image quality, thereby properly selecting the regions each of which exhibits the global motion within the moving image. Furthermore, such an aspect reduces the data amount of the coded moving image data, thereby improving the compression efficiency.

An arrangement may be made in which, in a case that the global motion vector is defined for each of two or more regions, the coded moving image data includes the information with respect to the difference between the global motion vectors of different regions. With such an arrangement, the difference is obtained between the global motion vectors each of which has been obtained for the corresponding region, thereby reducing the coding amount of the global motion vector.

An arrangement may be made in which, in a case that global motion vectors have been defined for two or more regions, at least one of the global motion vectors is selected as a reference, and the coded moving image data includes the information with respect to the difference between the global motion vector serving as the reference and each of the other global motion vectors. With such an arrangement, before the coding of the global motion vectors for multiple regions, the difference is calculated between each of the global motion vectors and the reference global motion vector. This reduces the coding amount of the global motion vectors, thereby improving the compression efficiency of the moving image.

An arrangement may be made in which, in a case that the local motion vectors are defined in units of predetermined blocks in the picture which is subjected to inter-picture prediction coding, the coded moving image data includes the information with respect to the difference between the global motion vector and the local motion vector for each of the regions. With such an arrangement, before the coding of the local motion vector, the difference is calculated between the global motion vector and the local motion vector for each region defined in the coding target picture. This reduces the coding amount of the local motion vectors, thereby improving the compression efficiency of the moving image.

Another aspect of the Embodiment 2 provides a coding device. The coding device includes: a region setting unit for setting regions, which are to be coded with different image quality, in a moving image; and a global motion vector calculation unit for calculating a global motion vector that represents a global motion in each region set by the region setting unit.

The position information with respect to the region thus set may also be used as position information with respect to the regions for which the global motion vectors have been obtained. The coding device may further include a multiplexing unit for storing such position information with respect to the regions in the header of a coded stream of the moving image in a form multiplexed with the global motion vectors. This reduces the data amount of the header, thereby further improving the compression efficiency of a coded stream of a moving image.

Yet another aspect of the present invention provides a data structure of a moving image stream. With regard to this data structure of a moving image stream, the pictures of the moving image are coded. Furthermore, multiple regions, which are to be reproduced with different image quality, are provided in the coding target picture. The global motion vector, which represents the global motion within each region, is stored in the header of the coded stream of the moving image in a form multiplexed with the position information with respect to the regions.

With such an aspect, the position information with respect to each region set in the image is also used as the position information with respect to the regions for which the global motion vectors have been obtained for the coding target picture. This provides a moving image stream with a header having a reduced data amount.

Yet another aspect of the Embodiment 2 provides a decoding device. This decoding device is a device for decoding a moving image stream which has been obtained by coding pictures of a moving image. The decoding device includes: a region acquisition unit for acquiring position information with respect to multiple regions, which are defined in the moving image, and which are to be reproduced with different image quality, from the moving image stream; a global motion vector calculation unit for calculating a global motion vector for each region for decoding target picture of the moving image with reference to the position information thus acquired, which is also used as position information with respect to the region where the global motion vector that represents global motion is to be obtained; and an image reconstruction unit for performing motion compensation of the decoding target picture using the global motion vector calculated for each region.

With such an aspect, a global motion vector difference is acquired from a moving image stream obtained by coding the difference between the global motion vectors each of which has been obtained for the corresponding region defined in the image. Then, the global motion vector is obtained for each region, and motion compensation is performed using the global motion vector thus obtained. With such an arrangement, the global motion compensation is performed over the corresponding region, in addition to allowing such a region to be reproduced with high image quality and with high priority.

The global motion vector calculation unit may calculate the global motion vector for each region by acquiring the global motion vector difference for each region from the moving image stream, and making the sum of the reference global motion vector and the global motion vector difference thus acquired.

The decoding device may further include a local motion vector calculation unit for calculating the local motion vector, which represents the local motion within each region, for each region by acquiring the local motion vector difference from the moving image stream, and making the sum of the local motion vector difference thus acquired and the global motion vector of the corresponding region. The image reconstruction unit may reconstruct the decoding target picture by making the sum of the subtraction image acquired from the moving image stream and the local motion vector.

Yet another aspect of the Embodiment 2 provides a decoding method. With the decoding method, position information with respect to multiple regions, which are defined in a moving image, and which are to be reproduced with different image quality, is acquired from a moving image stream. Then, a global motion vector is calculated for each region with reference to the position information thus acquired, which is also used as position information with respect to the region where the global motion vector that represents global motion is to be obtained. Then, motion compensation is performed for a coding target picture using the global motion vector thus calculated.

Note that any combination of the aforementioned components or any manifestation of the Embodiment 2 realized by modification of a method, device, system, computer program, and so forth, is effective as the Embodiment 2.

Detailed Description of this Embodiment

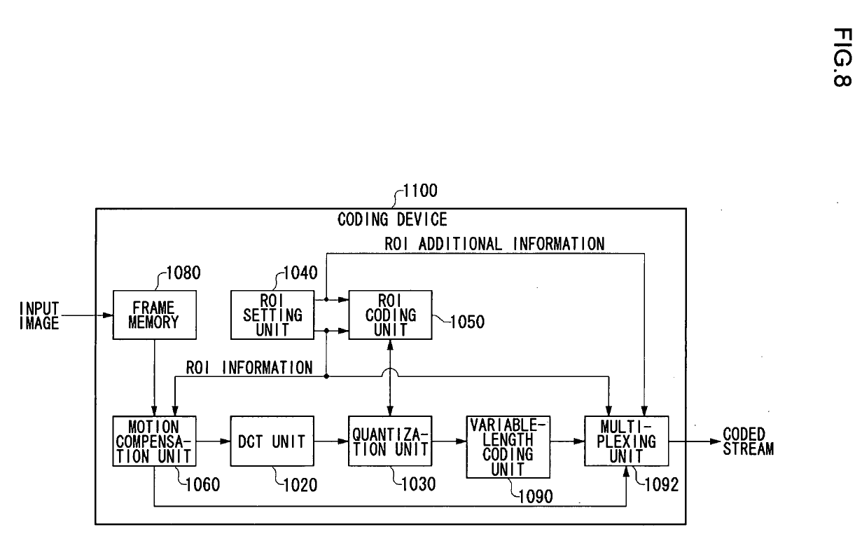

FIG. 8 is a configuration diagram which shows a coding device 1100 according to an Embodiment 2. This configuration can be realized by hardware means, e.g., by actions of a CPU, memory, and other LSIs, of a computer, or by software means, e.g., by actions of a program having a function of image coding or the like, loaded into the memory. Here, the drawing shows a functional block configuration which is realized by cooperation between the hardware components and software components. It is needless to say that such a functional block configuration can be realized by hardware components alone, software components alone, or various combinations thereof, which can be readily conceived by those skilled in this art.

The coding device 1100 according to the present embodiment performs coding of moving images according to the MPEG (Moving Picture Experts Group) series standards (MPEG-1, MPEG-2, and MPEG-4) standardized by the international standardization organization ISO (International Organization for Standardization)/IEC (International Electrotechnical Commission), the H.26x series standards (H.261, H.262, and H.263) standardized by the international standardization organization with respect to electric communication ITU-T (International Telecommunication Union-Telecommunication Standardization Sector), or the H.264/AVC standard which is the newest moving image compression coding standard jointly standardized by both the standardization organizations (these organizations have advised that this H.264/AVC standard should be referred to as the “MPEG-4 Part 10: Advanced Video Coding” and “H.264”, respectively).

With the MPEG series standards, in a case of coding an image frame in the intra-frame coding mode, the image frame to be coded is referred to as the “I (Intra) frame”. In a case of coding an image frame with a prior frame as a reference image, i.e., in the forward interframe prediction coding mode, the image frame to be coded is referred to as the “P (Predictive) frame”. In a case of coding an image frame with a prior frame and an upcoming frame as reference images, i.e., in the bi-directional interframe prediction coding mode, the image frame to be coded is referred to as the “B frame”.

On the other hand, with the H.264/AVC standard, image coding is performed using reference images regardless of the time at which the reference images have been acquired. For example, image coding may be made with two prior image frames as reference images. Also, image coding may be made with two upcoming image frames as reference images. Furthermore, the number of the image frames used as the reference images is not restricted in particular. For example, image coding may be made with three or more image frames as the reference images. Note that, with the MPEG-1, MPEG-2, and MPEG-4 standards, the term “B frame” represents the bi-directional prediction frame. On the other hand, with the H.264/AVC standard, the time at which the reference image is acquired is not restricted in particular. Accordingly, the term “B frame” represents the bi-predictive prediction frame.

While description will be made in the Embodiment 2 regarding an arrangement in which coding is performed in units of frames, coding may be performed in units of fields. Also, coding may also be performed in VOP increments as stipulated in the MPEG-4.

The coding device 1100 receives the input moving images in units of frames, performs coding of the moving images, and outputs a coded stream. The moving image frames thus input are stored in frame memory 80.

An ROI setting unit 1040 sets a region of interest (ROI) in a moving image. Here, the region of interest may be selected by the user, by specifying a particular region in the image. Also, a predetermined region such as a region around the center of the image may be selected as the region of interest. Also, an important region such as a region where a human figure or a text is displayed may be automatically extracted as the region of interest. Also, the region of interest may be automatically selected in units of frames by tracing the motion of a particular object or the like in the moving image.

Also, multiple regions of interest may be provided in the image. For example, an arrangement may be made in which the ROI setting unit 1040 sets a region around the center of the image as a ROI, and sets the perimeter thereof as another ROI. With such an arrangement in which multiple ROIs are set, the ROI setting unit 1040 has a function of setting a priority for each of the multiple ROIs thereamong.

As an example in which the multiple ROIs are selected, let us consider a case in which regions around the center of the image and the perimeter of the image are selected as the ROIs. In this case, the priority of the region around the center of the image is set to be higher, and the priority of the perimeter thereof is set to be lower. Let us consider a case in which a text region and a human figure region are set as the ROIs. In this case, the priority of the text region is set to be higher, and the human figure region is set to be lower.

As another example, an arrangement may be made in which, in a case that the region where a person's face is displayed has been set as a ROI, the priority of such a ROI is set to a lower priority such that such a region where the person's face is displayed is displayed with a low image quality, for the purpose of protecting the privacy of the person. As described above, it is not essential for the ROI to be coded with a higher priority and with high image quality. Also, the ROI may be coded with a lower priority, and accordingly, with lower image quality.

The ROI setting unit 1040 transmits the position information with respect to the ROI thus set (which will be referred to as the “ROI information” hereafter) to a ROI coding unit 1050 and a motion compensation unit 1060. In a case that the ROI is selected in a rectangular shape, the ROI region information is represented by the coordinate values of the upperleft pixel of the rectangular region, the width in pixels, and the height in pixels. Note that the ROI may be a region in an any shape occupied by a particular object extracted from a moving image.

Furthermore, the ROI setting unit 1040 transmits various kinds of additional information (which will be referred to as the “ROI additional information” hereafter) such as the priority of the ROI and so forth, to an ROI coding unit 1050 and a multiplexing unit 1092.

The ROI coding unit 1050 performs coding of the ROI thus set by the ROI setting unit 1040 with a higher priority than that of other regions in cooperation with a quantization unit 1030. For example, with the present embodiment, the ROI is quantized using a special quantization table such that the quantization step, which is to be applied, is reduced, or such that the number of lower bits, which are to be truncated, is reduced. This ensures that the ROI coding unit 1050 performs coding of the ROI with a greater effective bit number. This provides high priority coding of the ROI, thereby providing reproduction of the ROI with a higher image quality than reproduction of other regions after the decoding of a moving image stream.

In a case that the priority is set for each of the multiple regions, the ROI coding unit 1050 performs coding of the regions in order starting with the highest priority. That is to say, the effective bit number, with which the coding is performed, is increased according to the increase in the priority of the ROI.

A motion compensation unit 1060 performs motion compensation for each macro block of a P frame or B frame using a prior or upcoming image frame stored in the frame memory 1080 as a reference image, thereby creating the motion vector and the predicted image. The motion compensation unit 1060 performs subtraction between the image of the P frame or B frame to be coded and the predicted image, and supplies the subtraction image to a DCT unit 1020. Furthermore, the motion compensation unit 1060 supplies the coded motion vector information to the multiplexing unit 1092.

The DCT unit 1020 performs discrete cosine transform (DCT) for the image supplied from the motion compensation unit 1060, and transmits the DCT coefficients thus obtained to a quantization unit 1030.

The quantization unit 1030 performs quantization of the DCT coefficients, and transmits the quantized DCT coefficients to a variable-length coding unit 1090. The variable-length coding unit 1090 performs variable-length coding of the quantized DCT coefficients of the subtraction image, and transmits the coded data to a multiplexing unit 1092.

The multiplexing unit 1092 performs multiplexing of the coded DCT coefficients supplied from the variable-length coding unit 1090, and the coed motion vector information supplied from the motion compensation unit 1060, thereby creating a coded stream. The multiplexing unit 1092 creates a coded stream with the coded frames being sorted in order of time. Furthermore, the multiplexing unit 1092 appends the ROI information and the ROI additional information, which have been supplied from the ROI setting unit 1040, to the header of the coded stream.

Description has been made regarding coding processing for a P frame or B frame, in which the motion compensation unit 1060 operates as described above. On the other hand, in a case of coding processing for an I frame, the I frame subjected to intra-frame prediction is supplied to the DCT unit 1020 without involving the motion compensation unit 1060. Note that this coding processing is not shown in the drawings.

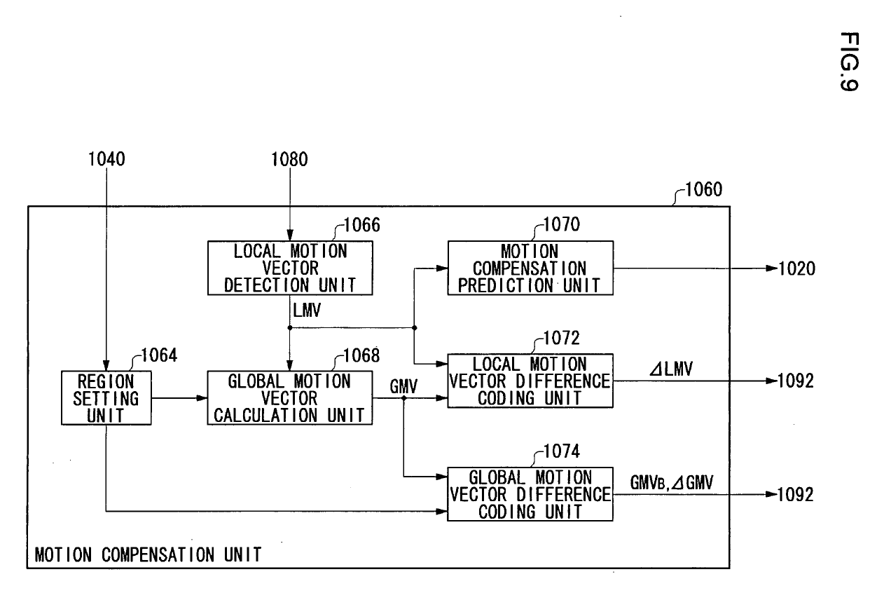

FIG. 9 is a diagram for describing the configuration of the motion compensation unit 1060. The motion compensation unit 1060 detects a motion vector for each macro block in a coding target image (which will be referred to as the “local motion vector” hereafter). At the same time, the motion compensation unit 1060 obtains a motion vector which indicates the global motion within the ROI for each of the predetermined ROIs set in the image (which will be referred to as the “global motion vector” hereafter). The motion compensation unit 1060 performs motion prediction based upon the local motion vector, and outputs a subtraction image. At the same time, the motion compensation unit 1060 performs coding of the difference between each of the local motion vectors and the global motion vector, and outputs the calculation results in the form of motion vector information.

The local motion vector detection unit 1066 detects the predicted macro block which exhibits the least difference from the target macro block in the coding target image with reference to the reference image held by the frame memory 1080, and obtains the local motion vector LMV which represents the motion from the target macro block to the predicted macro block. This motion detection is performed by searching the reference image for the reference macro block that matches the target macro block in units of pixels, or in units of fractions of a pixel. In general, searching is repeatedly performed multiple times within a pixel region, and the reference macro block which best suits the target macro block is selected as the predicted macro block.

The local motion vector detection unit 1066 transmits the local motion vector LMV thus obtained to a global motion vector calculation unit 1068, a motion vector prediction unit 1070, and a local motion vector difference coding unit 1072.

The motion compensation prediction unit 1070 performs motion compensation for the target macro block using the local motion vector LMV, thereby creating a predicted image. Furthermore, the motion compensation prediction unit 1070 creates a subtraction image by making a subtraction between the coding target image and the predicted image, and outputs the subtraction image to the DCT unit 1020.

A region setting unit 1064 sets a region for calculating the global motion vector GMV in a frame image (which will be referred to as the “global region” hereafter). In this step, the region setting unit 1064 sets the global region to be in the same position in the frame image as that of the ROI set by the ROI setting unit 1040 with reference to the ROI information supplied from the ROI setting unit 1040. Thus, the global region is connected with the ROI set by the ROI setting unit 1040.

The region setting unit 1064 transmits the position information with respect to the global region thus set (which will be referred to as the “global region information” hereafter) to the global motion vector calculation unit 1068 and a global motion vector subtraction coding unit 1074.

The global motion vector calculation unit 1068 calculates the global motion vector GMV which indicates the global motion in each global region set by the region setting unit 1064. For example, the global motion vector calculation unit 1068 calculates the average of the local motion vectors LMV within a region, and employs the average as the global motion vector GMV.

Furthermore, an arrangement may be made in which the global motion vector calculation unit 1068 acquires the information with respect to the global motion in each global region, and calculates the global motion vector GMV for each global region based upon the information thus acquired. For example, an arrangement may be made in which, in a case of the camera zooming or panning, or in a case of scrolling the screen, the global motion vector calculation unit 1068 determines the global motion for each global region based upon the information with respect to the overall region of the screen, thereby calculating the global motion vector GMV. Also, an arrangement may be made in which the global motion vector calculation unit 1068 automatically extracts the motion of a particular object such as a human figure or the like in the image, and determines the global motion for each global region based upon the motion of that object, thereby calculating the global motion vector GMV.

The global motion vector calculation unit 1068 transmits the global motion vector GMV thus obtained to the local motion vector difference coding unit 1072 and the global motion vector difference coding unit 1074.

The local motion vector difference coding unit 1072 receives the local motion vector LMV from the local motion vector detection unit 1066, and receives the global motion vector GMV from the global motion vector calculation unit 1068, respectively. Then, the local motion vector difference coding unit 1072 calculates the difference between the local motion vector LMV and the global motion vector GMV for each global region, i.e., the local motion vector difference ΔLMV=LMV−GMV, and performs variable length coding of the local motion vector difference ΔLMV. The local motion vector difference coding unit 1072 transmits the coded local motion vector difference ΔLMV to the multiplexing unit 1092 in the form of motion vector information.

The global motion vector difference coding unit 1074 receives the global motion vector GMV for each region as an input from the global motion vector calculation region 1068, and selects at least one global motion vector GMV as a reference from among the set of global motion vectors GMV, each of which is obtained for the corresponding region. The global motion vector GMV which is selected as a reference will be referred to as the “reference global motion vector GMVB”. The global motion vector difference coding unit 1074 calculates the difference ΔGMV=GMV−GMV_{B}, which is the difference between the reference global motion vector GMVB and each of the global motion vectors GMV other than the reference global motion vector GMV_{B}, and performs variable-length coding of the difference between the reference motion vector GMV_{B} and the global motion vector difference ΔGMV.

The global motion vector difference coding unit 1074 transmits the coded reference global motion vector GMVB and the coded global motion vector difference ΔGMV for each global region to the multiplexing unit 1092 in the form of motion vector information. In this stage, the global motion vector difference coding unit 1074 appends the global region information set by the region setting unit 1064 as a part of the motion vector information. The global region information is the same as the ROI information supplied from the ROI setting unit 1040.

The multiplexing unit 92 receives the reference global motion vector GMV_{B}, the global motion vector difference ΔGMV, and the local motion vector difference ΔLMV, in the form of motion vector information.

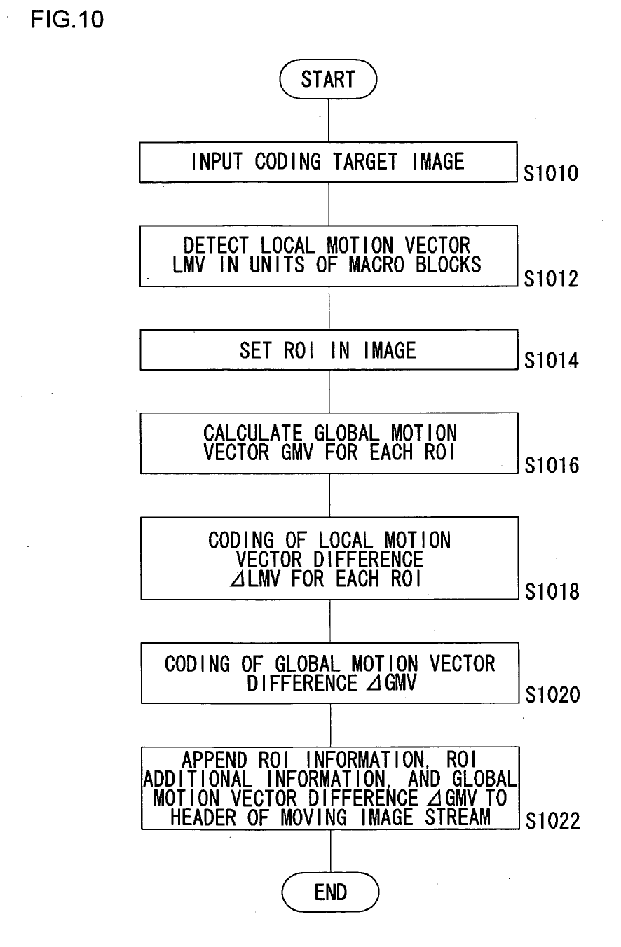

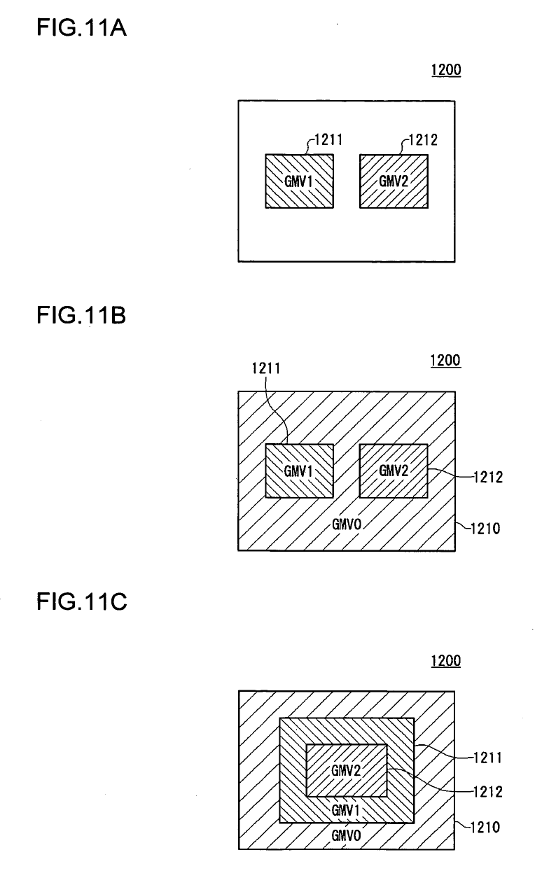

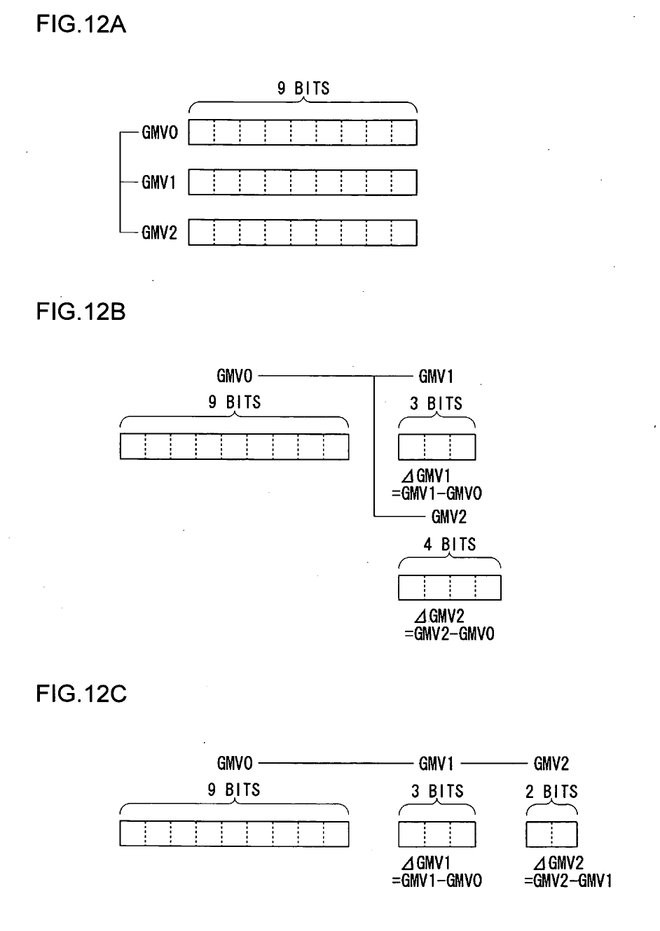

FIG. 10 is a flowchart for describing the coding procedure for the motion vector difference performed by the motion compensation unit 1060. Description will be made regarding the coding procedure with reference to examples shown in FIGS. 11A through 11C, and FIG. 12A through FIG. 12C, as appropriate.

A coding target image is input to the frame memory 1080 of the coding device 1100 (S110). The local motion vector detection unit 1066 of the motion compensation unit 1060 detects the local motion vectors LMV for each macro block in the coding target image (S1012).

The ROI setting unit 1040 sets a ROI in the image (S1014). The global motion vector calculation unit 1068 calculates the global motion vector GMV for each ROI (1016).

The local motion vector difference coding unit 1072 calculates the local motion vector differences ΔLMV for each ROI, and performs coding thereof (S1018). The global motion vector difference coding unit 1074 calculates the global motion vector difference ΔGMV for each global region, and performs coding thereof (S1020).

The multiplexing unit 1092 appends the ROI information, the ROI additional information, and the coded global motion vector differences ΔGMV to the header of the coded stream of the moving image (S1022).

FIGS. 11A through 11C are diagrams for describing an example of the ROI. In the example shown in FIG. 11A, the ROI setting unit 1040 sets a first ROI 1211 and a second ROI 1212 in a coding target image 1200. The global motion vector calculation unit 1068 obtains a first global motion vector GMV1 for the first ROI 1211, and a second global motion vector GMV2 for the second ROI 1212. In this example, there is no region set to be a ROI in the background region other than the first ROI 1211 and the ROI 1212. Accordingly, the global motion vector calculation unit 1068 does not obtain any global motion vector in the background region other than the first ROI 1211 and the ROI 1212.

In the example shown in FIG. 11A, in a case of coding the local motion vectors LMV within the first ROI 1211, the local motion vector difference coding unit 1072 obtains ALMV=LMV−GMV1, which is the difference between the local motion vector LMV and the first global motion vector GMV1, for each macro block, and performs coding thereof. In the same way, in a case of coding the local motion vectors LMV within the second ROI 1212, the local motion vector difference coding unit 1072 obtains ΔLMV=LMV−GMV2, which is the difference between the local motion vector LMV and the second global motion vector GMV2, for each macro block, and performs coding thereof.

In the example shown in FIG. 11A, the global motion vector GMV is not obtained for any region in the background region other than the first ROI 1211 and the second ROI 1212. Accordingly, in a case of coding the local motion vectors in the background region, the local motion vector difference coding unit 1072 performs coding of each local motion vector LMV without calculating the difference between the local motion vector LMV and the global motion vector GMV, i.e., without performing computation before the coding.

In the example shown in FIG. 11B, the ROI setting unit 1040 sets the background region other than the first ROI 1211 and the second ROI 1212 to be a third ROI 1210, unlike the example shown in FIG. 11A. The global region vector calculation unit 1068 obtains a third global motion vector GMV0 for the third ROI 1210. In a case of coding the local motion vectors LMV within the third ROI 1210, the local motion vector difference coding unit 1072 calculates ΔLMV=LMV−GMV0, which is the difference between the local motion vector LMV and the third global motion vector GMV0, for each macro block in the third ROI 1210, and performs coding thereof.

Note that, in the example shown in FIG. 11A, the ROI setting unit may set the background region other than the first ROI 1211 and the second ROI 1212 to be a ROI with a lower coding priority. With such an arrangement, the global motion vector calculation unit 1068 also obtains the global motion vector for the background region. In general, in a case that ROIs have been determined, the region not included in the ROIs is automatically set to be a non-ROI. In this case, the non-ROI may be set to be the lowest priority ROI.

FIG. 11C shows an example in which there is an inclusion relation among multiple global regions in the coding target image 1200. In this example, the second ROI 1212 is included in the first ROI 1211. Furthermore, the entire areas of the first ROI 1211 and the second ROI 1212 are included in the third ROI 1210.

In a case of coding the local motion vectors LMV within the second ROI 1212, the local motion vector difference coding unit 1072 performs coding of the difference between the local motion vector LMV and the second global motion vector GMV2 for each macro block. On the other hand, in a case of coding the local motion vectors LMV in a region which is inside the first ROI 1211 and is outside the second ROI 1212, the local motion vector difference coding unit 1072 performs coding of the difference between the local motion vector LMV and the first global motion vector GMV1 for each macro block. On the other hand, in a case of coding the local motion vectors LMV in a region which is inside the ROI 1210 and is outside the first ROI 1211, the local motion vector difference coding unit 1072 performs coding of the difference between the local motion vector LMV and the third global motion vector GMV0 for each macro block.

FIGS. 12A through 12C are diagrams for describing examples of the calculation of the global motion vector difference performed by the global motion vector difference coding unit 1074. Here, description will be made regarding examples in which three ROIs are set as shown in FIG. 11B or 11C, the three global motion vectors GMV0, GMV1, and GMV2, are obtained for the three respective ROIs, and the three global motion vectors GMV0, GMV1, and GMV2 are coded.

FIG. 12A shows an arrangement in which the three global motion vectors GMV0, GMV1, and GMV2 are handled without involving any hierarchical structure. With such an arrangement, the global motion vector difference coding unit 1074 handles all the three global motion vectors GMV0, GMV1, and GMV2 as a set of reference global motion vectors. Specifically, the global motion vector difference coding unit 1074 performs coding of the 9-bit global motion vectors GMV0, GMV1, and GMV2 without calculating the global motion vector difference, i.e., without performing any calculation before the coding, and outputs the coded global motion vectors.

FIG. 12B shows an arrangement in which the three global motion vectors GMV0, GMV1, and GMV2 are handled in a hierarchical structure. With such an arrangement, GMV0 serves as a global motion vector at a higher hierarchical level. On the other hand, each of GMV1 and GMV2 serves as a global motion vector at a hierarchical level immediately lower than that of GMV0. With such an arrangement, the global motion vector difference coding unit 1074 performs coding of each of the global motion vectors GMV1 and GMV2 at the lower hierarchical level with the global motion vector GMV0 at the higher hierarchical level as a reference global motion vector. Specifically, the global motion vector difference coding unit 1074 performs coding of ΔGMV1=GMV1−GMV0, which is the difference between the global motion vector GMV1 and the reference global motion vector GMV0, and AGMV2=GMV2−GMV0, which is the difference between the global motion vector GMV2 and the reference global motion vector GMV0. Here, each of the global motion vectors GMV1 and GMV2 at the lower hierarchical level has a 9-bit original coding amount. With such an arrangement, the global motion vectors GMV1 and GMV2 are represented by reduced coding amounts, i.e., a 3-bit coding amount and the 4-bit coding amount, respectively, by calculating the difference between the global motion vector GMV1 and the higher hierarchical level global motion vector GMV0, and calculating the difference between the global motion vector GMV2 and the higher hierarchical level global motion vector GMV0.

FIG. 12C shows an arrangement in which the three global motion vectors GMV0, GMV1, and GMV2 are handled using another hierarchical structure. With such an arrangement, GMV0 serves as the global motion vector at the highest hierarchical level. GMV1 serves as the global motion vector at the next lower hierarchical level than that of GMV0, and GMV2 serves as the global motion vector at next lower hierarchical level than that of GMV1. With such an arrangement, the global motion vector difference coding unit 1074 performs coding of the global motion vectors GMV1 at the second hierarchical level with the global motion vector GMV0 at the first hierarchical level as a reference global motion vector. Specifically, the global motion vector difference coding unit 1074 performs coding of ΔGMV1=GMV1−GMV0, which is the difference between the global motion vector GMV1 and the reference global motion vector GMV0. Here, the second hierarchical level global motion vector GMV1 has a 9-bit original coding amount. With such an arrangement, the global motion vector GMV1 is represented by a reduced coding amount, i.e., a 3-bit coding amount, by calculating the difference between the global motion vector GMV1 and the first hierarchical level global motion vector GMV0.

Then, the global motion vector difference coding unit 1074 performs coding of ΔGMV2=GMV2−GMV1, which is the difference between the third hierarchical level global motion vector GMV2 and the second hierarchical level global motion vector GMV1. Here, the third hierarchical level global motion vector GMV2 has a 9-bit original coding amount. With such an arrangement, the global motion vector GMV2 is represented by the reduced coding amount, i.e., a 2-bit coding amount, by calculating the difference between the third hierarchical level global motion vector GMV2 and the second hierarchical level global motion vector GMV1.

With either of the arrangements shown in FIG. 12B or FIG. 12, the global motion vector difference coding unit 1074 outputs the reference global motion vector GMV0 and the two global motion vector differences ΔGMV1 and ΔGMV2, as the motion vector information. In this stage, the information that indicates the hierarchical structure used for handling the three global motion vectors GMV0, GMV1, and GMV2 is appended as a part of the motion vector information.

As described above with reference to the examples shown in FIGS. 12B and 12C, an arrangement may be made in which the global motion vectors are handled in a hierarchical structure as appropriate. With such an arrangement, each of the global motion vectors is represented by a reduced coding amount by calculating the difference between the global motion vector and another global motion vector at an adjacent hierarchical level. Description has been made in the above examples regarding an arrangement in which coding is performed for the difference between the global motion vector at a lower hierarchical level and the global motion vector at a higher hierarchical level with the global motion vector at the higher hierarchical level as a reference. Also, an arrangement may be made in which coding is performed for the difference between the global motion vector at a lower hierarchical level and the global motion vector at a higher hierarchical level with the global motion vector at the lower hierarchical level as a reference.

The hierarchical structure for the global motion vectors may be determined regardless of the inclusion relation among the ROIs. Also, the hierarchical structure may be determined based upon the inclusion relation among the ROIs.

For example, let us consider a case in which the first ROI 1211 and the second ROI 1212 are included within the third ROI 1210 as shown in FIG. 11B. In this case, the global motion vector difference coding unit 1074 creates a hierarchical structure in which the global motion vector GMV0 of the third ROI 1210 is set to a higher hierarchical level, and the global motion vectors GMV1 and GMV2 of the first and second global ROIs 1211 and 1212 are set to the immediately lower hierarchical level, based upon the inclusion relation among these ROIs, as shown in FIG. 12B. The global motion vector difference coding unit 1074 performs coding of the global motion vector difference using the hierarchical structure thus created.

Next, let us say that there is an inclusion relation in which the second ROI 1212 is included within the first ROI 1211, and the entire areas of the first ROI 1211 and the second ROI 1212 are included within the third ROI 1210. In this case, the global motion vector difference coding unit 1074 creates a hierarchical structure in which the global motion vector GMV0 of the third ROI 1210 is set to the highest hierarchical level, the global motion vector GMV1 of the first ROI 1211 is set to a second hierarchical level, and the global motion vector GMV2 of the second ROI 1212 is set to a third hierarchical level. The global motion vector difference coding unit 1074 performs coding of the global motion vector difference using the hierarchical structure thus created.

With such an arrangement in which the hierarchical structure for the global motion vectors is created just in accordance with the inclusion relation among the global regions set by the ROI setting unit 1040, and the information with respect to the inclusion relation among the ROIs is included as a part of the motion vector information, there is no need to provide the information with respect to the hierarchical structure for the global motion vectors in the form of additional information. Such an arrangement reduces the amount of data in the header information.

Also, let us consider a case in which the inclusion relation among the ROIs reflects the relative difference in the motion amount in the image such as the difference in the motion amount between the region around the center and the back ground region in the image, the difference in the motion amount between the region of a particular object and the background region other than the region of the particular object, and so forth. In this case, with such an arrangement in which the hierarchical structure for the global motion vectors is created such that it just reflects the inclusion relation among the global regions, and the global motion vector difference is obtained according to the hierarchical structure thus created, in general, it will be anticipated that the global motion vector difference can be represented with a fewer number of bits.

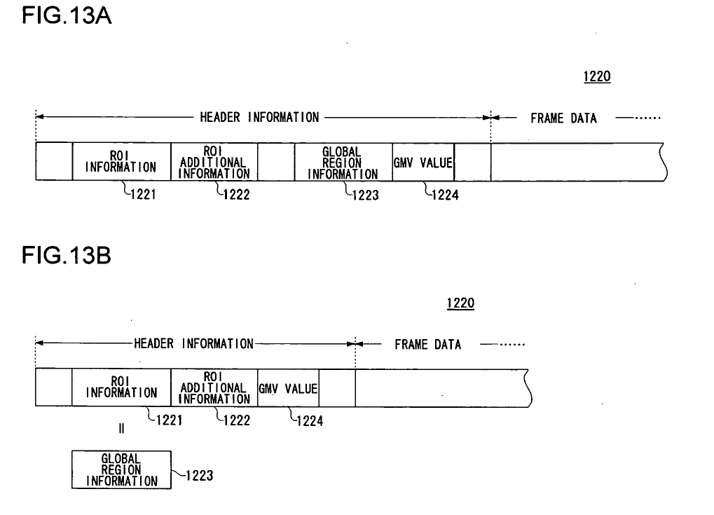

FIGS. 13A and 13B are diagrams for describing the data structure of a coded stream 1220 created by the multiplexing unit 1092. The coded stream 1220 comprises header information and frame data.

FIG. 13A shows a data structure of the coded stream 1220 having the header information which stores ROI information 1221, ROI additional information 1222, global region information 1223, and the coded global motion vector difference (which will be referred to as the “GMV value” hereafter) 1224.

With the present Embodiment 2, the ROIs set by the ROI setting unit 1040 are directly employed as the global regions for obtaining the global motion vectors. That is to say, the ROI information 1221 is the same as the global region information 1223. Accordingly, it is sufficient to store either the ROI information 1221 or the global region information 1223 in the header of the coded stream.

FIG. 13B shows another data structure of the coded stream 1220 having the header information which stores the ROI information 1221, the ROI additional information 1222, and the coded global motion vector difference (the “GMV value”) 1224. With the coded stream 1220 shown in FIG. 13B, the ROI information 1221 is also used as the global region information 1223. As described above, an arrangement may be made in which the header information of the coded stream 1220 stores only either of the ROI information 1221 or the global region information 1223, and whichever one kind of information thus stored is substituted for the other. Such an arrangement reduces the data mount of the header information, thereby improving the compression efficiency for the moving image stream.

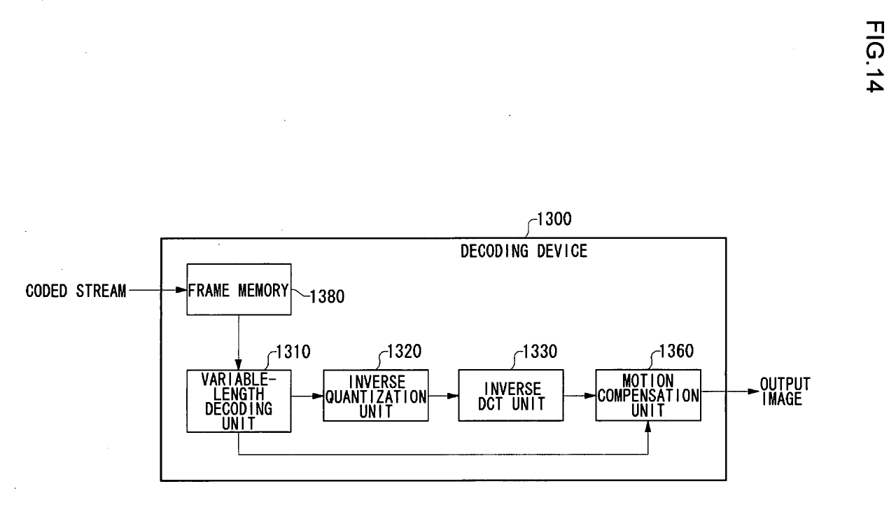

FIG. 14 is a configuration diagram which shows the decoding device 1300 according to the Embodiment 2. The functional block configuration can also be realized by hardware components alone, software components alone, or combinations thereof.

The decoding device 1300 receives a coded stream in the form of input data, and decodes the coded stream, thereby creating an output image. The coded stream thus input is stored in frame memory 1380.

A variable-length decoding unit 1310 performs variable-length decoding of the coded stream stored in the frame memory 1380, and transmits the decoded image data to an inverse-quantization unit 1320. On the other hand, the variable-length decoding unit 1310 transmits the decoded motion vector information to a motion compensation unit 1360.

The inverse-quantization unit 1320 performs inverse-quantization of the image data decoded by the variable-length decoding unit 1310, and transmits the image data thus inverse-quantized to an inverse DCT unit 1330. The image data inverse-quantized by the inverse quantized unit 1320 is a DCT coefficient set. The inverse DCT unit 1330 performs inverse discrete cosine transform (IDCT) for the DCT coefficient set thus inverse-quantized by the inverse quantization unit 1320, thereby reconstructing the original image data. The image data reconstructed by the inverse DCT unit 1330 is transmitted to the motion compensation unit 1360.

The motion compensation unit 1360 creates a predicted image based upon the motion vector information supplied from the variable-length decoding unit 1310 using the prior or upcoming image frame as a reference image. Then, the motion compensation unit 1360 reconstructs the original image data by making the sum of the predicted image and the subtraction image supplied from the inverse DCT unit 1330, and outputs the original image data thus reconstructed.

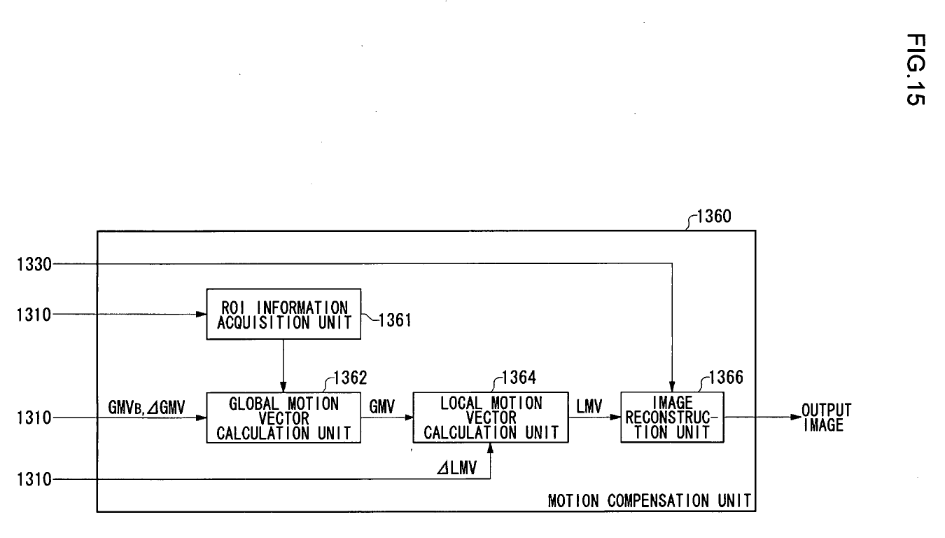

FIG. 15 is a diagram for describing the configuration of the motion compensation unit 1360. The coded stream, which has been coded by the coding device 1100 shown in FIG. 8, is input to the decoding device 1300. The motion vector information, which is supplied to the motion compensation unit 1360, includes: the reference global motion vector GMV_{B}; the global motion vector difference ΔGMV; and the local motion vector difference ΔLMV. The motion compensation unit 1360 obtains the local motion vectors LMV in the decoding target frame with reference to this motion vector information, and performs motion compensation.

An ROI information acquisition unit 1361 acquires the ROI information from the variable-length decoding unit 1310, determines a global region for obtaining the global motion vector with reference to the ROI information thus acquired, and transmits the global region information to a global motion vector calculation unit 1362.

A global motion vector calculation unit 1362 receives the reference global motion vector GMV_{B} and the global motion vector difference ΔGMV for each global region in the form of input from the variable-length decoding unit 1310, calculates the global motion vector GMV=ΔGMV+GMV_{B} for each global region specified by the ROI information acquisition unit 1361, and transmits the global motion vector GMV to a local motion vector calculation unit 364.

The local motion vector calculation unit 1364 receives the local motion vector difference ΔLMV in the form of input from the variable-length decoding unit 1310, and the global motion vector GMV for each global region in the form of input from the global motion vector calculation unit 1362. Then, the local motion vector calculation unit 1364 calculates the local motion vector LMV=ΔLMV+GMV. The local motion vector calculation unit 1364 transmits the local motion vectors LMV thus calculated for each global region, to an image reconstruction unit 1366.

The image reconstruction unit 1366 creates a predicted image using the reference image and the local motion vectors LMV each of which has been calculated for the corresponding macro block within each global region. Then, the image reconstruction unit 1366 reconstructs the original image by calculating the sum of the subtraction image received from the inverse DCT unit 1330 and the predicted image thus created, and outputs the original image thus reconstructed.

As described above, with the coding device 1100 according to the Embodiment 2, the global regions, each of which is set for obtaining the global motion vector that represents the overall motion of the individual motion vectors in an image, are connected to the respective ROIs. This provides the global regions having the advantage of high coding efficiency.

In general, examples of the ROIs thus selected include: a region around the center of the screen, which is often occupied by a moving object; a region where a particular moving object is displayed; etc. Accordingly, in many cases, principal motion can be captured for each ROI thus set in a moving image. With the present embodiment, each of the global region is connected to the corresponding ROI, thereby permitting suitable selection of the regions where the global motion vectors each of which indicates global motion are to be obtained. Furthermore, in general, it can be anticipated that the motion is approximately uniform over each ROI. This reduces the coding amount of the difference between each local motion vector and the global motion vector, thereby improving the coding efficiency.

Furthermore, such an arrangement in which each of the global regions is connected to the corresponding ROI enables either of the global region position information or the ROI position information to be substituted, one for the other. This reduces the data amount of the header information of the moving image stream.

Furthermore, with the present embodiment, before the coding of the motion vectors, the information with respect to the motion vector within a ROI is represented by the difference between the motion vector and the global motion vector of this ROI. Such an arrangement enables the amount of data of the information with respect to the individual motion vectors to be reduced. This reduces the overall coding amount of the moving image stream, thereby improving the compression efficiency. Furthermore, with the present embodiment, multiple ROIs are provided, a global motion vector is obtained for each ROI, and the difference is calculated between each local motion vector and the global motion vector for each ROI. Such an arrangement provides the smaller local motion vector differences for each ROI than those with an arrangement in which a single global motion vector is provided over the entire image and the difference is calculated between each local motion vector and the single global motion vector. This further reduces the coding amount of the motion vector information.

Furthermore, with the present embodiment, the global motion vectors of the ROIs are handled in a hierarchical structure, and coding is performed for the difference between the global motion vectors at different hierarchical levels. Such an arrangement enables the coding amount of the motion vector information to be further reduced.

With the decoding device 1300 according to the Embodiment 2, the position information with respect to ROIs and the local motion vector differences are acquired from a highly compressed moving image stream coded by the coding device 100, the local motion vector is obtained by adding the local motion vector difference to the global motion vector for each ROI, and motion compensation is performed based upon each local motion vector thus obtained. Such an arrangement provides reconstruction of a high-quality moving image. Furthermore, with such an arrangement, the ROIs are coded with high priority. Such an arrangement provides global motion compensation linked to the individual ROIs while providing high-quality image reconstruction of the individual ROIs. This provides higher-quality moving-image reconstruction of the individual ROIs.

Description has been made regarding the Embodiment 2 with reference to the Examples. The above-described Examples have been described for exemplary purposes only, and are by no means intended to be interpreted restrictively. Rather, it can be readily conceived by those skilled in this art that various modifications may be made by making various combinations of the aforementioned components, processing, or the like, which are also encompassed in the technical scope of the Embodiment 2.

Description has been made in the present embodiment regarding an arrangement in which the coding device 1100 and the decoding device 1300 perform coding and decoding of the moving images in accordance with the MPEG series standards (MPEG-1, MPEG-2, and MPEG-4), the H.26x series standards (H.261, H.262, and H.263), or the H.264/AVC standard. Also, the Embodiment 2 may be applied to an arrangement in which coding and decoding are performed for moving images managed in a hierarchical manner having a temporal scalability. In particular, the present invention is effectively applied to an arrangement in which motion vectors are coded using the MCTF technique, which effectively reduces the coding amount.

The Embodiment 2 can also be expressed by the following items 1 through 9.

1. A coding method wherein coded moving image data includes: information for specifying regions which are defined in a picture that is a component of a moving image, and in which coding is performed with different image quality; and information for specifying a global motion vector that represents global motion within each of the regions defined in the picture where inter-picture prediction coding is to be performed.

2. A coding method described in 1, wherein the information for specifying regions thus included in the coded moving image data is also used as information for specifying the regions where the global motion vectors have been calculated.

3. A coding method described in 1 or 2, wherein multiple regions for which coding is performed with different image quality are defined in the pictures of the moving image, and wherein the coded moving image data includes the information for specifying the global motion vector obtained for at least one of the defined multiple regions.

4. A coding method described in 3, wherein, in a case that global motion vectors have been defined for two or more regions, the coded moving image data includes the information with respect to the difference between the global motion vectors obtained for the different regions.

5. A coding method described in 3, wherein, in a case that global motion vectors have been defined for two or more regions, at least one of the global motion vectors is selected as a reference, and the coded moving image data includes the information with respect to the difference between the global motion vector serving as the reference and each of the other global motion vectors.

6. A coding method described in 3, wherein, in a case that global motion vectors have been defined for two or more regions, the global motion vectors of these regions are handled in a hierarchical structure,

and wherein the coded moving image data includes the information with respect to the difference between global motion vectors in different hierarchical levels.

7. A coding method described in any one of 4 through 6, wherein, in a case that there is an inclusion relation among the multiple regions, the coded moving image data includes the information with respect to the differences between the global motion vectors of these regions in accordance with the order of the inclusion relation.

8. A coding method described in 7, wherein the coded moving image data includes the information with respect to the difference between a global motion vector of a region at a higher hierarchical level in the inclusion relation, which serves as a reference, and another global motion vector at a lower hierarchical level in the inclusion relation.

9. A coding method described in any one of 4 through 6, wherein, in a case that local motion vectors are defined in units of predetermined blocks in the pictures where the inter-picture prediction coding is performed, the coded moving image data includes the information with respect to the difference between the global motion vector and each of the local motion vectors for each region.

### Embodiment 3

Summary of this Embodiment

It is an object of Embodiment 3 to provide a coding technique and a decoding technique for a moving image which offer high coding efficiency and high-precision motion prediction.

With a coding method according to an aspect of the Embodiment 3, coded moving image data includes information with respect to a global motion vector that represents global motion which can be applied to multiple pictures which are to be subjected to inter-picture prediction coding over a group in units of groups including multiple pictures that form a moving image.

The “global motion vector” may be a vector which represents the overall motion of an entire image, or may be a vector which represents the overall motion of a predetermined region defined in an image.

The term “picture” as used herein represents a coding unit. The concept thereof includes the frame, field, and VOP (Video Object Plane).

The term “global motion vector which can be applied to multiple pictures which are to be inter-picture prediction coding over a group” includes the global motion vector which can be applied to each picture included in the group after correction thereof for the corresponding picture, as well as including the global motion vector which can be applied to each picture included in the group without any correction.

With such an aspect, coding of a moving image can be performed while tracing the global motion over multiple pictures that form the moving image.

The group may be a unit which can be decoded independently. The term “unit which can be decoded independently” represents a unit which can be displayed without error or drop frame without the need of decoding any reference picture included another unit which can be decoded independently. Examples of such units include the GOP (Group of Pictures) stipulated in the MPEG-2, the GOV (Group of Video Object Planes) stipulated in the MPEG-4, etc.

The coded moving image data may include the information with respect to the difference in the global motion vector between two groups among the groups. With such an arrangement, the global motion vector is obtained for each group, and the difference in the global motion vector is obtained between these groups. This reduces the coding amount of the global motion vectors.

The global motion vector may be a vector which represents the global motion within at least one region defined as a common region over multiple pictures which are to be inter-picture prediction coding over the group. This enables the global motion of a particular region, e.g., the center of the image, an important region occupied by the face of a human figure, a region occupied by a moving object, etc., to be captured. Also, such an arrangement enables the global motion within a particular region which exhibits a small amount of movement to be captured using the global motion.

An arrangement may be made in which the global motion vector that can be applied to multiple pictures which are to be subjected to inter-picture prediction coding is corrected for each picture included in the group, and the global motion vector thus corrected is employed as the global motion vector for the corresponding picture. Such correction may be performed according to the change in the speed of the global motion. With such an arrangement, the global motion vector, which can be applied to multiple picture, is corrected for each picture, thereby providing coding of a moving image with higher precision and with higher coding efficiency.

An arrangement may be made in which, in a case that the local motion vectors are defined in units of predetermined blocks for each of multiple pictures which are to be inter-picture prediction coding, the coded moving image data includes the information with respect to the difference between each of the local motion vectors defined for each picture and the global motion vector which can be applied to the multiple pictures which are to be inter-picture prediction coding. With such an arrangement, before the coding of each local motion vector, the difference is obtained between the local motion vector and the global motion vector which can be applied to the multiple pictures. This reduces the coding amount of the local motion vectors, thereby improving the compression efficiency of a moving image.

Note that any combination of the components or any manifestation of the Embodiment 3 realized by modification of a method, device, system, computer program, and so forth, is effective as the Embodiment 3.

Detailed Description of this Embodiment

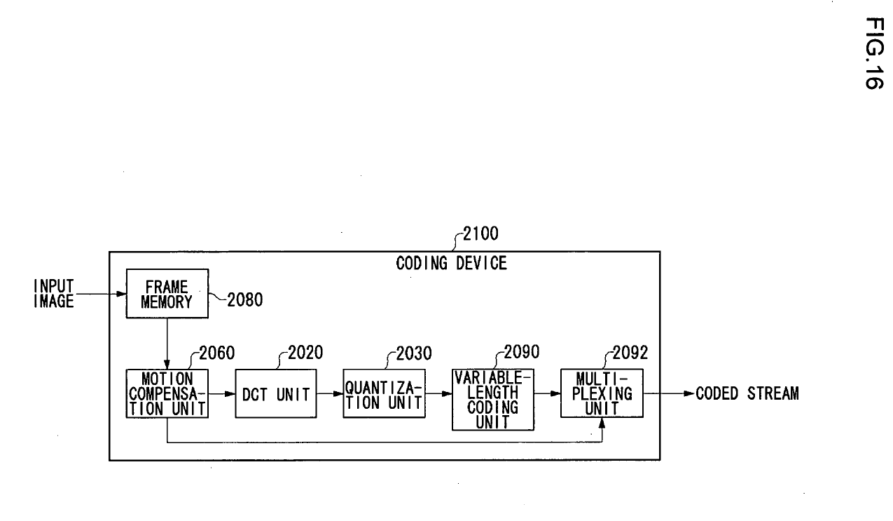

FIG. 16 is a configuration diagram which shows a coding device 2100 according to an Example 1 of an Embodiment 3. This configuration can be realized by hardware means, e.g., by actions of a CPU, memory, and other LSIs, of a computer, or by software means, e.g., by actions of a program having a function of image coding or the like, loaded into the memory. Here, the drawing shows a functional block configuration which is realized by cooperation between the hardware components and software components. It is needless to say that such a functional block configuration can be realized by hardware components alone, software components alone, or various combinations thereof, which can be readily conceived by those skilled in this art.

The coding device 2100 according to the present embodiment performs coding of moving images according to the MPEG (Moving Picture Experts Group) series standards (MPEG-1, MPEG-2, and MPEG-4) standardized by the international standardization organization ISO (International Organization for Standardization)/IEC (International Electrotechnical Commission), the H.26x series standards (H.261, H.262, and H.263) standardized by the international standardization organization with respect to electric communication ITU-T (International Telecommunication Union-Telecommunication Standardization Sector), or the H.264/AVC standard which is the newest moving image compression coding standard jointly standardized by both the standardization organizations (these organizations have advised that this H.264/AVC standard should be referred to as the “MPEG-4 Part 10: Advanced Video Coding” and “H.264”, respectively).

With the MPEG series standards, in a case of coding an image frame in the intra-frame coding mode, the image frame to be coded is referred to as the “I (Intra) frame”. In a case of coding an image frame with a prior frame as a reference image, i.e., in the forward interframe prediction coding mode, the image frame to be coded is referred to as the “P (Predictive) frame”. In a case of coding an image frame with a prior frame and an upcoming frame as reference images, i.e., in the bi-directional interframe prediction coding mode, the image frame to be coded is referred to as the “B frame”.

On the other hand, with the H.264/AVC standard, image coding is performed using reference images regardless of the time at which the reference images have been acquired. For example, image coding may be made with two prior image frames as reference images. Also, image coding may be made with two upcoming image frames as reference images. Furthermore, the number of the image frames used as the reference images is not restricted in particular. For example, image coding may be made with three or more image frames as the reference images. Note that, with the MPEG-1, MPEG-2, and MPEG-4 standards, the term “B frame” represents the bi-directional prediction frame. On the other hand, with the H.264/AVC standard, the time at which the reference image is acquired is not restricted in particular. Accordingly, the term “B frame” represents the bi-predictive prediction frame.

Note that the terms “frame” and “picture” as used in this specification have the same meaning. Accordingly, the “I frame”, “P frame”, and “B frame” will also be referred to as the “I picture”, “P picture”, and “B picture”, respectively.

The coding device 2100 receives an input moving image in units of frames, performs coding of the moving image, and outputs a coded stream. The moving image frames thus input are stored in frame memory 2080.

A motion compensation unit 2060 performs motion compensation for each macro block of a P frame or B frame using a prior or upcoming image frame stored in the frame memory 2080 as a reference image, thereby creating a motion vector and a predicted image. The motion compensation unit 2060 performs subtraction between the image of the P frame or B frame to be coded and the predicted image, and supplies the subtraction image to a DCT unit 2020. Furthermore, the motion compensation unit 2060 supplies the coded motion vector information to a multiplexing unit 2092.

The DCT unit 2020 performs discrete cosine transform (DCT) processing for the image supplied from the motion compensation unit 2060, and supplies the DCT coefficients thus obtained, to a quantization unit 2030.

The quantization unit 2030 performs quantization of the DCT coefficients and supplies the quantized DCT coefficients to the variable-length coding unit 2090. The variable-length coding unit 2090 performs variable-length coding processing for the quantized DCT coefficients of the subtraction image, and transmits the DCT coefficients subjected to the variable-length coding processing to the multiplexing unit 2092. The multiplexing unit 2092 multiplexes the coded DCT coefficients received from the variable-length coding unit 2090 and the coded motion vector information received from the motion compensation unit 2060, thereby creating a coded stream. The multiplexing unit 2092 creates a coded stream with the coded frames in order of time.

Description has been made regarding coding processing for a P frame or B frame with the operation of the motion compensation unit 2060 being as described above. On the other hand, in a case of coding processing for an I frame, the I frame subjected to intra-frame prediction is supplied to the DCT unit 2020 without involving the motion compensation unit 60. Note that this coding processing is not shown in the drawings.

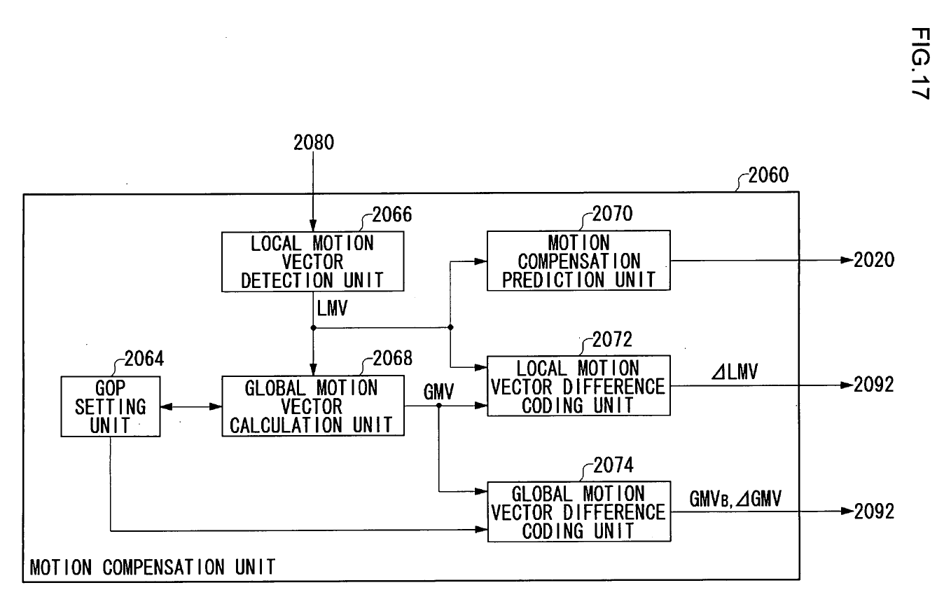

FIG. 17 is a diagram for describing the configuration of the motion compensation unit 2060. The motion compensation unit 2060 detects a motion vector for each macro block in a coding target image (which will be referred to as the “local motion vector” hereafter). At the same time, the motion compensation unit 2060 handles multiple coding target frames as a group, and obtains a motion vector that indicates the global motion, which is common to the coding target frames in the group, for each group (which will be referred to as the “global motion vector” hereafter). Here, the global motion vector is a vector which indicates the overall motion of the entire image or a predetermined area provided in the image. The global motion vector represents the individual local motion vectors obtained in units of macro blocks in the image or a predetermined region.

The motion compensation unit 2060 performs motion prediction based upon the local motion vector, and outputs a subtraction image. At the same time, the motion compensation unit 2060 performs coding of the difference between each of the local motion vectors and the global motion vector, and outputs the calculation results in the form of motion vector information.

The local motion vector detection unit 2066 detects the predicted macro block which exhibits the least difference from the target macro block in the coding target image with reference to the reference image held by the frame memory 2080, and obtains the local motion vector LMV which represents the motion from the target macro block to the predicted macro block. This motion detection is performed by searching the reference image for the reference macro block that matches the target macro block in units of pixels, or in units of fractions of a pixel. In general, searching is repeatedly performed multiple times within a pixel region, and the reference macro block which best suits the target macro block is selected as the predicted macro block.

The local motion vector detection unit 2066 transmits the local motion vector LMV thus obtained to the global motion vector calculation unit 2068, a motion vector prediction unit 2070, and a local motion vector difference coding unit 2072.

The motion compensation prediction unit 2070 performs motion compensation for the target macro block using the local motion vector LMV, thereby creating a predicted image. Furthermore, the motion compensation prediction unit 2070 creates a subtraction image by making a subtraction between the coding target image and the predicted image, and outputs the subtraction image to the DCT unit 2020.

A GOP setting unit 2064 sets a GOP (Group of Pictures) which is unit that comprises a group of a sequence of multiple moving image frames. In general, fast-forward and reverse reproduction of a moving image, and random access of moving image data, are performed in increment of GOPs.

Note that the term “GOP” is a term stipulated in the MPEG-2. On the other hand, the picture is referred to as the “VOP (Video Object Plane)” in the MPEG-4. Accordingly, the term “GOV (Group of Video Object Planes)” is used in the MPEG-4, instead of the technical term “GOP”. In the present specification, the standard of moving image compression coding technique employed in the present invention is not restricted to one of these two standards. Here, the technical term “GOP” will be used hereafter as a general term that refers to a group that consists of multiple frames.

The number of frames included in a GOP may be fixed at a predetermined number, or it may be variable. With an arrangement in which the number of the frames included in the GOP is variable, the GOP setting unit 2064 may adjust the number of frames included in the GOP based upon the speed of the global motion in a moving image. For example, the GOP setting unit 2064 may reduce the number of frames included in the GOP according to the increase in the speed of the global motion. In other words, the GOP setting unit 2064 may increase the number of frames included in the GOP according to the reduction in the speed of the global motion.

With such an arrangement, in a case that the global motion is rapid, the GOP is formed of a relatively small number of frames. This enables the global motion in a moving image to be represented with high precision by the global motion vector which is common within each GOP. Conversely, let us consider a case in which there is relatively slow global motion. In this case, the GOP formed of an increased number of frames is sufficient for enabling the global motion in a moving image to be represented by the global motion vector which is common within each GOP.

In general, the GOP includes an I frame which is not to undergo inter-frame prediction coding. On the other hand, the motion compensation unit 2060 performs motion prediction processing for the frames which are to be subjected to inter-frame prediction coding. Accordingly, description of the I frames included in the GOP will be omitted, and description will be made regarding only the frames which are to be subjected to inter-frame prediction coding. Note that I frame included in the GOP is used as a reference image for motion prediction.

Let us consider a case in which the global motion is obtained for a particular region in an image, instead of a case in which the global motion is obtained for the entire image. In this case, the GOP setting unit 2064 sets a region for obtaining a global motion vector GMV (which will be referred to as the “global region” hereafter). The global region is set to be common to all the frames included in the GOP. That is to say, the global region is set to the same position in all the frames included in the GOP.

Multiple global regions may be set in an image. For example, an arrangement may be made in which the GOP setting unit 2064 sets one global region around the center of the frame image, and sets the perimeter region other than the center region to be another global region. Also, the global region may be set by the user.

Also, an arrangement may be made in which, in a case that the image includes a particular object such as a human figure or the like, the GOP setting unit 2064 automatically extracts the region occupied by the object, which can have any shape, and the region thus extracted is set to be a global region.

Also, an arrangement may be made in which the GOP setting unit 2064 automatically extracts a region occupied by the macro blocks having roughly the same motion with reference to the local motion vectors LMV in the image detected by a local motion vector detection unit 2066, and sets the region thus extracted to be a global region.

The GOP setting unit 2064 transmits the information with respect to the GOP such as the information with respect to the number of frames which form the GOP thus determined, the information with respect to the global regions thus set, and so forth, to the global motion vector calculation unit 2068 and a global motion vector difference coding unit 2074.

The global motion vector calculation unit 2068 calculates the global motion vector GMV, which is applied in common to multiple frames, which are to be subjected to inter-frame prediction coding in the GOP (which will simply be referred to as the “common global motion vector GMV” hereafter). In a case that the GOP setting unit 2064 has set a global region for obtaining the common global motion vector GMV, the global motion vector calculation unit 2068 calculates the common global motion vector GMV which indicates the global motion in this global region. On the other hand, in a case that the GOP setting unit 2064 has not set a global region for obtaining the common global motion vector GMV, the global motion vector calculation unit 2068 calculates the common global motion vector GMV which indicates the global motion of the entire image.

Description will be made regarding several methods used by the global motion vector calculation unit 2068 to obtain the common global motion vector GMV.

The global motion vector calculation unit 2068 acquires the local motion vectors LMV from the local motion vector detection unit 2066 in units of macro blocks defined in each frame included in the GOP. Then, the global motion vector calculation unit 2068 calculates the average of the local motion vectors LMV, which have been obtained in units of macro blocks, over the entire image for each frame included in the GOP, thereby obtaining the global motion vector GMV which indicates the global motion of the entire image for each frame. Next, the global motion vector calculation unit 2068 calculates the average of the global motion vectors GMV, each of which has been obtained for the corresponding frame, over all the frames included in the GOP, thereby obtaining the global motion vector GMV averaged over the GOP. The averaged global motion vector GMV thus obtained is set to be the common global motion vector GMV for the GOP. This provides the global motion vector that represents the global motion with high precision, which is common to the multiple frames included in the GOP.

Also, let us consider a case in which a global region is set for obtaining the global motion vector GMV in the procedure. In this case, the global motion vector may be obtained by calculating the average of the local motion vectors LMV over the global region thus set.

Also, another method may be employed to obtain the common global motion vector GMV, as follows. That is to say, the global motion vector calculation unit 2068 calculates the average of the local motion vectors LMV, which have been obtained in increments of macro blocks in a particular frame included in the GOP, over the entire area of this particular frame image, and the global motion vector GMV thus obtained is employed as the common global motion vector GMV which is common to all the frames included in the GOP. With such an arrangement, the global motion vector GMV obtained for a particular frame included in the GOP is also applied to other frames included in the GOP. Such an arrangement enables processing amount to be reduced as compared with a method in which the common global motion vector GMV is obtained by making the average of the local motion vectors LMV over all the frames included in the GOP.

Furthermore, an arrangement may be made in which the global motion vector calculation unit 2068 acquires the information with respect to the global motion in a moving image, and calculates the common global motion vector GMV for each GOP. For example, an arrangement may be made in which, in a case of the camera zooming or panning, or in a case of scrolling the screen, the global motion vector calculation unit 2068 determines the global motion in the moving image based upon the information with respect to the entire image, thereby calculating the common global motion vectors GMV in units of GOPs. Also, an arrangement may be made in which the global motion vector calculation unit 2068 automatically extracts the motion of a particular object such as a human figure or the like in the image, and determines the global motion based upon the motion of that object, thereby calculating the common global motion vectors GMV in units of GOPs.

The global motion vector calculation unit 2068 transmits the common global motion vector GMV, which has been thus obtained as a common value for the GOP, to a local motion vector difference coding unit 2072 and a global motion vector difference coding unit 2074.

The local motion vector difference coding unit 2072 receives the local motion vectors LMV from the local motion vector detection unit 2066 in units of frames, and receives the global motion vectors GMV from the global motion vector calculation unit 2068 in units of GOPs, respectively. Then, the local motion vector difference coding unit 2072 calculates the difference between each local motion vector LMV and the corresponding global motion vector GMV for each frame, i.e., the local motion vector difference ΔLMV=LMV−GMV, and performs variable length coding of the local motion vector difference ΔLMV thus calculated. The local motion vector difference coding unit 2072 transmits the coded local motion vector difference ΔLMV to the multiplexing unit 2092.

The global motion vector difference coding unit 2074 performs coding of the difference information with respect to the common global motion vector GMV. In order to reduce the coding amount of the common global motion vectors GMV, the differential coding of the common global motion vector GMV is performed in the following case.

(1) Let us consider a case in which multiple global regions are set in an image, and a common global motion vector GMV is obtained for each global region. In this case, coding is performed for each difference between the common global motion vectors GMV obtained in different global regions.

(2) Let us consider a case in which the GOP is divided into multiple sub-groups, and the common global motion vectors GMV are obtained in units of sub-groups in the GOP. In this case, coding is performed for each difference between the common global motion vectors GMV obtained in the different sub-groups.

(3) Let us consider a case in which a moving image is formed of a sequence of multiple GOPs. In this case, coding is performed for each difference between the common global motion vectors GMV obtained for the different GOPs.

In a case that the multiple common global motion vectors GMV are obtained, determination is made whether or not a method in which coding is performed for each difference obtained between these common global motion vectors GMV is advantageous from the perspective of the coding amount, as compared with another arrangement in which coding is performed for the individual common global motion vectors GMV. In a case that the determination is “YES”, the global motion vector difference coding unit 2074 performs coding of each difference between the common global motion vectors GMV.

Before the differential coding of the common global motion vectors GMV, the global motion vector difference coding unit 2074 receives multiple common global motion vectors GMV as input data from the global motion vector calculation unit 2068, and selects at least one global motion vector GMV as a reference from among these common global motion vectors GMV thus received. The global motion vector GMV which is selected as a reference will be referred to as the “reference common global motion vector GMVB”. The global motion vector difference coding unit 2074 calculates each difference ΔGMV=GMV−GMV_{B}, which is the difference between the reference global motion vector GMV_{B} and each of the other common global motion vectors GMV. Then, the global motion vector difference coding unit 2074 performs variable-length coding of the reference global motion vector GMV_{B} and the global motion vector differences ΔGMV.

The global motion vector difference coding unit 2074 transmits the coded reference global motion vector GMVB and the coded global motion vector differences ΔGMV to the multiplexing unit 2092 in the form of motion vector information. In this stage, the global motion vector difference coding unit 2074 acquires the information with respect to the number of frames included in the GOP, the region information with respect to the global region, the information with respect to the sub-groups (in a case that the GOP has been divided into sub-groups), and so forth, from the GOP setting unit. Then, the global motion vector difference coding unit 2074 appends the information thus acquired as a part of the motion vector information.

The multiplexing unit 2092 receives the reference global motion vector GMV_{B}, the global motion vector differences ΔGMV, and the local motion vector differences ALMV, in the form of motion vector information.

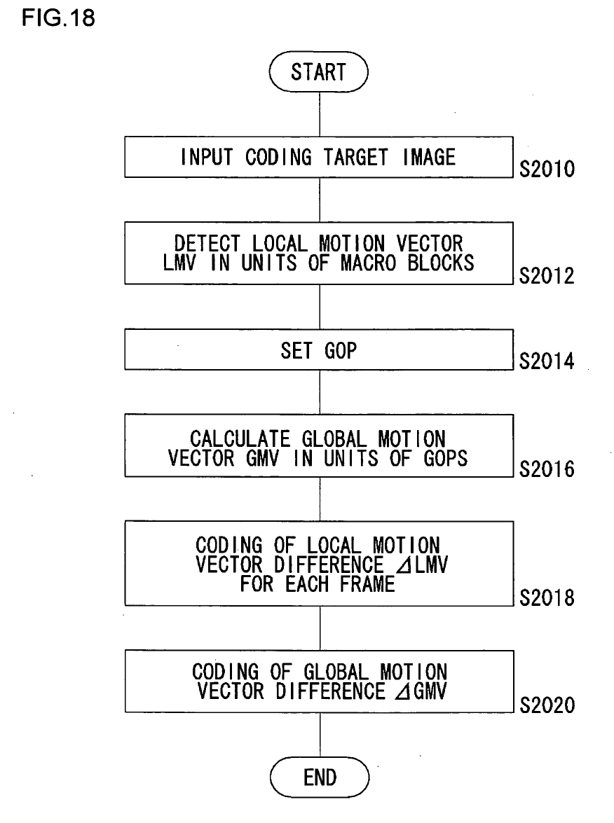

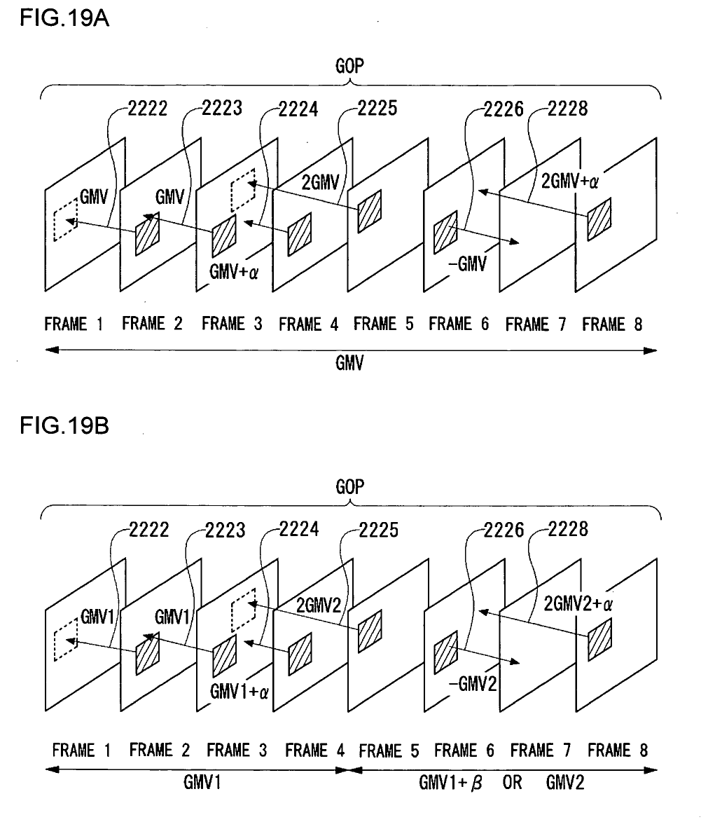

FIG. 18 is a flowchart for describing the coding procedure for the motion vector difference performed by the motion compensation unit 2060. Description will be made regarding the coding procedure with reference to examples shown in FIGS. 19A through 21, as appropriate.

A coding target image is input to the frame memory 2080 of the coding device 2100 (S2010). The local motion vector detection unit 2066 of the motion compensation unit 2060 detects the local motion vectors LMV in units of macro blocks in the coding target image (S2012).

Next, the GOP setting unit 2064 sets the information with respect to the GOP such as the number of frames which form the GOP, the global region for which the global motion is to be obtained, and so forth (S2014). The global motion vector calculation unit 2068 calculates the common global motion vectors GMV in units of GOPs (S2016).

The local motion vector difference coding unit 2072 obtains the difference between each of the local motion vectors LMV obtained for each frame included in the GOP and the common global motion vector GMV obtained for the GOP. Then, the local motion vector difference coding unit 2072 performs coding of the local motion vector differences ΔLMV (S2018). In a case that multiple common global motion vectors GMV have been obtained, the global motion vector difference coding unit 2074 obtains each difference between these common global motion vectors GMV thus obtained. Then, the global motion vector difference coding unit 2074 performs coding of the global motion vector differences ΔGMV thus obtained (S2020).

FIGS. 19A and 19B are diagrams for describing examples of the common global motion vectors GMV in units of GOPs formed of multiple moving image frames. Specifically, FIG. 19A shows an example in which eight frames, i.e., the frames 1 through 8, form a GOP. In this example, a single global motion vector GMV is obtained, which is shared by the frames 1 through 8. With such an arrangement, coding is performed for the difference between the common global motion vector GMV thus obtained and the local motion vector LMV obtained for each frame.

For example, let us consider a case in which differential coding is performed for the local motion vector LMV of the macro block indicated by the hatched region in the frame 2. In this case, as indicated by the reference numeral 2222, coding is performed for the local motion vector LMV of this macro block with reference to the macro block enclosed by the dotted line in the frame 1. Now, let us say that the local motion vector LMV is approximately the same as the common global motion vector GMV. In this case, the difference between the local motion vector LMV and the common global motion vector GMV is a value close to zero, thereby providing a reduced coding amount for the local motion vector LMV. Also, the local motion vector LMV of the macro block indicated by the hatched region in the frame 3 approximately matches the common global motion vector GMV, thereby providing a reduced coding amount for the local motion vector LMV.

Let us say that the local motion vector LMV of the macro block indicated by the hatched region in the frame 4 does not match the global motion vector GMV, and deviates from the global motion vector GMV by the difference vector α. That is to say, this relation is represented by the Expression, LMV=GMV+α. In this case, only the difference vector α is obtained by calculating the difference between the local motion vector LMV and the common global motion vector GMV. With such an arrangement, coding of the local motion vector LMV is performed by coding the difference vector α in the form of coded information. This provides a smaller coding amount than with an arrangement in which coding is performed for individual local motion vectors LMV.

Let us consider a case in which coding is performed for the local motion vector LMV of the macro block indicated by the hatched region in the frame 5, with reference to the macro block enclosed by the dotted line in the frame 3 which is two frames prior to the frame 5. In this case, before the differential coding of this local motion vector LMV, the difference is calculated between the local motion macro block, and the common global motion vector GMV multiplied by two. Let us say that the local motion vector LMV is approximately the same as the common global motion vector GMV multiplied by two. In this case, the difference is a value close to zero, thereby providing a reduced coding amount of the local motion vector LMV.

Let us consider a case in which coding is performed for the local motion vector LMV of the macro block indicated by the hatched region in the frame 6, with reference to the macro block in the frame 7 which is one frame after the frame 6. In this case, before the differential coding of this local motion vector LMV, the difference is calculated between the local motion macro block and the common global motion vector GMV multiplied by (−1). Let us say that the local motion vector LMV is approximately the same as the common global motion vector GMV multiplied by (−1). In this case, the difference is a value close to zero, thereby providing a reduced coding amount of the local motion vector LMV.

Let us consider a case in which coding is performed for the local motion vector LMV of the macro block indicated by the hatched region in the frame 8, with reference to the macro block in the frame 6 which is two frames prior to the frame 6. In this case, before the differential coding of this local motion vector LMV, the difference is calculated between the local motion macro block, and the common global motion vector GMV multiplied by two. Let us say that the local motion vector LMV does not match twice the common global motion vector GMV, and specifically, deviates therefrom by the difference vector α. That is to say, the local motion vector is represented by the Expression, LMV=2 GMV+α. Accordingly, the difference between the local motion vector LMV and the common global motion vector GMV multiplied by two matches the difference vector α. Thus, such an arrangement provides a reduced coding amount for the local motion vectors as compared to an arrangement in which coding is performed for individual local motion vectors LMV without any calculation before the coding.

FIG. 19B shows an arrangement which is the same as that shown in FIG. 19A, except for a step in which one GOP is divided into two sub-groups, and a common global motion vector GMV is obtained for each sub-group. Now, let us say that there is a change in the global motion between the frame 4 and the frame 5. In this case, the global motion is different between the first-half frame group of the frames 1 through 4 and the second-half frame group of the frames 5 through 8. Now, let us consider an arrangement in which a single common global motion vector GMV is obtained, which is common to the eight frames included in the GOP, and coding is performed for the difference between the single common global motion vector and each of the local motion vectors LMV. Such an arrangement cannot provide a small motion vector difference, leading to reduced coding amount reduction efficiency.

With such an arrangement, the global motion vector calculation unit 2068 detects a frame which shows the change in the global motion in the GOP, and divides the frames into the first-half frame group which consists of the frames prior to the point at which the change in the global motion has occurred, e.g., the frames 1 through 4, and the second-half frame group which consists of the frames after the point at which the change in the global motion has occurred, e.g., the frames 5 through 8. Then, global motion vector calculation unit 2068 obtains a common global motion vector GMV for each sub-group, and performs coding of the difference between each local motion vector LMV and the corresponding common global motion vector.

The global motion vector calculation unit 2068 obtains a first common global motion vector GMV1, which is shared by the four frames 1 through 4 included in the first-half sub-group, and a second common global motion vector GMV2, which is shared by the four frames 5 through 8 included in the second-half sub-group. Then, the global motion vector calculation unit 2068 transmits the first common global motion vector GMV1 and second common global motion vector GMV2 to the local motion vector difference coding unit 2072.

The local motion vector coding unit 2072 performs differential coding of the local motion vectors LMV in the frames 1 through 4 included in the first-half sub-group by coding the difference between the first common global motion vector GMV and each of the local motion vectors LMV. On the other hand, the local motion vector coding unit 2072 performs differential coding of the local motion vectors LMV in the frames 5 through 8 included in the second-half sub-group by coding the difference between the second common global motion vector GMV and each of the local motion vectors LMV.

With such an arrangement shown in FIG. 19B, the first common global motion vector GMV1 and the second common global motion vector GMV2 may be multiplexed into a coded stream. Also, an arrangement may be made in which, in a case that the value of the first common global motion vector GMV1 is close to that of the second global motion vector GMV2, coding is performed for the difference between the first common global motion vector GMV1 and the second common global motion vector GMV2. Such an arrangement provides a further reduction in the coding amount.

In this case, the global motion vector difference coding unit 2074 performs coding of the second common global motion vector GMV2 with the first common global motion vector GMV1 as a reference. Specifically, in this step, the global motion vector difference coding unit 2074 performs coding of the difference between the first common global motion vector GMV1 and the second common global motion vector GMV2. Let us say that the second common global motion vector GMV2 deviates from the first common global motion vector GMV1 by an amount equal to the difference vector β, i.e., the second common global motion vector is represented by the Expression, GMV2=GMV1+β. In this case, the difference between the first common global motion vector and the second common global motion vector matches the difference vector β. This further reduces the coding amount, as compared with a case in which coding is performed individually and independently of one another for the first common global motion vector GMV1 and the second common global motion vector GMV2.

Also, an arrangement may be made in which the global motion vector difference coding unit 2074 makes a comparison between the coding amount obtained by coding the second common global motion vector GMV2 without any calculation before the coding and the coding amount obtained by coding the difference between the first common global motion vector GMV1 and the second common global motion vector GMV2. With such an arrangement, the global motion vector difference coding unit 2074 selects the coding method which provides the smaller coding amount. Note that, in a case that there is a great change in the global motion between the first-half group frames and the second-half group frames, from the perspective of the coding amount, in some cases, better coding results may be obtained using a coding method in which coding is performed for the second common global motion vector GMV2 without calculating the difference between the first common global motion vector GMV1 and the second common global motion vector GMV2.

FIG. 19B shows an example in which the frames included in the GOP are divided into two sub-groups. Also, an arrangement may be made in which the GOP is divided into three or more sub-groups as necessary, and a common global motion vector GMV is obtained for each sub-group. With such an arrangement, the global motion vector difference coding unit 2074 can select one coding method from among two possible coding methods, i.e., a coding method in which coding is performed for a given common global motion vector by coding the difference between the common global motion vectors of different sub-groups (in particular, between the common global motion vectors of sub-groups adjacent to one another), or a coding method in which the individual common global motion vectors GMV of these sub-groups are coded without any calculation before the coding.

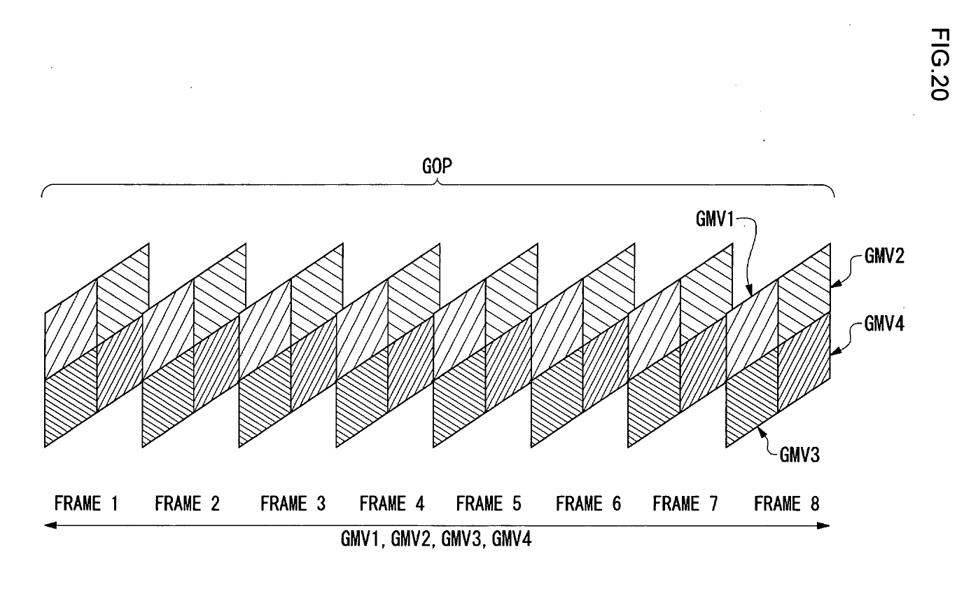

FIG. 20 is a diagram for describing an example in which a moving image is divided into multiple spatial regions, and a common global motion vector GMV is obtained for each region. The GOP setting unit 2064 sets multiple global regions each of which is common to all the frames included in the GOP. The GOP consists of the eight frames labeled frames 1 through 8, and each frame is partitioned into four global regions which are indicated by different hatched regions. Each of the four global regions is common to the eight frames 1 through 8, i.e., each of the four global regions is defined at the same position in the eight frames 1 through 8. The global motion vector calculation unit 2068 obtains the common global motion vectors GMV1 through GMV4 for the respective global regions.

With such an arrangement, in a case that there is a difference in the global motion between the regions defined in the image, the common global motion vector GMV is obtained for each region, and differential coding is performed for the local motion vectors LMV for each region with the corresponding common global motion vector GMV as a reference. This effectively reduces the coding amount of the local motion vectors LMV.

The regions defined in the frames, which are set by the GOP setting unit 2064, may overlap with one another, or may have an inclusion relation. Also, the GOP setting unit 2604 may change the layout of the regions for each GOP. Alternatively, the GOP setting unit 2604 may employ the same region layout for multiple GOPs.

In a case shown in FIG. 20, the global motion vector difference coding unit 2074 may perform coding of the differences between the common global motion vectors of the four global regions. Let us say that the values of the four common global motion vectors GMV 1 through 4 are close to each other. In this case, such an arrangement performs coding of the differences between the four global motion vectors GMV 1 through 4, thereby reducing the coding amount of the four global motion vectors GMV 1 through 4.

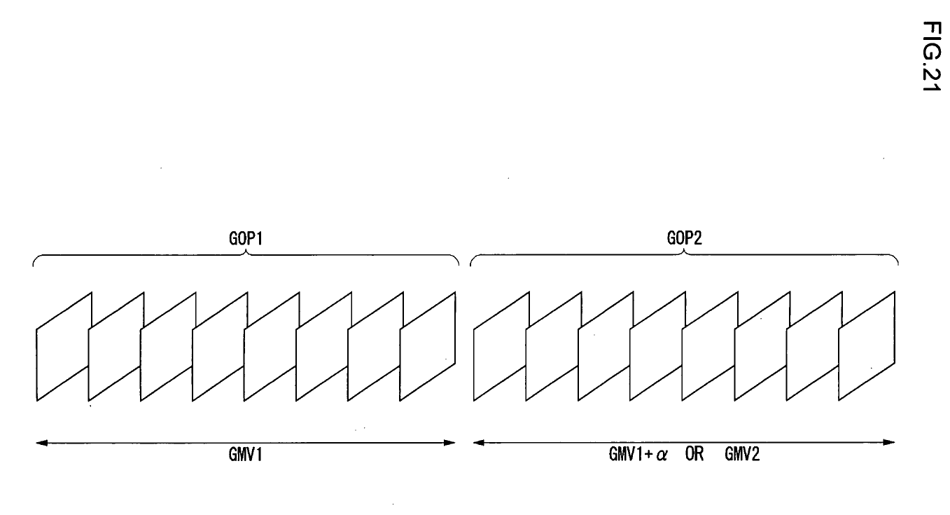

FIG. 21 is a diagram for describing an example in which coding is performed for the difference in the common global motion vector GMV between multiple GOPs.

Each of a first GOP1 and a second GOP 2 is a frame group which consists of eight frames. The global motion vector calculation unit 2068 obtains a first global motion vector GMV1 for the first GOP1, and obtains a second common global motion vector GMV2 for the second GOP2.

Let us say that the value of the first common global motion vector GMV1 is close to that of the second common global motion vector GMV2. In this case, a coding method in which coding is performed for the difference between these common global motion vectors provides a smaller coding amount than the coding amount that would result from a coding method in which coding is performed independently for every individual common global motion vector. For example, let us say that the second global motion vector GMV2 is represented by the Expression, GMV2=GMV1+α. In this case, coding may be performed for the second common global motion vector GMV2 with the first common global motion vector GMV1 as a reference global motion vector. Specifically, with such an arrangement, coding is performed for the difference between the first common global motion vector GMV1 and the second common global motion vector GMV2. That is to say, coding is performed for the difference vector a alone, thereby reducing the coding amount.

Also, an arrangement may be made in which the global motion vector difference coding unit 2074 makes a comparison between the coding amount obtained by coding the first common global motion vector GMV1 and the second common global motion vector GMV2 independently of one another, and the coding amount obtained by coding one common global motion vector with the other common global motion vector as a reference (specifically, by coding of the difference therebetween). With such an arrangement, the global motion vector difference coding unit 2074 selects the better of the two coding methods based upon the coding amounts thus obtained.

With reference to FIG. 21, description has been made regarding an arrangement in which differential coding is performed for the common global motion vectors GMV obtained for two adjacent GOPs. More typically, differential coding may be performed for the common global motion vectors GMV for three or more GOPs. For example, the common global motion vector obtained for any one GOP selected from among three or more GOPs may be selected as a reference common global motion vector. Furthermore, coding may be performed for each of the other common global motion vectors using the reference common global motion vector thus selected as a reference. Specifically, coding may be performed for the difference between each of the other common global motion vectors and the reference global motion vector. Alternatively, with regard to a sequence of three or more GOPs, coding may be performed for the difference between the common global motion vectors obtained for two adjacent GOPs.

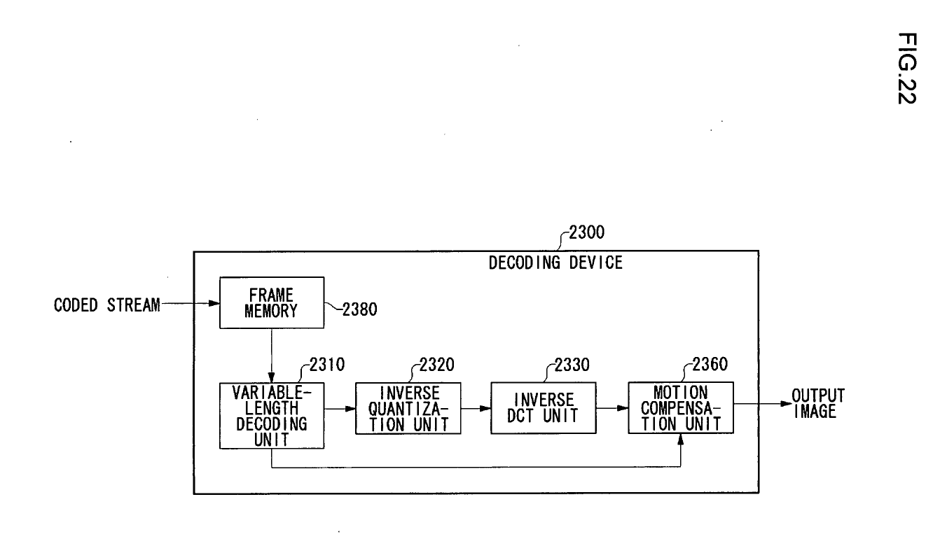

FIG. 22 is a configuration diagram which shows the decoding device 2300 according to the Example 1. The functional block configuration can also be realized by hardware components alone, software components alone, or combinations thereof.

The decoding device 2300 receives a coded stream in the form of input data, and decodes the coded stream, thereby creating an output image. The coded stream thus input is stored in frame memory 2380.

A variable-length decoding unit 2310 performs variable-length decoding of the coded stream stored in the frame memory 2380, and transmits the decoded image data to an inverse-quantization unit 2320. On the other hand, the variable-length decoding unit 2310 transmits the decoded motion vector information to a motion compensation unit 2360.

The inverse-quantization unit 2320 performs inverse-quantization of the image data decoded by the variable-length decoding unit 2310, and transmits the image data thus inverse-quantized to an inverse DCT unit 2330. The image data inverse-quantized by the inverse quantized unit 2320 is a DCT coefficient set. The inverse DCT unit 2330 performs inverse discrete cosine transform (IDCT) for the DCT coefficient set inverse-quantized by the inverse quantization unit 2320, thereby reconstructing the original image data. The image data thus reconstructed by the inverse DCT unit 2330 is transmitted to the motion compensation unit 2360.

The motion compensation unit 2360 creates a predicted image based upon the motion vector information supplied from the variable-length decoding unit 2310 using the prior or upcoming image frame as a reference image. Then, the motion compensation unit 2360 reconstructs the original image data by making the sum of the predicted image and the subtraction image supplied from the inverse DCT unit 2330, and outputs the original image data thus reconstructed.

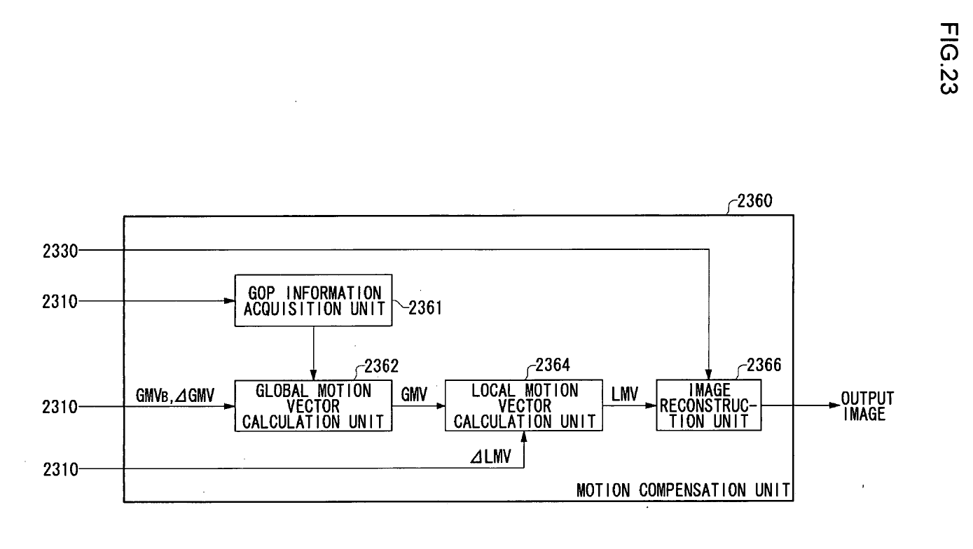

FIG. 23 is a diagram for describing the configuration of the motion compensation unit 2360. The coded stream, which has been coded by the coding device 2100 shown in FIG. 16, is input to the decoding device 2300. The motion vector information, which is supplied to the motion compensation unit 2360, includes: the reference global motion vector GMV_{B}; the global motion vector difference ΔGMV; and the local motion vector difference ΔLMV. The motion compensation unit 2360 obtains the local motion vector LMV with reference to this motion vector information, and performs motion compensation.

A GOP information acquisition unit 2361 acquires the information with respect to the GOP, which is included in the coded stream, from the variable-length decoding unit 2310, and transmits the information thus acquired to a global motion vector calculation unit 2362. The information with respect to the GOP includes: the information which specifies the frame that serves to define the boundary of the GOP; the information with respect to the global region for which the global motion vector GMV is to be obtained; and so forth.

The global motion vector calculation unit 2362 acquires the common global motion vectors GMV in units of GOPs from the coded stream with reference to the information with respect to the GOP supplied from the GOP information acquisition unit. In a case of receiving the global motion vectors GMV which have been subjected to differential coding, the global motion vector calculation unit 2362 receives the reference global motion vector GMV_{B} and the global motion vector difference ΔGMV in the form of input from the variable-length decoding unit 2310, calculates the common global motion vector GMV=ΔGMV+GMV_{B} in units of GOPs, and transmits the common global motion vector GMV to a local motion vector calculation unit 2364.

The local motion vector calculation unit 2364 receives the local motion vector differences ΔLMV in the form of input from the variable-length decoding unit 2310, and the common global motion vectors GMV in units of GOPs in the form of input from the global motion vector calculation unit 2362. Then, the local motion vector calculation unit 2364 calculates the local motion vector LMV=ΔLMV+GMV by adding the global motion vector GMV, which is common to the GOP, to each of the local motion vector differences ΔLMV for each frame. The local motion vector calculation unit 2364 transmits the local motion vectors LMV thus calculated for each frame, to an image reconstruction unit 2366.

The image reconstruction unit 2366 creates a predicted image using the reference image and the local motion vectors LMV each of which has been calculated for the corresponding macro block within the corresponding global region. Then, the image reconstruction unit 2366 reconstructs the original image by calculating the sum of the subtraction image received from the inverse DCT unit 2330 and the predicted image thus created, and outputs the original image thus reconstructed.

As described above, with the coding device 2100 according to the Example 1, before the coding of the motion vectors, common global motion vectors are obtained in units of groups each of which consists of multiple frames, and the information with respect to the common global motion vectors is coded. Let us say that each group unit exhibits similar motion over time. In this case, with the present Example 1, a common global motion vector is provided for each group unit, thereby reducing the coding amount of the global motion vectors.

Furthermore, with the present embodiment, the information with respect to the local motion vectors obtained in units of macro blocks for each frame included in the group is represented by the difference between each local motion vector and the common global motion vector for the group. Such an arrangement enables the amount of data of the local motion vector information to be reduced. This reduces the overall coding amount of the moving image stream, thereby improving the compression efficiency.

With the decoding device 2300 according to the present Example 1, decoding of a moving image is performed based upon the corresponding motion vector acquired from a highly compressed moving image stream, which has been created by the coding device 2100, with reference to the global motion information obtained for each group. Furthermore, the decoding device 2300 acquires the local motion vector differences for each frame and the common global motion vector, which is common to the group, and makes the sum of each local motion vector difference and the common global motion vector for the group, thereby obtaining each local motion vector. Then, the decoding device 2300 performs motion compensation, thereby reconstructing a high-quality moving image.

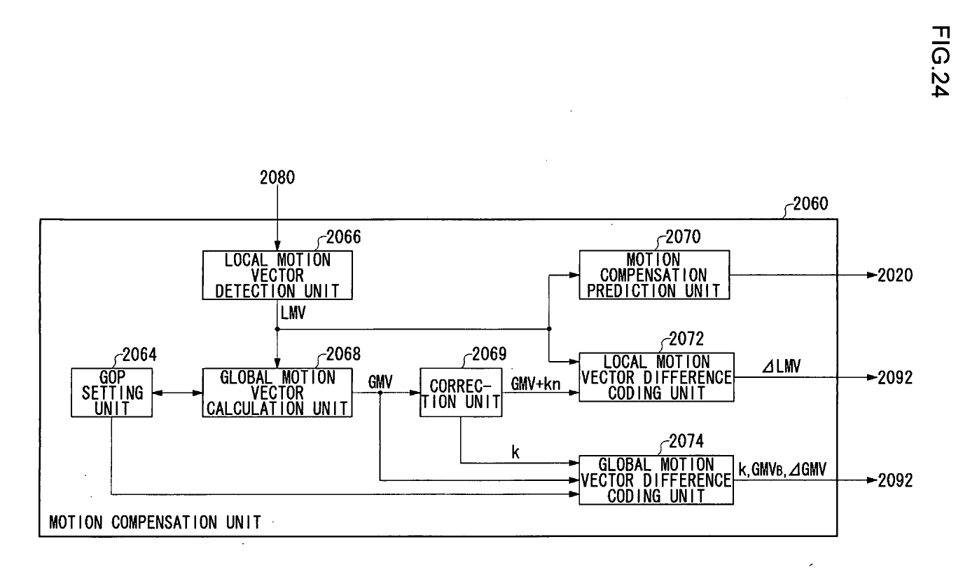

FIG. 24 is a configuration diagram which shows the motion compensation unit 2060 of the coding device 2100 according to an Example 2 of the Embodiment 3. The difference between the motion compensation unit 2060 of the coding device 2100 according to the present Example 2 and that according to the above-described Example 1 is as follows. That is to say, before the application of the common global motion vector GMV of the GOP to each frame included in the GOP, the motion compensation unit 2060 of the coding device 2100 according to the present Example 2 performs correction of the common global motion vector GMV as necessary. Note that the same components as those of the coding device 2100 according to the Example 1 are denoted by the same reference numerals, and description thereof will be omitted. Description will be made regarding only the difference in the components and operation from those of the Example 1.

With the Example 1, the common global motion vector GMV of the GOP is applied to each frame included in the GOP on the assumption that the speed of the global motion is constant over the frames included in the GOP. However, let us consider a case in which the speed of the global motion is not constant over the frames included in the GOP, for example. In this case, the application of the common global motion vector GMV obtained for a certain frame to other frames without any correction leads to a large difference between the common global motion vector GMV and the local motion vector LMV obtained for each macro block. In some cases, such a large difference between each local motion vector LMV and the common global motion vector GMV leads to a problem of insufficiently efficient coding amount reduction.

Let us consider a case of a falling object in a moving image, or a case of an accelerating vehicle. In this case, the speed of the global motion is not constant over the GOP, and the global motion is accelerating. With the present embodiment, the common global motion vector GMV is corrected using an acceleration correction term over the frames included in the GOP. That is to say, before the application of the common global motion vector GMV to each of the frames included in the GOP, the common global motion vector GMV is adjusted. Thus, the common global motion vector GMV thus corrected is close to the local motion vector LMV for each frame. This effectively reduces the coding amount obtained by differential coding of the local motion vector LMV for each frame.

The global motion vector calculation unit 2068 supplies the common global motion vectors GMV, which have been obtained in units of GOPs using the method described in Example 1, to a correction unit 2069 and the global motion vector difference coding unit 2074. The correction unit 2069 corrects each common global motion vector GMV before it is applied to each of the frames included in the GOP. As an example, let us consider a case in which the global motion has a constant acceleration. In this case, the correction unit 2069 corrects the common global motion vector GMV using the following Expression.
GMV[n]=GMV[0]+kn

Here, GMV[0] represents the initial value of the common global motion vector GMV. “n” represents the frame number, and “k” represents a correction coefficient which is a constant.

The correction unit 2069 supplies the corrected common global motion vector, i.e., GMV+kn, to the local motion vector difference coding unit 2072, and supplies the correction coefficient “k” to the global motion vector difference coding unit 2074.

In a case that multiple common global motion vectors GMV are provided, the global motion difference coding unit 2074 performs differential coding of the common global motion vectors GMV in the same way as described in Example 1. With the present Example 2, the common global motion vector GMV, which is to be applied to each frame included in the GOP, is adjusted using the correction coefficient k. Accordingly, the global motion vector difference coding unit 2074 performs coding of the motion vector information with the information with respect to the correction coefficient k as a part of the motion vector information. Then, the global motion vector difference coding unit 2074 supplies the coded correction coefficient k, coded reference global motion vector GMV_{B}, and coded global motion vector differences ΔGMV to the multiplexing unit 2092 in the form of motion vector information.

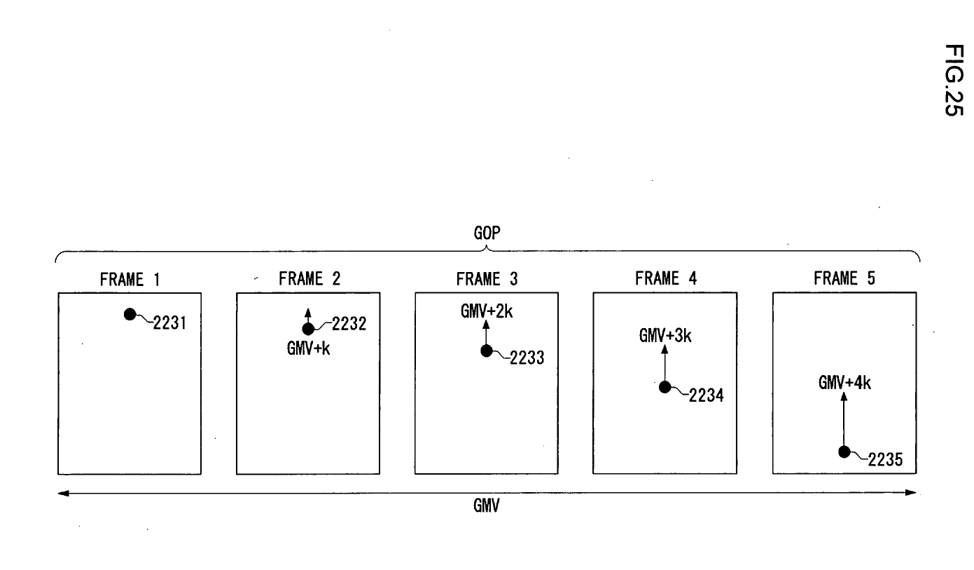

FIG. 25 is a diagram for describing a procedure in which the common global motion vector GMV is corrected for each frame over the GOP.

Let us say that the global motion is accelerating over the frames 1 through 5 included in the GOP. Here, the global motion of the entire image may be accelerating. Alternatively, the global motion of a particular global region may be accelerating. For the sake of simplification, description will be made below regarding a case in which the object indicated by the solid circle is accelerating. Also, the same can be said of a case in which the motion of the entire image is accelerating to the same extent as is the movement of the object indicated by the solid circle.

The object passes through the positions indicated by the reference numerals 2231 through 2235 over the frames from the frame 1 to the frame 5. Here, the speed of the movement is not constant, i.e., the motion of the object is accelerating. In this case, let us say that the global motion vector calculation unit 2068 detects the global motion for the frame 1 of the GOP, thereby obtaining the initial value of the common global motion vector GMV, i.e., the initial value GMV[0]. The correction unit 2069 corrects the initial value GMV[0] for the frame 2 using the correction coefficient k. Specifically, the correction unit 2069 supplies GMV[0]+k to the local motion vector difference coding unit 2072 as the corrected common global motion vector GMV for the frame 2. Subsequently, the correction unit 2069 supplies GMV[0]+2k for the frame 3, GMV[0]+3k for the frame 4, and GMV[0]+4k for the frame 5, to the local motion vector difference coding unit 2072, each of which is used as a corrected common global motion vector GMV for the corresponding frame.

The local motion vector difference coding unit 2072 performs differential coding of each local motion vector LMV in the frame 1 by coding the difference between the local motion vector LMV and the initial value of the global motion vector GMV, i.e., GMV[0]. Subsequently, the local motion vector difference coding unit 2072 performs differential coding of each local motion vector LMV in the frames 2 through 5 by coding the difference between the local motion vector LMV and the sum of the initial value of the global motion vector GMV, i.e., GMV[0], and the correction coefficient k multiplied by an integer, i.e., GMV[0]+k, GMV[0]+2k, GMV[0]+3k, and GMV[0]+4k.

Description has been made regarding a case in which the common global motion vector GMV is corrected on the assumption that the acceleration of the global motion is constant. More generally, the correction unit 2069 can perform various kinds of correction such as correction using a quadratic function or the like according to the change in the speed. In this case, an arrangement may be made in which the correction unit 2069 supplies the information with respect to correction such as the kind of the function used for correction, the coefficients of the function, and so forth, to the global motion vector difference coding unit 2074. With such an arrangement, the global motion vector coding unit 2074 appends the information with respect to correction as a part of the motion vector information, and performs coding of the motion vector information.

A decoding device according to the Example 2 may have the same configuration as that of the decoding device 200 according to the Example 1, except for the correction unit 2069 included in the motion compensation unit 2360 as shown in FIG. 24. With the processing procedure as modified for such an arrangement, before transmission of the common global motion vector GMV to the local motion vector calculation unit 2364, the correction unit 2069 corrects the common global motion vector GMV, which has been obtained by the global motion vector calculation unit 2362, using the correction coefficient k.

Description has been made regarding the Embodiment 3 with reference to the aforementioned examples. The aforementioned Examples have been described for exemplary purposes only, and are by no means intended to be interpreted restrictively. Rather, it can be readily conceived by those skilled in this art that various modifications may be made by making various combinations of the aforementioned components or of the aforementioned processing, which are also encompassed in the technical scope of the Embodiment 3.

Description has been made in the present embodiment regarding an arrangement in which the coding device 2100 and the decoding device 2300 perform coding and decoding of a moving image in accordance with the MPEG series standards (MPEG-1, MPEG-2, and MPEG-4), the H.26x series standards (H.261, H.262, and H.263), or the H.264/AVC standard. Also, the Embodiment 3 may be applied to an arrangement in which coding and decoding are performed for a moving image managed in a hierarchical manner having a temporal scalability. In particular, the Embodiment 3 is effectively applied to an arrangement in which motion vectors are coded with the reduced coding amount using the MCTF technique.

The Embodiment 3 can also be expressed by the following items 1 through 7.

1. A coding method wherein a coded moving image data includes information with respect to global motion vectors each of which specifies the global motion, and each of which can be applied to a plurality of pictures which are to be subjected to inter-picture prediction coding for each group that includes said plurality of pictures forming a moving image.

2. A coding method described in 1, wherein said group is a unit which can be decoded independently.

3. A coding method described in 1 or 2, wherein the coded moving image data includes the information with respect to the difference between the global motion vectors of the groups which differ from one another.

4. A coding method described in any one of 1 through 3, wherein the global motion vector represents the global motion within at least one region among a plurality of regions in an image, each of which is defined as a common global motion vector in units of a plurality of pictures which are to be subjected to the inter-picture prediction coding for each of the groups.

5. A coding method described in 4, wherein, in a case that global motion vectors have been defined for two or more regions, the coded moving image data includes the information with respect to the difference between the global motion vectors obtained for the different regions.

6. A coding method described in any one of 1 through 5, wherein, in a case that the global motion vector, which can be applied to a plurality of pictures which are to be subjected to the inter-picture prediction coding, is corrected before being applied to each picture included in the group, the coded moving image data includes a parameter for correcting the global motion vector.

7. A coding method described in any one of 1 through 6, wherein, in a case that local motion vectors are defined in units of predetermined blocks for each of a plurality of pictures which are to be subjected to the inter-picture prediction coding, the coded moving image data includes the information with respect to the difference between each of the local motion vectors for each picture and the global motion vector which can be applied to a plurality of pictures which are to be subjected to the inter-picture prediction coding.

### Embodiment 4

Summary of this Embodiment

It is an object of the Embodiment 4 to provide a coding technique and a decoding technique for a moving image which offer high coding efficiency by reducing the coding amount for the motion vector information.

With a coding method according to an aspect of the Embodiment 4, coded moving image data includes the information with respect to a global motion vector that represents the global motion within a picture, which is a component of a moving image, and which is to be subjected to inter-picture prediction coding, or a region defined in the picture, and the index for identifying the global motion vector, stored in a correlated manner in the form of a table, and the index information specified for each region within the picture.

The “global motion vector” is a vector which represents the overall motion of the entire region.

The term “picture” as used herein represents a coding unit. The concept thereof includes the frame, field, and VOP (Video Object Plane).

With such an aspect, a table, which indicates the relation between the global motion vector and the index, is created in increments of pictures or the regions defined in a picture. This allows the global motion vector used for prediction coding of each region in the picture to be specified using the index. That is to say, with such an arrangement, the table is used, and accordingly, the coded data does not need to include redundant data for the information with respect to the global motion vector. This reduces the data amount due to the global motion vectors, thereby improving the compression efficiency of a moving image.

Another aspect of the Embodiment 4 also provides a coding method. With this coding method, coded moving image data includes the information which indicates the global motion vector that represents the global motion within a picture, which is a component of the moving image and which is to be subjected to inter-picture prediction coding, or within a region defined in the picture, and the information with respect to index for identifying the global motion vector. Furthermore, the coded moving image data also includes the index information which specifies the global motion vector used for prediction coding of the picture or the region included in the picture, for which the global motion vector has been calculated.

With such an aspect, the coded data does not need to include redundant data for the same global motion vector information in the same picture or in a region defined in the picture. This reduces the data amount due to the global motion vectors.

An arrangement may be made in which, in a case that a first global motion vector calculated for a first picture or for a region defined in the first picture differs from a second global motion vector calculated for a second picture or for a region defined in the second picture, the coded data includes the information with respect to the difference between the first global motion vector and the second global motion vector in correlation with the index. With such an arrangement, the data amount of the overall data amount of the global motion vector information, thereby improving the compression efficiency of the coded moving image data.

The index may be assigned to each global motion vector with the global motion vectors obtained in the second picture or the region defined in the second picture being sorted in order of how frequently each global motion vector has been used in the first picture or the region defined the first picture.

An arrangement may be made in which the header of each coded data, the header of each picture, or the header of each region in the picture includes the information with respect to the global motion vector and the information with respect to the index for identifying the global motion vector. Furthermore, the header of each picture or the header of each region defined in the picture, for which the global motion vector has been calculated, may include the index information which specifies the global motion used for prediction coding of the target region. With such an arrangement, the information with respect to the global motion vector and the index may be stored in the head defined for each stream or picture, or for each smaller coding unit such as the slice, macro block, etc. Furthermore, such an arrangement allows the global motion vector to be specified using the index in increments of such smaller coding units. Thus, such an arrangement allows the combination of the coding unit for calculating the global motion vector and the coding unit for which the global motion vector is used for prediction coding to be selected as desired according to the properties of the moving image.

For example, an arrangement may be made in which the header of each picture includes the information with respect to the global motion vectors and the information with respect to the index for identifying the global motion vectors, and the header of each slice or the header of each block includes the index information for specifying the global motion vector used for prediction coding. Also, an arrangement may be made in which the header of each slice defined in the picture includes the information with respect to the global motion vectors and the information with respect to the index for identifying the global motion vectors, and the header of each block defined in the slice includes the index information for specifying the global motion vector used for prediction coding.

An arrangement may be made in which the coded data includes a flag, which indicates whether or not prediction coding is performed using the global motion vector, for each picture or for each region defined in the picture. Also, an arrangement may be made in which the coded data includes a flag, which indicates one prediction coding option from among two possible prediction coding options, i.e., the prediction coding option using the global motion vector specified by the index, and the prediction coding option using the local motion vector calculated for the target block, for each block defined in the picture. This allows one motion prediction option to be selected for each block defined in a picture, from the two motion prediction options, i.e., the motion prediction option using the local motion vector, and the motion prediction option using the global motion vector. This allows the data amount of the coded data of the macro blocks to be further reduced.

Note that any combination of the aforementioned components or any manifestation of the Embodiment 4 realized by modification of a method, device, system, computer program, and so forth, is effective as the Embodiment 4.

Detailed Description of this Embodiment

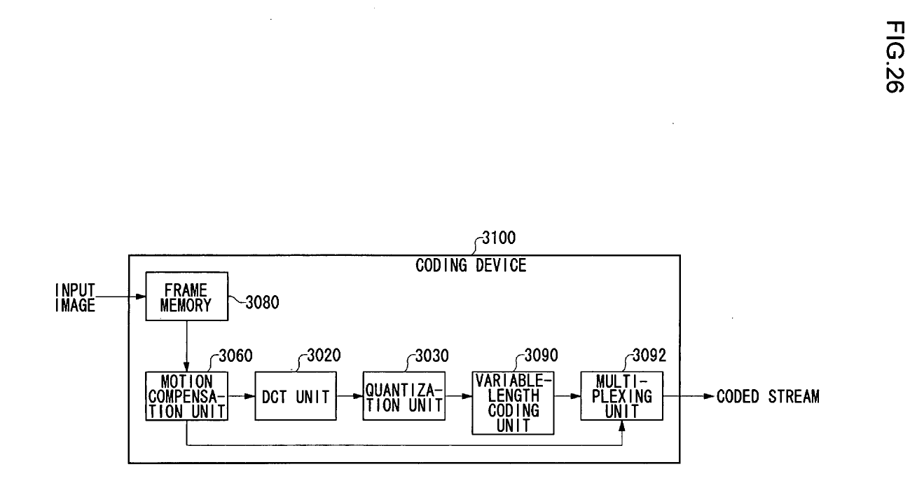

FIG. 26 is a configuration diagram which shows a coding device 3100 according to an Embodiment 4. This configuration can be realized by hardware means, e.g., by actions of a CPU, memory, and other LSIs, of a computer, or by software means, e.g., by actions of a program having a function of image coding or the like, loaded into the memory. Here, the drawing shows a functional block configuration which is realized by cooperation between the hardware components and software components. It is needless to say that such a functional block configuration can be realized by hardware components alone, software components alone, or various combinations thereof, which can be readily conceived by those skilled in this art.

The coding device 3100 according to the present embodiment performs coding of moving images according to the MPEG (Moving Picture Experts Group) series standards (MPEG-1, MPEG-2, and MPEG-4) standardized by the international standardization organization ISO (International Organization for Standardization)/IEC (International Electrotechnical Commission), the H.26x series standards (H.261, H.262, and H.263) standardized by the international standardization organization with respect to electric communication ITU-T (International Telecommunication Union-Telecommunication Standardization Sector), or the H.264/AVC standard which is the newest moving image compression coding standard jointly standardized by both the standardization organizations (these organizations have advised that this H.264/AVC standard should be referred to as the “MPEG-4 Part 10: Advanced Video Coding” and “H.264”, respectively).

With the MPEG series standards, in a case of coding an image frame in the intra-frame coding mode, the image frame to be coded is referred to as the “I (Intra) frame”. In a case of coding an image frame with a prior frame as a reference image, i.e., in the forward interframe prediction coding mode, the image frame to be coded is referred to as the “P (Predictive) frame”. In a case of coding an image frame with a prior frame and an upcoming frame as reference images, i.e., in the bi-directional interframe prediction coding mode, the image frame to be coded is referred to as the “B frame”.

On the other hand, with the H.264/AVC standard, image coding is performed using reference images regardless of the time at which the reference images have been acquired. For example, image coding may be made with two prior image frames as reference images. Also, image coding may be made with two upcoming image frames as reference images. Furthermore, the number of the image frames used as the reference images is not restricted in particular. For example, image coding may be made with three or more image frames as the reference images. Note that, with the MPEG-1, MPEG-2, and MPEG-4 standards, the term “B frame” represents the bi-directional prediction frame. On the other hand, with the H.264/AVC standard, the time at which the reference image is acquired is not restricted in particular. Accordingly, the term “B frame” represents the bi-predictive prediction frame.

While description will be made in the Embodiment 4 regarding an arrangement in which coding is performed in units of frames, coding may be performed in units of fields. Also, coding may also be performed in VOP increments as stipulated in the MPEG-4.

The coding device 3100 receives the input moving images in units of frames, performs coding of the moving images, and outputs a coded stream. The moving image frames thus input are stored in frame memory 3080.

A motion compensation unit 3060 performs motion compensation for each macro block of a P frame or B frame using a prior or upcoming image frame stored in the frame memory 3080 as a reference image, thereby creating the motion vector and the predicted image. The motion compensation unit 3060 performs subtraction between the image of the P frame or B frame to be coded and the predicted image, and supplies the subtraction image to a DCT unit 3020. Furthermore, the motion compensation unit 3060 supplies the coded motion vector information to a multiplexing unit 3092.

The DCT unit 3020 performs discrete cosine transform (DCT) processing for the image supplied from the motion compensation unit 3060, and supplies the DCT coefficients thus obtained, to a quantization unit 3030.

The quantization unit 3030 performs quantization of the DCT coefficients and supplies the quantized DCT coefficients to the variable-length coding unit 3090. The variable-length coding unit 3090 performs variable-length coding processing for the quantized DCT coefficients of the subtraction image, and transmits the DCT coefficients subjected to the variable-length coding processing to the multiplexing unit 3092. The multiplexing unit 3092 multiplexes the coded DCT coefficients received from the variable-length coding unit 3090 and the coded motion vector information received from the motion compensation unit 3060, thereby creating a coded stream. The multiplexing unit 3092 creates a coded stream with the coded frames being sorted in order of time.

Description has been made regarding coding processing for a P frame or B frame, in which the motion compensation unit 3060 operates as described above. On the other hand, in a case of coding processing for an I frame, the I frame subjected to intra-frame prediction is supplied to the DCT unit 3020 without involving the motion compensation unit 3060. Note that this coding processing is not shown in the drawings.

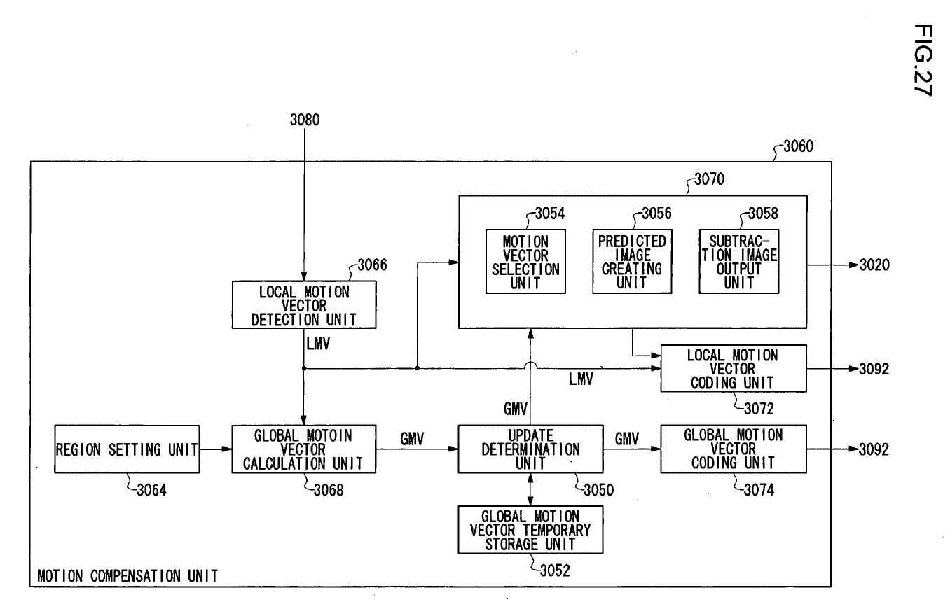

FIG. 27 is a diagram for describing the configuration of the motion compensation unit 3060. The motion compensation unit 3060 detects a motion vector for each macro block in a coding target image (which will be referred to as the “local motion vector” hereafter). At the same time, the motion compensation unit 3060 obtains a motion vector which indicates the global motion within the region for each of the predetermined regions set in the image (which will be referred to as the “global motion vector” hereafter). The global motion vector is a vector which represents the overall motion in the region. For example, the global motion vector for each region may be a motion vector which represents individual local motion vectors obtained in units of macro blocks defined in the region.

The motion compensation unit 3060 performs motion compensation based upon either the local motion vector or the global motion vector, and outputs a subtraction image. At the same time, the motion compensation unit 3060 performs coding of the local motion vector and the global motion vector, and outputs the calculation results in the form of motion vector information.

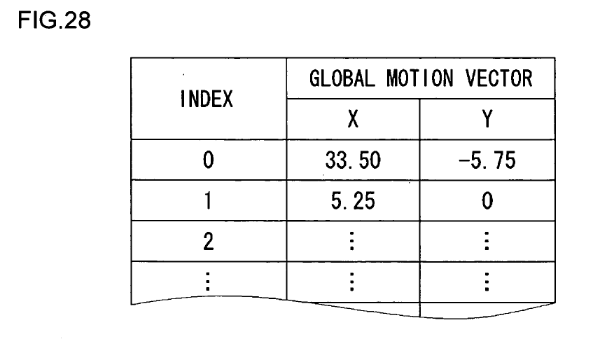

With the Example 1, after one or more global motion vectors are obtained in a frame, a reference table is created for the entire frame, which indicates the relation between each global motion vector and a corresponding index for specifying the global motion vector. FIG. 28 shows an example of the reference table. In the reference table shown in FIG. 28, the global motion vector (33.50, −5.75) corresponds to the index “0”, and the global motion vector (5,25, 0) corresponds to the index “1”.

In a case that prediction coding is performed for each macro block using the global motion vector, the corresponding index is stored in the coded stream. Let us consider a case in which the same global motion vector is used for macro bocks included in different regions. Such an arrangement enables prediction coding to be performed without the need to code the same global motion vector multiple times. This reduces the coding amount. Furthermore, with the Example 1, the coded stream stores a flag for each macro block, which specifies whether or not prediction coding is performed using either one or more global motion vectors defined in the reference table or the local motion vector. This provides two prediction coding options for each macro block, one of which can be selected for the macro block such that the coding amount exhibits the smallest possible value. Here, one option is prediction coding using one or more global motion vectors. The other is prediction coding using the local motion vector.

Description will be made returning to FIG. 27. A local motion vector detection unit 3066 detects the predicted macro block which exhibits the least difference from the target macro block in the coding target image with reference to the reference image held by the frame memory 3080, and obtains the local motion vector LMV which represents the motion from the target macro block to the predicted macro block. This motion detection is performed by searching the reference image for the reference macro block that matches the target macro block in units of pixels, or in units of fractions of a pixel. In general, searching is repeatedly performed multiple times within a pixel region, and the reference macro block which best suits the target macro block is selected as the predicted macro block.

The local motion vector detection unit 3066 supplies the local motion vector LMV thus obtained to a global motion calculation unit 3068, a motion compensation prediction unit 3070, and a local motion vector coding unit 3072.

A region setting unit 3064 sets a region for calculating the global motion vector GMV in a frame image (which will be referred to as the “global region” hereafter). Note that the region setting unit 3064 sets multiple global regions in the image. For example, the region setting unit 3064 may set fixed global regions in the image beforehand. Specific examples include: an arrangement in which the region setting unit 3064 sets one global region around the center of the frame image, and sets the perimeter region other than the center region to be another global region; etc. Alternatively, the global regions may be set by the user.

Also, an arrangement may be made in which, in a case that the image includes a particular object such as a human figure or the like, the region setting unit 3064 automatically extracts the region occupied by the object, and the region thus extracted is set to be a global region.

Also, an arrangement may be made in which the region setting unit 3064 automatically extracts a region occupied by the macro blocks having roughly the same motion with reference to the local motion vectors LMV in the image detected by a local motion vector detection unit 3066, and sets the region thus extracted to be a global region.

The region setting unit 3064 transmits the information with respect to the global regions thus set, to the global motion vector calculation unit 3068 and a global motion vector coding unit 3074.

The global motion vector calculation unit 3068 calculates the global motion vector GMV which indicates the global motion in each global region set by the region setting unit 3064. For example, the global motion vector calculation unit 3068 calculates the average of the local motion vectors LMV within a region, and employs the average as the global motion vector GMV.

Furthermore, an arrangement may be made in which the global motion vector calculation unit 3068 acquires the information with respect to the global motion in each global region, and calculates the global motion vector GMV for each global region based upon the information thus acquired. For example, an arrangement may be made in which, in a case of the camera zooming or panning, or in a case of scrolling the screen, the global motion vector calculation unit 3068 determines the global motion for each global region based upon the information with respect to the overall motion of the entire screen, thereby calculating the global motion vector GMV. Also, an arrangement may be made in which the global motion vector calculation unit 3068 automatically extracts the motion of a particular object such as a human figure or the like in the image, and determines the global motion for each global region based upon the motion of that object, thereby calculating the global motion vector GMV.

The global motion vector calculation unit 3068 supplies the global motion vector GMV thus obtained to an update determination unit 3050.

The update determination unit 3050 assigns an index to the global motion vector received from the global motion vector calculation unit 3068, thereby creating the reference table. The update determination unit 3050 supplies the global motion vector GMV with the index to the motion compensation prediction unit 3070 and the global motion vector coding unit 3074.

Furthermore, the update determination unit 3050 makes a comparison between the global motion vector received from the global motion vector calculation unit 3068 and the global motion vectors calculated in the processing for a previous frame, prior to the processing for the current target frame. Then, the update determination unit 3050 determines whether or not the global motion vectors defined in the reference table are to be updated based upon the comparison results thus obtained.

The global motion vectors calculated in the previous processing for a previous frame (which will be referred to as the “previous global motion vectors” hereafter) are stored in a global motion vector temporary storage unit 3052. In a case that the global motion vector obtained in the current processing matches one of the previous global motion vectors, the update determination unit 3050 maintains the relation between the previous global motion vector and the index, and stores a flag in the coded stream, which specifies that the same global motion vector has been obtained. On the other hand, in a case that the global motion vector thus obtained in the current processing differs from the previous global motion vectors, a new index is assigned to the current global motion vector.

The motion compensation prediction unit 3070 performs motion prediction for the target macro block based upon the local motion vector LMV or the global motion vector GMV, thereby creating a predicted image. Then, motion compensation prediction unit 3070 outputs a subtraction image, which is obtained by making a subtraction between the coding target image and the predicted image, to the DCT unit 3020.

The motion compensation prediction unit 3070 includes a motion vector selection unit 3054, a predicted image creating unit 3056, and a subtraction image output unit 3058.

The motion vector selection unit 3054 selects one from the two possible motion compensation options. Here, one option is motion prediction using one or more global motion vectors GMV defined in the reference table. The other option is motion prediction using the local motion vector LMV for each macro block. Specifically, the prediction image creating unit 3056 creates a predicted image by motion prediction using the local motion vector LMV, and a predicted image by motion prediction using the global motion vector GMV. Then, the prediction image creating unit 3056 makes a subtraction image between each of these predicted image and the coding target image. The motion vector selection unit 3054 makes a comparison between the total coding amounts for these subtraction images. Here, the total coding amount is the sum of the coding amount of the subtraction image and the motion vector for each macro block. Then, the motion vector selection unit 3054 selects the motion vector which has provided the predicted image that exhibits the smallest coding amount. The subtraction image output unit 3058 outputs the subtraction image, which exhibits the smallest coding amount, to the DCT unit 3020.

The motion vector selection unit 3054 supplies the information of which of the two motion compensation options has been selected, i.e., the option of motion prediction using the local motion vector, and the option of motion prediction using the global motion vector, to the local motion vector coding unit 3072.

The local motion vector coding unit 3072 receives the local motion vectors LMV from the local motion vector detection unit 3066 in units of macro blocks. Furthermore, the local motion vector coding unit 3072 detects each of the macro blocks which have provided the smallest coding amount in the step involving the motion compensation prediction unit 3070 using the corresponding local motion vector. The local motion vector coding unit 3072 performs variable-length coding of the local motion vector LMV for each of the macro blocks thus detected. The local motion vector coding unit 3072 supplies the coded local motion vector LMV to the multiplexing unit 3092 as motion vector information.

Furthermore, the local motion vector coding unit 3072 supplies a flag, which indicates whether or not the predicted image with the smallest coding amount has been created using the global motion vector for each macro block, (which will be referred to as the “GMV use flag” hereafter), to the multiplexing unit 3092. In a case that the global motion vector has been used for the macro block, the local motion vector coding unit 3072 supplies the index information corresponding to the global motion vector, which is defined in the reference table.

The global motion vector coding unit 3074 receives the global motion vector GMV with the index from the update determination unit 3050, and performs variable-length coding thereof.

Specifically, let us consider a case in which the update determination unit 3050 has determined that the global motion vector defined in the reference table is to be updated. In this case, the global motion vector coding unit 3074 performs variable-length coding of the global motion vector GMV, of which it has been determined that it needs to be updated, and also performs variable-length coding of the corresponding index. Furthermore, a flag which indicates whether or not the reference table has been updated (which will be referred to as the “table update flag” hereafter) and the number of the global motion vectors thus updated (which will be represented by “Num”) are supplied to the multiplexing unit 3092. On the other hand, in a case that the update determination unit 3050 has determined that the global motion vector is not to be updated, the global motion vector coding unit 3072 does not perform variable-length coding of the global motion vector.

The global motion vector 3074 may perform variable-length coding of the difference between the updated global motion vector and the global motion vector before updating GMV′, i.e., the difference (GMV−GMV′), instead of the variable-length coding of the whole global motion vector GMV.

The global motion vector coding unit 3074 supplies the coded global motion vector GMV and the index, which are both obtained for each global region, to the multiplexing unit 3092 as the motion vector information. In this stage, the global motion vector coding unit 3074 appends the region information with respect to the global region, which has been set by the region setting unit 3064, as a part of the motion vector information.

Accordingly, the multiplexing unit 3092 receives the global motion vectors GMV, the indexes, the local motion vectors LMV, and various kinds of flags.

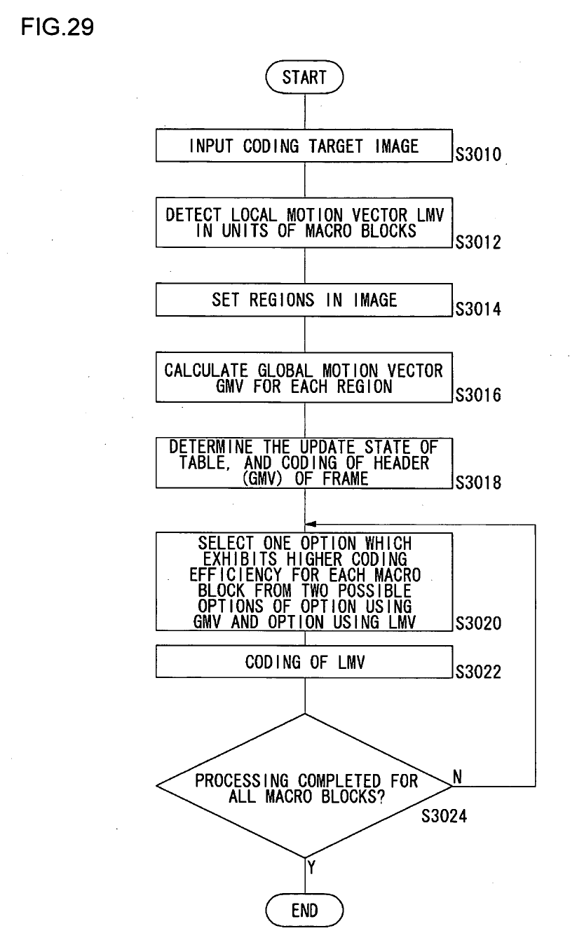

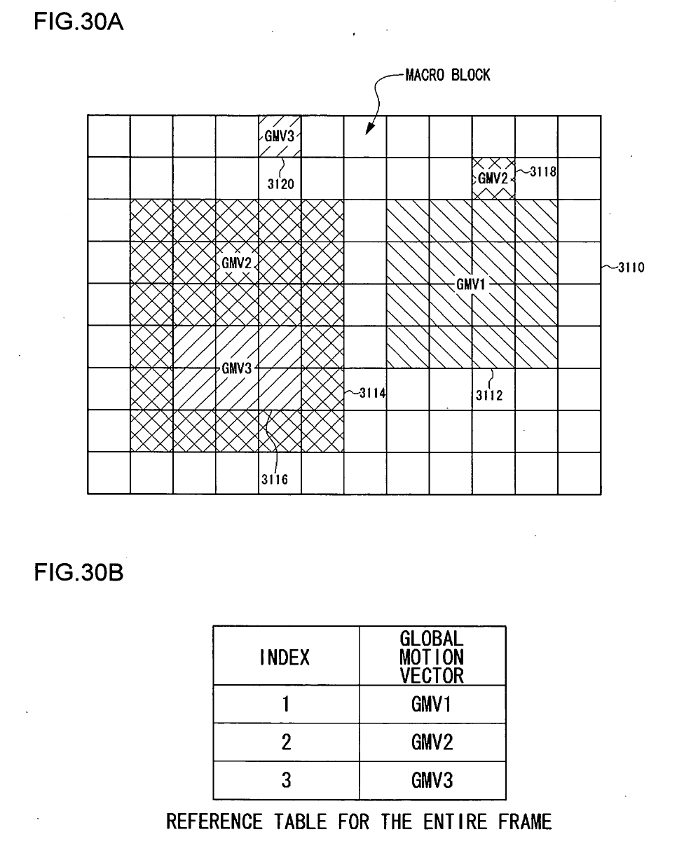

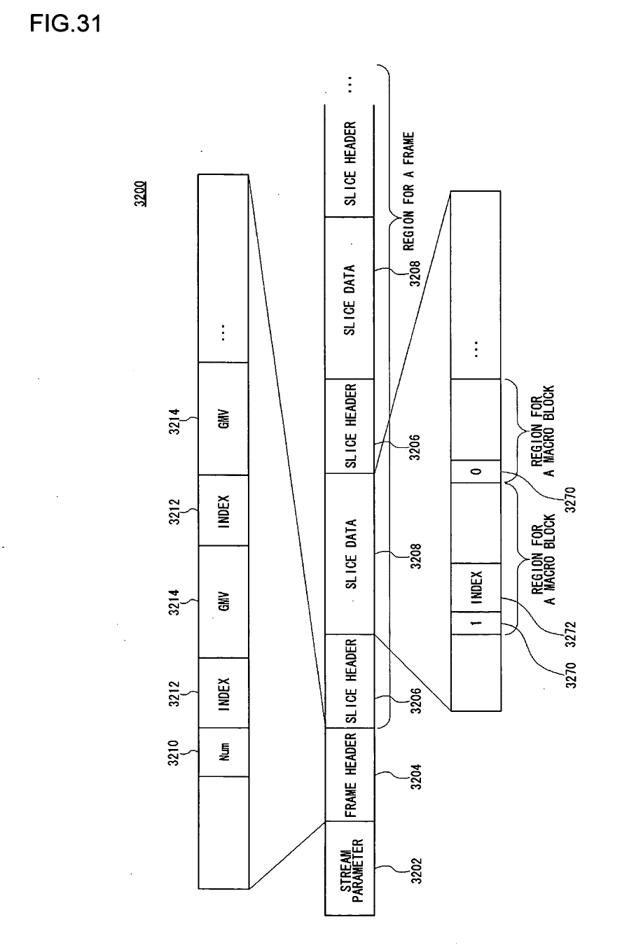

FIG. 29 is a flowchart for describing the procedure for differential coding of motion vectors performed by the motion compensation unit 3060 according to the Example 1 of the Embodiment 4. Description will be made regarding the coding procedure with reference to the examples shown in FIGS. 30A, 30B, and 31, as appropriate.

First, a coding target image is input to the frame memory 3080 of the coding device 3100 (S3010). The local motion vector detection unit 3066 detects the local motion vectors LMV in the coding target image in units of macro blocks (S3012).

Next, the region setting unit 3064 sets global regions in the image (S3014). Then, the global motion vector calculation unit 3068 calculates the global motion vector GMV for each global region (S3016).

The update determination unit 3050 assigns an index to each global motion vector, and determines whether or not the global motion vector GMV defined in the reference table is to be updated. The global motion vector coding unit 3074 performs variable-length coding of the global motion vector GMV and the corresponding index (S3018). The data is stored in the header of the frame as described later.

The motion compensation prediction unit 3070 determines which motion compensation option from among the two possible motion compensation options provides the smallest total coding amount for each macro block (S3020). Here, of these two motion compensation options, one is motion compensation using the global motion vector GMV with the index assigned in S3018, and the other is motion compensation using the local motion vector LMV calculated for each target macro block. On the other hand, the total coding amount is the sum of the coding amount of the subtraction image and the coding amount of the motion vector. The motion compensation prediction unit 3070 transmits the motion vector, which provides the smallest coding amount of the macro block, to the local motion vector coding unit 3072.

In a case that determination has been made in S3020 that the motion compensation using the local motion vector provides the smallest coding amount for the macro block, the local motion vector coding unit 3072 performs coding of the local motion vector (S3022). Furthermore, the local motion vector coding unit 3072 supplies the GMV use flag, which specifies whether or not the prediction coding has been executed using the global motion vector, to the multiplexing unit 3092.

Upon completion of the processing in S3020 and S3022 for all the macro blocks included in the frame (in a case of “YES” in S3024), the flow ends.

FIG. 30A is a diagram for describing an example of the global regions. In FIG. 30A, the region setting unit 3064 sets a first global region 3112 and a second global region 3114 in a frame 3110. Furthermore, the region setting unit 3064 sets a third global region 3116 included in the second global region 3114. The global motion vector calculation unit 3068 obtains a first global motion vector GMV1 for the first global region 3112, a second global motion vector GMV2 for the second global region 3114, and a third global motion vector GMV3 for the third global region 3116. In FIG. 30A, the global motion vector is not set for the background regions indicated by empty square blocks.

The update determination unit 3050 assigns an index to each of the global motion vectors GMV1 through GMV3 for each frame, thereby creating the reference table. FIG. 30B shows an example of the reference table. In this example, the indexes 1 through 3 are assigned to the global motion vectors GMV1 through GMV3, respectively. The global motion vector information and the indexes are stored in the frame header of the coded stream.

In such a case shown in FIG. 30A, before execution of the prediction coding for each macro block, the motion compensation prediction unit 3070 determines one motion compensation option from among the two possible motion compensation options, i.e., the motion compensation option using the local motion vector LMV calculated for each macro block, and the motion compensation option using one of the global motion vectors GMV1 through GMV3.

Let us say that motion compensation using the third global motion vector GMV3 provides the smallest coding amount for the macro block 3120 in the drawing, which is smaller than the amount with motion compensation using the local motion vector LMV calculated for this macro block. In this case, the motion compensation option using the third global motion vector GMV3 is selected. On the other hand, let us say that motion compensation using the second global motion vector GMV2 provides the smallest coding amount for the macro block 3118 in the drawing, which is smaller than the amount with motion compensation using the local motion vector LMV calculated for this macro block. In this case, the motion compensation option using the second global motion vector GMV2 is selected.

On the other hand, let us say that motion compensation using the local motion vector LMV calculated for each macro block provides the smallest coding amount for the macro blocks in the background region other than the macro blocks 3118 and 3120, which is smaller than the amount with motion compensation using any one of the global motion vectors. Accordingly, the motion compensation option using the local motion vector is selected without involving any one of the global motion vectors.

FIG. 31 is a diagram for describing the data structure of a coded stream 3200 created by the multiplexing unit 3092. The coded stream 3200 is formed of a stream parameter 3202, a frame header 3204, and the data of each frame.

With the Example 1, the frame header 3204 stores the reference table information, i.e., the information with respect to the global motion vectors and the indexes. On the other hand, the slice data 3208 stores the GMV use flags 3270 in units of macro blocks.

The term “Num” 3210 as used here represents the number of the global motion vectors stored in the frame header 3204. Data representing a predetermined number of data pairs, each of which is formed of an index 3212 and a global motion vector (GMV) 3214, follows the Num 3210 in the frame header 3204. The number of the data pairs is specified by the Num 3210.

With such an arrangement, the decoding device for performing processing of the coded stream 3200 may update only the global motion vectors which have been assigned the same indexes as those in the reference table defined in the previous processing of the previous frame. For example, let us say that the reference table shown in FIG. 30B has been defined for the previous processing, of the previous frame. Furthermore, let us say that the frame header 3204 of the subsequent frame includes only the index 1 and index 3. In this case, these global motion vectors GMV1 and GMV3 are updated. On the other hand, the global motion vector GMV2 assigned the index 2 is maintained as an effective component. Alternatively, an arrangement may be made in which the reference table is updated for each frame, and the index/global motion vector pairs included in the frame header 3204 of a current frame are defined as components of a new reference table for the current frame.

The slice data 3208 stores data sets in units of macro blocks. The GMV use flag 3270 indicates whether or not prediction coding has been performed for the corresponding macro block using the global motion vector. Specifically, the GMV use flag 3270 of “1”, indicates that prediction coding has been performed for the corresponding macro block using the global motion vector. Accordingly, in this case, the stored data which follows the GMV use flag 3270 is an index 3272 which indicates which global motion vector has been used from among the multiple global motion vectors defined in the reference table. On the other hand, the GMV use flag 3270 of “0” indicates that prediction coding has been performed for the corresponding macro block using the local motion vector without involving the global motion vector. Accordingly, in this case, the index is not stored. The slice date 3208 also includes the information with respect to the subtraction image and the local motion vector LMV.

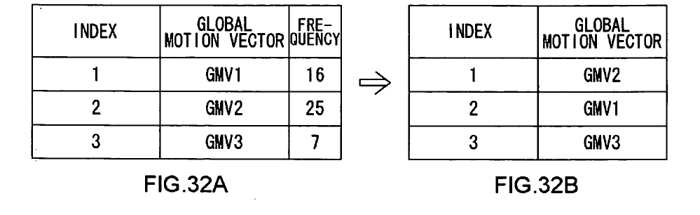

FIGS. 32A and 32B show an example of a method for assigning an index to each global motion vector. Now, let us say that the indexes 1 through 3 are assigned to the global motion vectors GMV1 through GMV3. The update determination unit 3050 acquires, from the motion compensation prediction unit 3070, the information with respect to the number of macro blocks where motion compensation has been performed using the global motion vector for each of the global motion vectors GMV1 through GMV3 (which corresponds to the “frequency” shown in FIG. 32A). Then, the global motion vector temporary storage unit 3052 holds this frequency information thus acquired, along with the reference table (see FIG. 32A). Upon receiving the global motion vectors of the subsequent frame, the update determination unit 3050 makes a comparison between each of the global motion vectors thus received and each of the global motion vectors GMV1 through GMV3 held by the global motion vector temporary storage unit 3052. Let us say that these global motion vectors thus received match those being held by the global motion vector temporary storage unit 3052. In this case, the update determination unit 3050 assigns the indexes 1 through 3 to the global motion vectors GMV1 through GMV3 in order of frequency, with reference to the frequency information which indicates how frequently motion compensation has been performed using the global motion vector for each of the global motion vectors GMV1 through GMV3 (see FIG. 32B). With such an arrangement, the index with a smaller number of bits can be assigned to the global motion vector which is used more frequently. This reduces the coding amount of the index.

### EXAMPLE 2

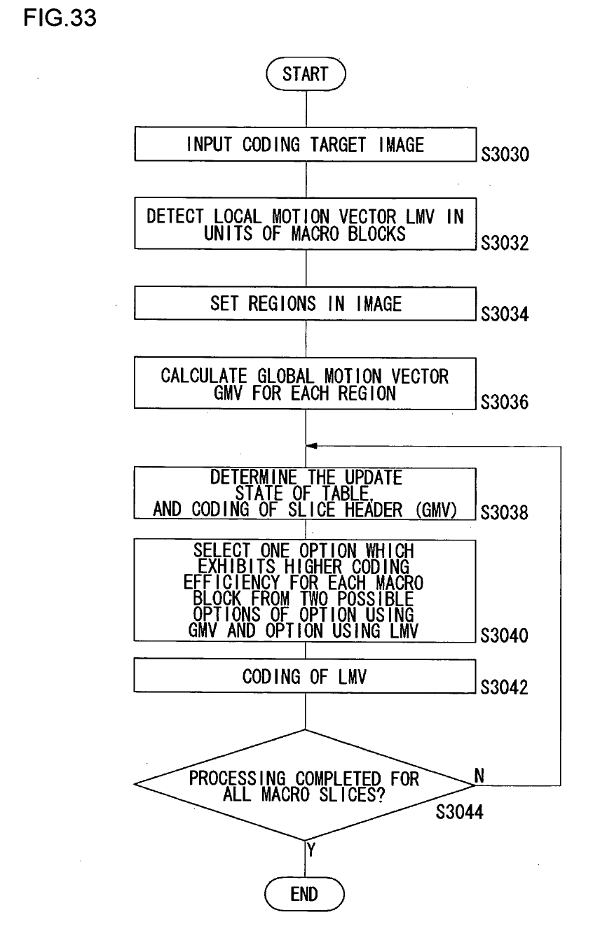

Description has been made in the Example 1 regarding an arrangement in which a reference table is created for each frame, which indicates the relation between the global motion vector and index. With the present Example 2, a reference table, which indicates the relation between the global motion vector and index, is created for each slice. Description will be made below regarding the Example 2 with reference to FIGS. 33 through 35.

FIG. 33 is a flowchart for describing the procedure of the differential coding of the motion vector performed by the motion compensation unit 3060 according to the Example 2 of the Embodiment 4. Note that the steps in S3030 through S3036 in this drawing are the same as those in S3030 through 3036 shown in FIG. 29.

The update determination unit 3050 assigns an index to each global motion vector in units of slices. Furthermore, the update determination unit 3050 determines whether or not the reference table with respect to the global motion vectors is to be updated. The global motion vector coding unit 3074 performs variable-length coding of the global motion vector GMV and the index in correlation with each other (S3038). As described later, the data is stored in the slice header.

The motion compensation prediction unit 3070 determines the motion compensation option which provides the smallest total coding amount, which is the sum of the coding amount of the subtraction image and the coding amount of the motion vector, from among the two possible motion compensation options, i.e., the motion compensation option using one of the global motion vectors GMV with the indexes assigned in S3038, and the motion compensation option using the local motion vector LMV obtained for each macro block. (S3040). Then, the motion compensation prediction unit 3070 transmits the motion vector, which provides the motion compensation with the smallest coding amount for the macro block, to the local motion vector coding unit 3072.

In a case that determination has been made in S3040 that the motion compensation using the local motion vector provides the smallest coding amount for the macro block, the local motion vector coding unit 3072 performs coding of the local motion vector (S3042). Furthermore, the local motion vector coding unit 3072 supplies the GMV use flag, which indicates whether or not the prediction coding has been performed using the global motion vector, to the multiplexing unit.

Upon completion of the processing in S3038 through S3042 for all the slices included in the frame (in a case of “YES” in S3044), the flow ends.

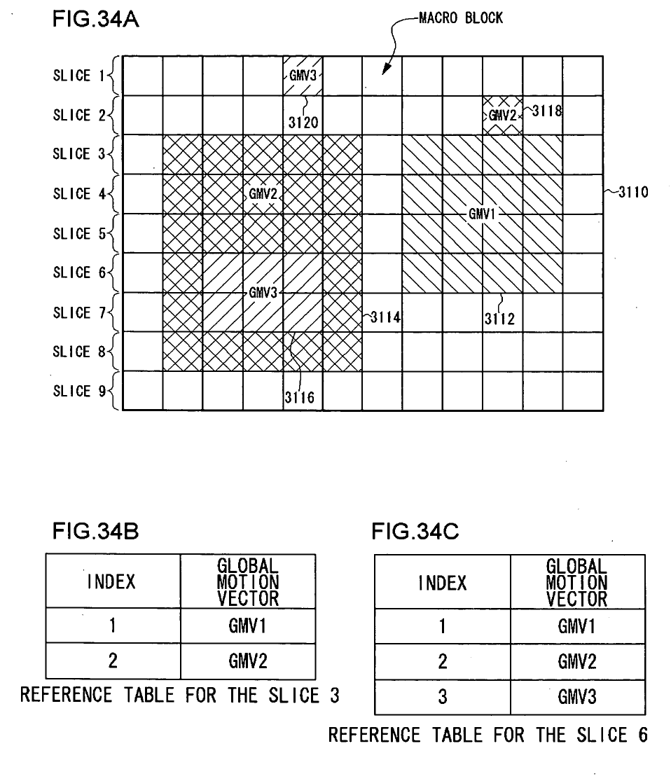

FIG. 34A is a diagram for describing an example of the global regions in the Example 2. In this drawing, the first through third global regions 3112 through 3116 are set, and the global motion vectors GMV1 through GMV3 are calculated for these respective regions in the same way as shown in FIG. 30A. In FIG. 34A, the slices, each of which is formed of a macro block array one-dimensionally extending in the horizontal direction, are defined in the frame 3110.

With the Example 2, the reference table with respect to the global motion vectors is created for each slice. For example, the slice 3 in the drawing includes a part of the first global region 3112 and a part of the second global region 3114. Accordingly, in this case, the update determination unit 3050 assigns the indexes 1 and 2 to the first global motion vector GMV1 and the second global motion vector GMV2, respectively, thereby creating the reference table (see FIG. 34B). The reference table information, i.e., the relation between the global motion vector GMV and the index, is stored in the slice header of the coded stream.

Before execution of the prediction coding for each macro block included in the slice 3, the motion compensation unit 3070 determines one motion compensation option from the two possible motion compensation options, i.e., the motion compensation options using the local motion vector LMV calculated for each macro block, and the motion compensation option using one of the global motion vectors GMV1 and GMV2 defined in the reference table for the slice 3 (FIG. 34B).

On the other hand, the slice 6 in the drawing includes a part of the first global region 3112, a part of the second global region 3114, and a part of the third global region 3116. Accordingly, in this case, the update determination unit 3050 assigns the indexes 1 through 3 to the first global motion vector GMV1 through the third global motion vector GMV3, respectively, thereby creating the reference table (see FIG. 34C). Before execution of the prediction coding for each macro block included in the slice 6, the motion compensation unit 3070 determines one motion compensation option from the two possible motion compensation options, i.e., the motion compensation options using the local motion vector LMV calculated for each macro block, and the motion compensation option using one of the global motion vectors GMV1 through GMV3 defined in the reference table for the slice 3 (FIG. 34C).

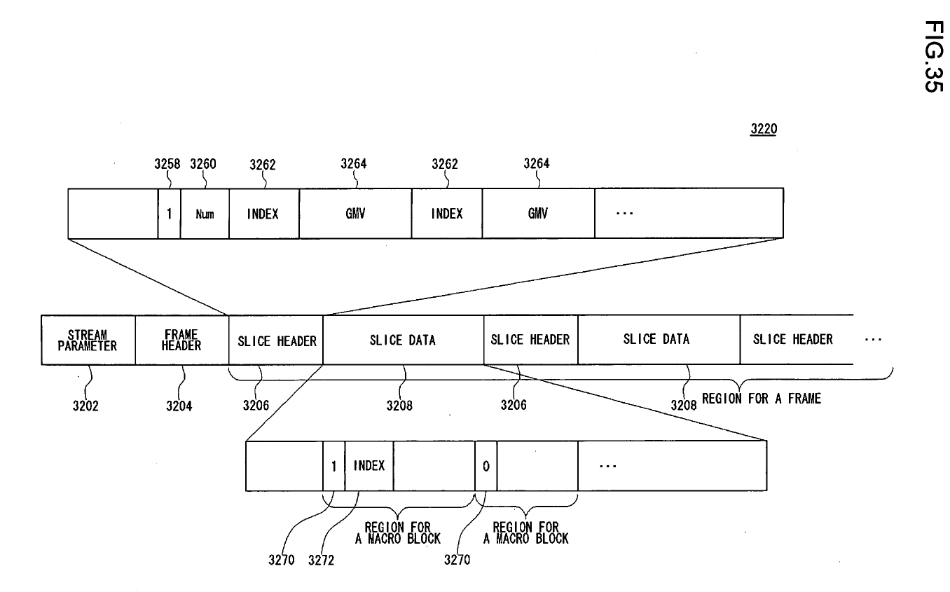

FIG. 35 is a diagram for describing the data structure of a coded stream 3220 created by the multiplexing unit 3092.

With the Example 2, the slice header 3206 stores the reference table information, i.e., the information with respect to the global motion vectors and the indexes. On the other hand, the slice data 3208 stores the GMV use flags 3270 in units of macro blocks.

A table update flag 3258 is a flag which indicates whether or not the reference table with respect to the global motion vectors is to be updated for the target slice. In a case of the table update flag 3258 of “0”, the reference table is not updated, and the reference table set for the previous slice prior to the target slice is maintained as the effective table. On the other hand, in a case of the table update flag 3250 of “1”, the reference table is updated. In this case, the term “Num” 3260 represents the number of the global motion vectors stored in the slice header 3206. As shown in the drawing, a predetermined number of data pairs, each of which is formed of an index 3262 and a global motion vector (GMV) 3264, follows the Num 3210 in the frame header 3204. The number of the data pairs is specified by the Num 3210.

The slice data 3208 stores the GMV use flag 3270, and the data of the subtraction image and local motion vector corresponding to the GMV use flag 3270, for each macro block. The data structure of the slice data 3208 is the same as that described with reference to FIG. 31, and accordingly, description thereof will be omitted.

### EXAMPLE 3

With the Example 3, a reference table, which indicates the relation between the global motion vector and the index, is created for each frame, in the same way as with the Example 1. The difference is as follows. That is to say, with the Example 3, first, one motion vector is selected for each slice from among the motion vectors defined in the reference table. Next, determination is made for each macro block whether or not that motion compensation is performed using the motion vector specified for each slice.

Specific description thereof will be made with reference to FIGS. 30B and 34A. The update determination unit 3050 creates the reference table for the frame 3110 as shown in FIG. 30B. The motion compensation prediction unit 3070 specifies one global motion vector for each slice from among the global motion vectors defined in the reference table shown in FIG. 30B, using the index. For example, let us consider a case of the slice 3 shown in FIG. 34A. In this case, a comparison between the first global region 3112 and the second global region 3114 indicates that the slice 3 includes a greater number of macro blocks which belong to the first global region 3112 than belong to the second global region 3114. Accordingly, in this case, the motion compensation prediction unit 3070 specifies the second global motion vector GMV2. Next, before the execution of prediction coding for each macro block included in the slice 3, determination is made regarding which motion compensation option is to be selected from among the two possible options, i.e., the option using the local motion vector LMV calculated for each macro block, and the option using the second global motion vector GMV2 specified beforehand for each slice.

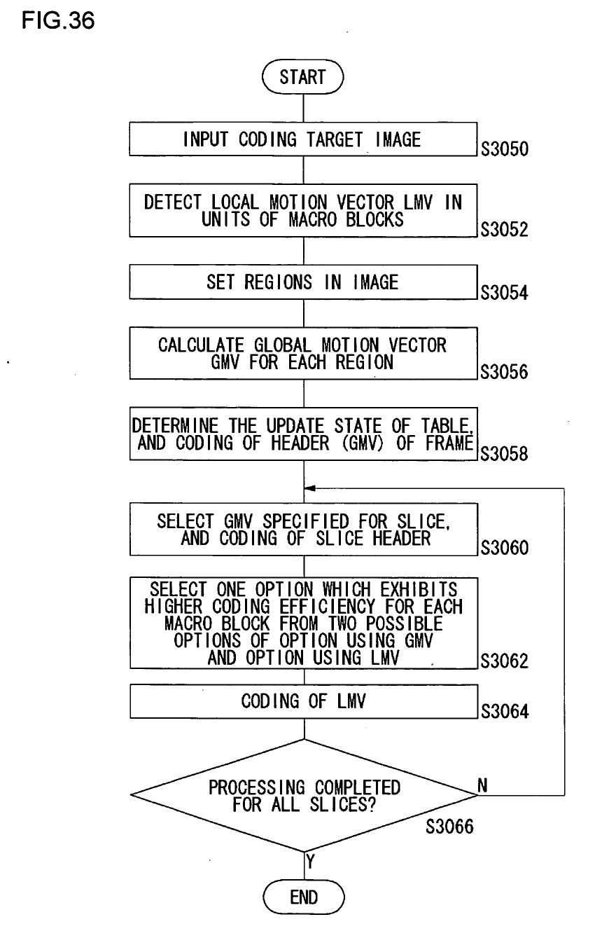

FIG. 36 is a flowchart for describing the procedure of differential coding of the motion vector performed by the motion compensation unit 3060 according to the Example 3 of the Embodiment 4.

The update determination unit 3050 assigns an index to each global motion vector GMV, and determines whether or not the reference table with respect to the global motion vectors is to be updated. The global motion vector coding unit 3074 performs variable-length coding of the global motion vector GMV and the index in correlation with each other (S3058). The data is stored in the frame header.

The motion compensation prediction unit 3070 specifies one global motion vector for each slice from among the global motion vectors defined in the reference table (S3060).

The motion compensation prediction unit 3070 determines the motion compensation option which provides the smallest coding amount for each macro block included in the slice, from among the two possible motion compensation options, i.e., the motion compensation option using the global motion vector GMV specified in S3060, and the motion compensation option using the local motion vector LMV calculated for each macro block (S3062). The motion compensation prediction unit 3070 transmits the motion vector, which provides the smallest coding amount for the macro block, to the local motion vector coding unit 3072.

In a case that determination has been made in S3062 that the motion compensation using the local motion vector provides the smallest coding amount for the macro block, the local motion vector coding unit 3072 performs coding of the local motion vector (S3064). Furthermore, the local motion vector coding unit 3072 supplies the GMV usage flag, which specifies whether or not the prediction coding has been performed using the global motion vector, to the multiplexing unit.

Upon completion of the processing in S3060 through S3064 for all the slices included in the frame (“Yes in S3066), the flow ends.

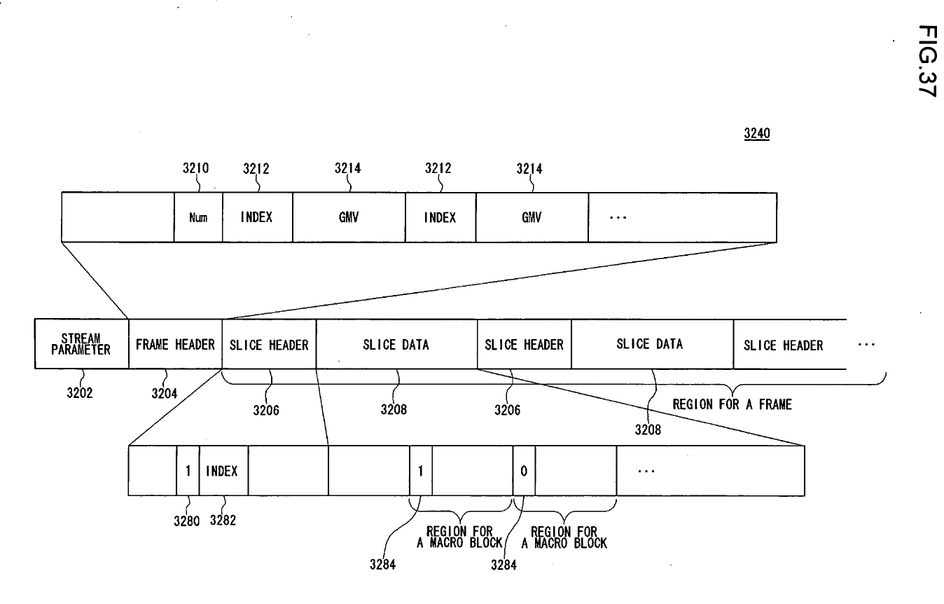

FIG. 37 is a diagram for describing the data structure of a coded stream 3240 created by the multiplexing unit 3092.

With the Example 3, the frame header 3204 stores the reference table information, i.e., the information with respect to the relation between the global motion vector GMV and the index. The slice header 3206 stores the index information which specifies one global motion vector from among the global motion vectors GMV defined in the frame header. Furthermore, the slice data 3208 stores the GMV use flags 3284 in units of macro blocks.

The data structure of the frame header 3204 is the same as that described above with reference to FIG. 31. The slice header 3206 stores the GMV use flag 3280 which indicates whether or not the global motion vector is used for each slice. In a case of the GMV use flag 3280 of “1”, the index 3282, which specifies the global motion vector to be used, follows the GMV use flag 3280. On the other hand, in a case of the GMV use flag 3280 of “0”, motion compensation is performed using only the local motion vector without involving any global motion vector, for each macro block included in the slice. In this case, the following processing is performed without involving the GMV use flag 3284 described later.

The GMV use flag 3284 indicates whether or not the global motion vector specified by the index 3282 is to be used for each macro block. In a case of the GMV use flag 3284 of “1”, motion compensation is performed for the macro block using the global motion vector. On the other hand, in a case of the GMV use flag 3284 of “0”, motion compensation is performed for the macro block using the local motion vector.

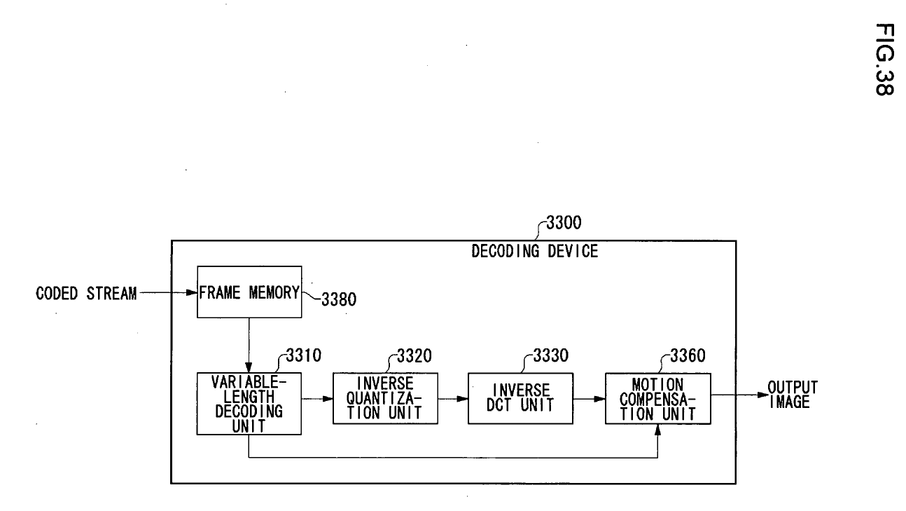

FIG. 38 is a configuration diagram which shows the decoding device 3300 according to the Embodiment 4. The functional block configuration can also be realized by hardware components alone, software components alone, or combinations thereof.

The decoding device 3300 receives a coded stream in the form of input data, and decodes the coded stream, thereby creating an output image. The coded stream thus input is stored in frame memory 3380.

A variable-length decoding unit 3310 performs variable-length decoding of the coded stream stored in the frame memory 3380, and transmits the decoded image data to an inverse-quantization unit 3320. On the other hand, the variable-length decoding unit 3310 transmits the decoded motion vector information to a motion compensation unit 3360.

The inverse-quantization unit 3320 performs inverse-quantization of the image data decoded by the variable-length decoding unit 3310, and transmits the image data thus inverse-quantized to an inverse DCT unit 3330. The image data inverse-quantized by the inverse quantization unit 3320 is a DCT coefficient set. The inverse DCT unit 3330 performs inverse discrete cosine transform (IDCT) for the DCT coefficient set inverse-quantized by the inverse quantization unit 3320, thereby reconstructing the original image data. The image data reconstructed by the inverse DCT unit 3330 is transmitted to the motion compensation unit 3360.

The motion compensation unit 3360 creates a predicted image based upon the motion vector information supplied from the variable-length decoding unit 3310 using the prior or upcoming image frame as a reference image. Then, the motion compensation unit 3360 reconstructs the original image data by making the sum of the predicted image and the subtraction image supplied from the inverse DCT unit 3330, and outputs the original image data thus reconstructed.

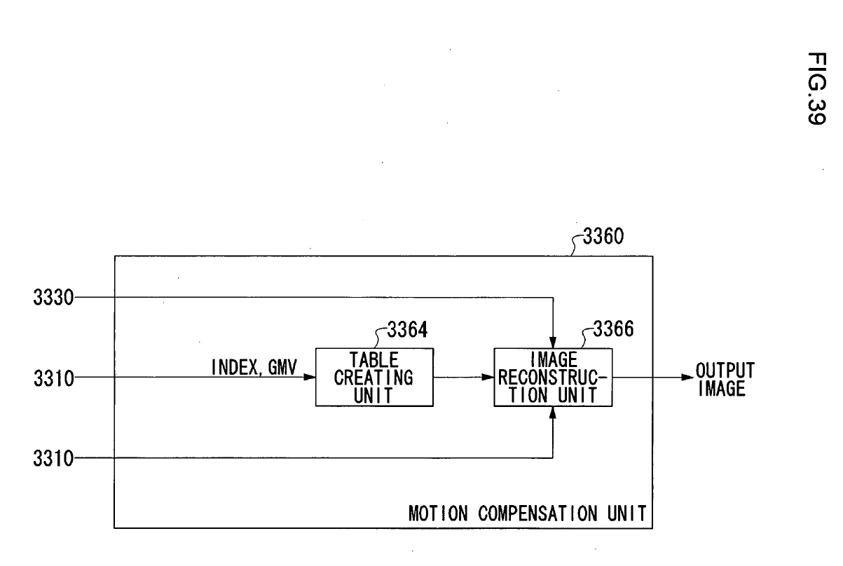

FIG. 39 is a diagram for describing the configuration of the motion compensation unit 3360. The coded stream, which has been coded by the coding device 3100 shown in FIG. 26, is input to the decoding device 3300. The global motion vector GMV, the index, various kinds of flags, and the local motion vector LMV, are supplied to the motion compensation unit 3360. The motion compensation unit 3360 obtains the local motion vectors LMV for the decoding target frame with reference to the information, and performs motion compensation.

A table creating unit 3364 receives the global motion vector and the index from the variable-length decoding unit 3310 in the form of input data, and creates the reference table with respect to the global motion vector.

Let us consider a case in which the reference table information with respect to the global motion vectors is coded for each frame as shown in FIG. 31 or 37. In this case, the table creating unit 3364 obtains the number of the global motion vectors based upon the information with respect to the Num 3210, and creates a table having a predetermined number of entry items, with the number of entry items being specified by the Num 3210. Then, the pairs of the index 3262 and the corresponding global motion vector 3264 are stored in this table, thereby creating the reference table as shown FIG. 30B.

Let us consider a case in which the reference table information with respect to the global motion vectors is coded for each slice as shown in FIG. 35. In this case, determination is made whether or not the reference table with respect to the global motion vectors is to be updated for the coding target slice. In a case that determination has been made that the reference table is to be updated, the number of the global motion vectors is obtained based upon the information with respect to the Num 3260. Then, the table creating unit 3364 creates a table having a predetermined number of entry items, with the number of entry items being specified by the Num 3210. Then, the pairs of the index 3262 and the corresponding global motion vector 3264 are stored in this table, thereby creating the reference table as shown FIG. 34B or FIG. 34C.

The table creating unit 3364 supplies the reference table thus created to the image reconstruction unit 3366.

The image reconstruction unit 3366 creates a predicted image using the reference image, and either the local motion vector LMV calculated for each macro block within each global region, or the global motion vector GMV defined in the reference table. Then, the image reconstruction unit 3366 reconstructs the original image by calculating the sum of the subtraction image received from the inverse DCT unit 3330 and the predicted image thus created, and outputs the original image thus reconstructed.

Upon receiving a coded stream as shown in FIG. 31 or FIG. 35, the image reconstruction unit 3366 determines one prediction image creation option from two possible options, i.e., an option of creating a predicted image using the global motion vector, and another option of creating a predicted image using the local motion vector, with reference to the GMV use flag 3270 defined for each macro block. In a case of selecting the option using the global motion vector, the corresponding global motion vector is acquired from the reference table received from the table creating unit 3364 using the index 3272 which follows the GM use flag 3270 stored in the coded stream. Then, a predicted image is created using the global motion vector thus acquired. On the other hand, in a case of the flag 3270 of “0”, the image reconstruction unit 3366 creates a predicted image using the local motion vector obtained for each macro block which is a processing target. Description will be made with reference to the example of the coded stream shown in FIG. 31. In this case, the image reconstruction unit 3366 creates a predicted image using the global motion vector specified by the index 3272 for the first macro block. Furthermore, the image reconstruction unit 3366 creates another predicted image using the local motion vector for the second macro block.

Upon receiving a coded stream as shown in FIG. 37, determination is made whether or not the global motion vector has been specified for each slice with reference to the GMV use flag. In a case of the GMV use flag 3280 of “1” which indicates that the global motion vector has been specified, the image reconstruction unit 3366 acquires the corresponding global motion vector from the reference table received from the table creating unit 3364 using the index 3282. Then, the image reconstruction unit 3366 creates a predicted image using either the global motion vector thus acquired in the previous step or the local motion vector obtained for each macro block, which is selected with reference to the GMV use flag for each macro block. Now, specific description will be made with reference to the example of the coded stream shown in FIG. 37. In this case, the image reconstruction unit 3366 creates a predicted image using the global motion vector specified by the index 3282 for the first macro block. Furthermore, the image reconstruction unit 3366 creates another predicted image using the local motion vector for the second macro block.

As described above, with the coding device 3100 according to the present Embodiment 4, a table, which indicates the relation between the global motion vector and the index, is created for each frame or for each slice. Such an arrangement allows the global motion vector, which is used for prediction coding for each macro block, to be specified using the index. Now, let us consider a case in which prediction coding is performed for different macro blocks in a single slice or in a single frame using the same global motion vector. In this case, with such an arrangement, there is no need to include redundant data for the same global motion vector in a coded stream for each slice or for each frame. This reduces the data amount of the coded data due to the global motion vectors, thereby improving the compression efficiency of a moving image stream.

Furthermore, with the present embodiment, the coded stream stores the GMV use flag which indicates whether or not the global motion vector is used for each macro block. This allows one motion compensation option to be selected for each macro block from the two possible motion compensation options, i.e., the motion compensation option using the local motion vector, and the motion compensation option using the global motion vector. This allows the data amount of the coded data of the macro blocks to be further reduced.

Furthermore, with the present embodiment, multiple global motion vectors are set in the reference table for each frame or for each slice. Such an arrangement enables any one of global motions vector to be selected from among the global motion vectors set in the reference table by specifying the index. This enables motion compensation of different macro blocks to be performed using the same global motion vector, even if these macro blocks are included in separate global regions.

The coded global motion vector in a form correlated with the index may be the difference data between the target global motion vector and the global motion vector defined in the reference table for the prior processing for the prior frame or slice. Such an arrangement reduces the data amount of the individual motion vectors. This reduces the overall coding amount of the moving image stream, thereby improving the compression efficiency.

An arrangement may be made in which the index is assigned to the global motion vector in order of the global motion vector being calculated. Also, an arrangement may be made in which the index is assigned to the global motion vector in order of the expected frequency at which the global motion vector is used for each frame or slice. The latter arrangement further reduces the data amount of the indexes.

With the decoding device 3300 according to the Embodiment 4, the reference table, which indicates the relation between the global motion vector and the index, is established for each frame or for each slice based upon the moving image stream coded by the coding device 3100 with high compression efficiency. Then, the decoding device 3300 acquires the motion vector for each slice or for each macro block from the reference table using the index. This provides two motion compensation options, i.e., the motion compensation option using the local motion vector, and the motion compensation option using the global motion vector.

Description has been made regarding the Embodiment 4 with reference to the Examples. The above-described Examples have been described for exemplary purposes only, and are by no means intended to be interpreted restrictively. Rather, it can be readily conceived by those skilled in this art that various modifications may be made by making various combinations of the aforementioned components or of the aforementioned processing, which are also encompassed in the technical scope of the Embodiment 4.

Description has been made in the Embodiment 4 regarding the operation of the motion vector selection unit 3054 as follows. That is to say, the motion vector selection unit 3054 determines the motion prediction option which provides the smallest coding amount for the macro block, which is the sum of the coding amount of the subtraction image and the coding amount of the motion vector, from among the two motion prediction options, i.e., the motion prediction option using one or more global motion vectors GMV, and the motion prediction option using the local motion vector LMV calculated for each macro block. Also, in order to select the optimum motion vectors, the motion vector selection unit 3054 may operate as follows. That is to say, the motion vector selection unit 3054 calculates the coding amount of each macro block in the same way as described above. In addition, the motion vector selection unit 3054 calculates the difference in the coding amount between the original image and the decoded image which has been coded using one or more multiple global motion vectors GMV, and the difference in the coding amount between the original image and the decoded image which has been coded using the local motion vector LMV. Then, the motion vector calculation unit 3054 substitutes the coding amount for the macro block, and the difference thus obtained, into a predetermined evaluation expression for each motion prediction option using the corresponding motion vector, and selects the optimum motion vector which exhibits the minimum evaluated value. Such an arrangement allows the optimum motion vector to be selected giving consideration to both the coding amount of the coded data and the image quality of the decoded image.

Description has been made in the present embodiment regarding an arrangement which provides the reference table which allows the motion vector to be specified using the index for each frame, for each region or each macro block. Also, a reference table may be provided for each larger unit, i.e., for each entire stream, or for each GOP. With such an arrangement, the reference table information is stored in the stream parameter or the GOP header. Furthermore, the index information which specifies the motion vector defined in the reference table is stored in the header in units of frames, slices, global regions, or macro blocks. Now, let us consider a case in which the motion vector of the moving image is constant over the entire stream, or over the GOP, for example. In this case, such an arrangement greatly reduces the coding amount for the motion vector information.

Description has been made in the present embodiment regarding an arrangement which creates a table that allows the motion vector to be specified for each global region or for each slice within the frame using the index. Also, the table, which allows the motion vector to be specified using the index, may be created for each region of interest (ROI) set in the moving image by an unshown ROI setting unit. Also, the ROI may be selected by the user, by specifying a particular region. Also, a predetermined region such as the center region of the image may be set to be the ROI. Alternatively, an important region occupied by a human figure or a text may be automatically extracted. Also, an arrangement may be made in which the ROI is automatically selected for each frame by following the movement of a particular object or the like in the moving image.

Description has been made in the present embodiment regarding an arrangement in which the coding device 3100 and the decoding device 3300 perform coding and decoding of a moving image in accordance with the MPEG series standards (MPEG-1, MPEG-2, and MPEG-4), the H.26x series standards (H.261, H.262, and H.263), or the H.264/AVC standard. Also, the Embodiment 4 may be applied to an arrangement in which coding and decoding are performed for a moving image managed in a hierarchical manner having a temporal scalability. In particular, the Embodiment 4 is effectively applied to an arrangement in which motion vectors are coded with the reduced coding amount using the MCTF technique.

What is claimed is:

1. A coding method wherein coded moving image data includes information with respect to a global motion vector that represents global motion within a target region for at least one region of multiple regions defined in a picture which is a component of a moving image, and which is to be subjected to inter-picture prediction coding.

2. A coding method according to claim 1, wherein, in a case that the global motion vector is defined for each of two or more regions, said coded moving image data includes the information with respect to the difference between the global motion vectors obtained for the different regions.

3. A coding method according to claim 1, wherein, in a case that the global motion vector is defined for each of two or more regions, at least one global motion vector is selected as a reference,
and wherein said coded moving image data includes the information with respect to the difference between the global motion vector selected as said reference and each of the other global motion vectors.

4. A coding method according to claim 1, wherein, in a case that the global motion vector is defined for each of two or more regions, the global motion vectors of these regions are handled in a hierarchical structure,
and wherein said coded moving image data includes the information with respect to the difference between the global motion vectors which belong to different hierarchical levels.

5. A coding method according to claim 2, wherein, in a case that there is an inclusion relation among said plurality of regions, said coded moving image data includes the information with respect to the difference between the global motion vectors of these regions according to the order of said inclusion relation.

6. A coding method according to claim 5, wherein said coded moving image data includes the information with respect to the difference between a global motion vector at a lower level of said inclusion relation and another global motion vector at a higher level, which serves as a reference.

7. A coding method according to claim 1, wherein, in a case that a local motion vector is defined for each predetermined block in said picture which is to be subjected to inter-picture prediction coding, said coded moving image data includes the information with respect to the difference between said global motion vector and said local motion vector for each region.

8. A coding method wherein coded moving image data includes information which indicates a global motion vector that represents global motion within a picture, which is a component of the moving image and which is to be subjected to inter-picture prediction coding, or within a region defined in the picture, and the information with respect to an index for identifying the global motion vector,
and wherein the coded image data also includes the index information which specifies the global motion vector used for prediction coding of the picture, or the region included in the picture, for which the global motion vector has been calculated.

9. A coding method according to claim 8, wherein, in a case that a first global motion vector calculated for a first picture or for a region defined in the first picture differs from a second global motion vector calculated for a second picture or for a region defined in the second picture, the coded data includes the information with respect to the difference between the first global motion vector and the second global motion vector in correlation with the index.

10. A coding method according to claim 8, wherein an index is assigned to each global motion vector with the global motion vectors obtained in the second picture or the region defined in the second picture being sorted in order of how frequently each global motion vector has been used in the first picture or the region defined the first picture.

11. A coding method according to claim 8, wherein the header of each coded data, the header of each picture, or the header of each region in the picture includes the information with respect to the global motion vector and the information with respect to the index for identifying the global motion vector,
and wherein the header of each picture or the header of each region defined in the picture, for which the global motion vector has been calculated includes the index information which specifies the global motion vector used for prediction coding of the target region.

12. A coding method according to claim 8, wherein the coded data includes a flag which indicates whether or not prediction coding is performed using the global motion vector, for each region defined in the picture or for each of the pictures.

13. A coding method according to claim 8, wherein the coded data includes a flag, which indicates one prediction coding option from among two possible prediction coding options, i.e., the prediction coding option using the global motion vector specified by the index, and the prediction coding option using the local motion vector calculated for the target block, for each block defined in the picture.
